(19) United States
(12) Patent Application Publication
(10) Pub. No.: US 2022/0315743 A1
(43) Pub. Date: Oct. 6, 2022

(54) RECYCLED POLYOLEFIN COMPOSITIONS COMPRISING RANDOM ALPHA-OLEFINIC COPOLYMERS AND ADDITIONAL POLYMERS

(71) Applicant: Synthomer Adhesive Technologies LLC, Beachwood, OH (US)

(72) Inventors: Robbie Rene MEUL, Hamme (BE); Synco DE VOGEL, Baden Wuerttemberg (DE); Jason AYOUB, Houston, TX (US); Chang Hoon SONG, Lawrenceville, GA (US); Terri Roxanne CARVAGNO, Church Hill, TN (US)

(21) Appl. No.: 17/841,025

(22) Filed: Jun. 15, 2022

Related U.S. Application Data
(63) Continuation-in-part of application No. PCT/US2021/063673, filed on Dec. 16, 2021.
(60) Provisional application No. 63/199,296, filed on Dec. 18, 2020.
(60) Provisional application No. 63/269,418, filed on Mar. 16, 2022.
(60) Provisional application No. 63/269,419, filed on Mar. 16, 2022.

(51) Int. Cl. C08L 23/06; C08L 23/14; C08L 23/12; C08K 5/01; B29C 48/00; B29C 48/40

(52) U.S. Cl. CPC C08L 23/06; C08L 23/142; C08L 23/12; C08K 5/01; B29C 48/022; B29C 48/40; C08L 2207/20; C08L 2207/062; C08L 2207/066; C08L 2205/025; C08L 2205/03

(57) ABSTRACT

A polyolefin composition is provided comprising: (A) about 60 to about 96 wt % of at least one recycled polyolefin; (B) about 2 to about 20 wt % of at least one random alpha-olefinic copolymer; (C) optionally, at least one tackifier; (D) about 1 to about 60 wt % of at least one additional polymer; and wherein the polyolefin composition has a melt flow rate increase of about 3 to about 400% compared to the same polyolefin composition without said random alpha-olefinic copolymer, said optional tackifier, and said additional polymer. Processes for making and articles produced from the polyolefin compositions are also provided.

### RELATED APPLICATIONS

This application is a continuation-in-part of PCT Application No. PCT/US2021/063673, which claims the priority benefit under 35 U.S.C. § 119(e) of U.S. Provisional Patent Application Ser. No. 63/199,296 filed Dec. 18, 2020, the entire disclosures of which are incorporated herein by reference. This application also claims the priority benefits under 35 U.S.C. § 119(e) of U.S. Provisional Patent Application Ser. No. 63/269,419, filed Mar. 16, 2022, and U.S. Provisional Patent Application Ser. No. 63/269,418, filed Mar. 16, 2022, the entire disclosures of which are incorporated herein by reference.

### FIELD

This invention relates to a polyolefin composition and, in particular, but not exclusively to, an article including the polyolefin composition. This invention also relates to processes to produce the polyolefin compositions and articles comprising the polyolefin composition.

### BACKGROUND

Polyolefins, particularly polyethylene and polypropylene, are increasingly consumed in large amounts in a wide range of applications, including packaging for food and other goods, fibers, automotive components, containers, and a great variety of manufactured articles.

During the last decade, concern about plastics and the environmental sustainability of their use in current quantities has arisen. This has led to new legislation on disposal, collection and recycling of polyolefin materials. There have additionally been efforts in several countries to increase the percentage of plastic materials that is recycled instead of sent to landfill.

Therefore, the use of recycled materials that are derived from a wide variety of post-consumer and post-industrial sources is an increasing requirement in the field of polyolefins. However, recycling streams commonly available suffer from limited rheological and mechanical properties, reducing commercially attractive end uses. Current commercial flow and impact modifiers available for upgrading recycling streams are either too expensive, rendering the recycling as such uneconomical, or tend to cause an imbalance in rheological and mechanical properties, for example, sacrificing impact strength for yield strength, or sacrificing Young's modulus or viscosity for impact strength.

Especially mechanical recycled polymers often show a deficit in flow characteristics (low MFI, high viscosity) and impact properties (reduced Izod or Charpy impact strength, notched and unnotched) induced by the recycling process (extrusion) and the use of the articles prior to recycling (e.g., exposure to UV, heat, etc.). Current available commercial solutions often focus on improvement of a single property (e.g., only improve flow or only improve impact strength), which leaves a need for integrated, easy to use solutions that simultaneously optimize and balance multiple properties to create a preferred combination of good processability and preferred end use characteristics.

The simultaneous optimization of flow and impact strength may be also beneficial for certain virgin polyolefins like polypropylene homopolymers, creating more buying power for customers if they can tune lower impact polypropylene homopolymers to a higher impact grade. Similarly, virgin polypropylene and polyethylene based copolymers may also benefit from simultaneous optimization and balancing of properties.

In blends comprising predominantly polyethylene and polypropylene, higher impact strength can be achieved through the addition of elastomers acting as compatibilizers, like conventional ethylene-propylene rubbers or EPDM. However, such addition limits the stiffness of the resulting compositions.

More recently developed highly crystalline metallocene-based polypropylene-ethylene elastomers (e.g., Vistamaxx™ 6102, from ExxonMobil Chemical Company, Houston, Tex., USA) increase impact strength by acting as compatibilizers between polyethylene and polypropylene fractions in recycled compounds. However, these solutions still show a decrease in stiffness and yield strength with only moderate improvements of the rheology.

The literature suggests the incorporation of heterophasic ethylene-propylene copolymers (HECOs) comprising ethylene-octene-copolymers, which are commercially available from Borealis Plastomers (NL) under the tradename Queo®, from The Dow Chemical Company (Midland, Mich., USA) under the tradename Engage™, or from ENI SpA (IT). However, the use of arbitrary heterophasic ethylene-propylene copolymers (HECOs) yields poor results, particularly with respect to stiffness.

It is commonly believed that the limited stiffness could only be overcome by using plastomers having a block copolymer structure such as provided by Dow Chemical INFUSE™ olefin block copolymer (OBC) or INTUNE™ OBC plastomers. For example, INTUNE™ polypropylene-based OBCs (PP-OBCs) were introduced as compatibilizers rather than elastomers. They contain propylene-rich blocks compatible with polypropylene and ethylene-rich blocks compatible with polyethylene. It is readily understandable that the block copolymer introduces the options of having certain highly crystalline domains of higher stiffness and thereby overall increased stiffness. However, plastomers with block copolymer natures have the disadvantage of being relatively expensive.

The combination of a polyethylene-based elastomer (for example Vistamaxx™ elastomer) with a propylene-based plastomer (for example Engage™ ethylene-octene copolymers) as suggested in the literature is limited by the economic feasibility of the suggested solution and focuses on enhanced impact strength while sacrificing modulus and significant viscosity optimizations.

The literature also suggests the incorporation of a C₂C₈ plastomer with a melt flow rate (MFR) equal or below 1.5 g/10 min (ISO1133, 190° C., 2.16 kg) as a more economical solution over the use of elastomers combined with plastomers. This solution can boost impact strength with moderate decrease of Young's modulus, but still sacrifices rheological properties.

Therefore, there still is a deeply felt need for a good balance of viscosity, stiffness and impact strength in polyolefin compositions containing recycled polyolefin.

Particularly, there is a deeply felt need for having upgraded polyolefin compositions containing recycled polyolefin where the composition has an increase in MFR while maintaining desirable mechanical properties as compared to the recycled polyolefin alone.

### SUMMARY

This invention relates to a polyolefin composition comprising: (A) about 60 to about 96 wt % of at least one recycled polyolefin; (B) about 2 to about 20 wt % of at least one random alpha-olefinic copolymer; (C) optionally about 2 to about 20 wt % of at least one tackifier; and (D) about 1 to about 60 wt % of at least one additional polymer; wherein the percentage of B+C+D can range from about 5 to about 70 wt %; wherein the polyolefin composition can have a weight ratio of random alpha-olefinic copolymer to tackifier of between about 0.2 to about 5.0; and wherein the polyolefin composition has a melt flow rate increase of about 3% to about 400% and impact strength increase of about 2 to about 150% compared to the same polyolefin composition without the random alpha-olefinic copolymer, additional polymer(s) and optional tackifier. This invention also relates to processes to produce the polyolefin compositions and articles comprising the polyolefin composition.

According to one embodiment of the invention, a polyolefin composition is provided comprising: (A) about 60 to about 96 wt % of at least one recycled polyolefin; (B) about 2 to about 20 wt % of at least one random alpha-olefinic copolymer; and (C) about 2 to about 20 wt % of at least one tackifier; wherein the polyolefin composition has a weight ratio of random alpha-olefinic copolymer to tackifier of between about 0.2 to about 5.0; and wherein the polyolefin composition has a melt flow rate increase of about 3 to about 400% compared to the same polyolefin composition without the random alpha-olefinic copolymer and the tackifier.

In another aspect, a process to produce a polyolefin composition is provided comprising: 1) extruding at least one recycled polyolefin in the presence of at least one radical initiator (E) to produce an extruded visbroken recycled polyolefin; and 2) melt blending (A) about 60 to about 96 wt % of the extruded recycled polyolefin; (B) about 2 to about 20 wt % of at least one random alpha-olefinic copolymer; and (C) optionally, about 2 to about 20 wt % of at least one tackifier; (D) optionally, at least one additional polymer; wherein the polyolefin composition has a weight ratio of random alpha-olefinic copolymer to tackifier of between about 0.2 to about 5.0; and wherein the extruded, visbroken polyolefin composition has a melt flow rate increase of about 3 to about 1500% compared to the recycled polyolefin.

Additionally, a process for producing a polyolefin composition is provided comprising melt blending: (A) about 60 to about 96 wt % of at least one recycled polyolefin; (B) about 2 to about 20 wt % of at least one random alpha-olefinic copolymer; and (C) about 2 to about 20 wt % of at least one tackifier; and (D) optionally, at least one additional polymer; wherein the polyolefin composition has a weight ratio of random alpha-olefinic copolymer to tackifier of between about 0.2 to about 5.0; and wherein the polyolefin composition has a melt flow rate increase of about 3 to about 400% compared to the same polyolefin composition without the random alpha-olefinic copolymer, the tackifier, and the optional additional polymer.

Further a process for producing a polyolefin composition is provided comprising melt blending: (A) about 60 to about 96 wt % of at least one recycled polyolefin; (B) about 2 to about 20 wt % of at least one random alpha-olefinic copolymer; optionally, (C) about 2 to about 20 wt % of at least one tackifier; and (D) at least one additional polymer; wherein the polyolefin composition has a melt flow rate increase of about 3% to about 400% and can have an increase in impact strength of about 2% to about 150% or of about 2% to about 200% compared to the same polyolefin composition without the random alpha-olefinic copolymer, the optional tackifier, and the additional polymer.

Additionally, a polyolefin composition is provided comprising: (A) about 60 to about 96 wt % of at least one recycled polyolefin; (B) about 2 to about 20 wt % of at least one random alpha-olefinic copolymer; (C) at least one tackifier; (D) about 1 to about 60 wt % of at least one additional polymer; and wherein the polyolefin composition has a weight ratio of random alpha-olefinic copolymer to tackifier of between about 0.2 to about 5.0; and wherein the polyolefin composition has a melt flow rate increase of about 3 to about 400% compared to the same polyolefin. composition without the random alpha-olefinic copolymer, the tackifier, and the additional polymer.

Also, a polyolefin composition is provided comprising: (A) about 60 to about 96 wt % of at least one recycled polyolefin; (B) about 2 to about 20 wt % of at least one random alpha-olefinic copolymer; optionally, (C) optionally, at least one tackifier; (D) about 1 to about 60 wt % of at least one additional polymer; and wherein the polyolefin composition has a weight ratio of random alpha-olefinic copolymer to tackifier of between about 0.2 to about 5.0; and wherein the polyolefin composition has a melt flow rate increase of about 3% to about 400% and can have an increase in impact strength of about 2% to about 150% or of about 2% to about 200% compared to the same polyolefin composition without the random alpha-olefinic copolymer, the optional tackifier, and the additional polymer.

### BRIEF DESCRIPTION OF THE DRAWINGS

The invention will now be described with reference to the drawings. The accompanying drawings, which are incorporated in and constitute a part of this specification, illustrate certain embodiments, and together with the written description, serve to explain certain principles of the constructs and methods disclosed herein.

FIG. 1 depicts the linearity variables in function of percentage amorphous poly-(alpha) olefin.

FIG. 2 depicts the linearity variables in function of percentage hydrogenated. amorphous poly-(alpha) olefin.

### DETAILED DESCRIPTION

The inventors have observed that, surprisingly, combining random alpha-olefinic copolymers with hydrocarbon tackifier resin (“tackifier”) leads to a significant increase in MFR (ISO1133), while balancing mechanical properties such as yield strength (ISO 527-2) and impact strength (ISO179-1). This can be done by using relatively inexpensive modifiers and bringing a sustainable economical solution to the market for recycled polyolefins.

Combining random alpha-olefinic copolymers with hydrocarbon tackifier resin (“tackifier”) in polyethylene-rich recycled polyolefin compositions leads to a significant increase in both MFR (ISO1133) and in elongation at break or elongation at yield while balancing other mechanical properties.

Surprisingly, non-rubber additional polymers such as linear low density polyethylene (LLDPE), ethylene-acrylate copolymers, and medium density polyethylene (MDPE) can be combined with at least one random alpha-olefinic copolymer and at least one hydrocarbon tackifier resin to improve the impact strength of the polyolefin composition comprising recycled polyolefins.

Also, non-rubber additional polymers such as linear low density polyethylene (LLDPE), ethylene-acrylate copolymers, and medium density polyethylene (MDPE) can be combined with at least one random alpha-olefinic copolymer and optionally, at least one hydrocarbon tackifier resin, to improve the impact strength of the polyolefin composition comprising recycled polyolefins.

Surprisingly, non-rubber additional polymers such as linear low density polyethylene (LLDPE), ethylene-acrylate copolymers, and medium density polyethylene (MDPE) can be combined with at least one random alpha-olefinic copolymer and optionally, at least one hydrocarbon tackifier resin, leads to a significant increase in both MFR (ISO1133) and in elongation at break or elongation at yield while balancing other mechanical properties.

A further surprising feature is that a new process involving visbreaking the recycled polyolefin followed by melt blending with at least one random alpha-olefinic copolymer also leads to a significant increase in MFR while balancing mechanical properties such as yield strength and impact strength. More specifically, a process has been discovered comprising 1) extruding at least one recycled polyolefin in the presence of at least one radical initiator to produce an visbroken recycled polyolefin; and 2) contacting (A) about 60 to about 96 wt % of the visbroken recycled polyolefin; (B) about 2 to about 20 wt % of at least one random alpha-olefinic copolymer; and (C) optionally, about 2 to about 20 wt % of at least one tackifier; wherein the polyolefin composition has a weight ratio of random alpha-olefinic copolymer to the optional tackifier of between about 0.2 to about 5.0; and wherein the extruded, visbroken polyolefin composition has a melt flow rate increase of about 3 to about 400% compared to the same polyolefin composition without melt blending with random alpha-olefinic copolymer and optional tackifier; and wherein the polyolefin composition has a melt flow rate increase of about 3 to about 1500% compared to the same polyolefin composition without the visbreaking extrusion and melt blending with random alpha-olefinic copolymer and optional tackifier.

It is to be understood that the following detailed description is provided to give the reader a fuller understanding of certain embodiments, features, and details of aspects of the invention, and should not be interpreted as a limitation of the scope of the invention.

Certain terms used throughout this disclosure are defined hereinbelow so that the present invention may be more readily understood. Additional definitions are set forth throughout the disclosure.

Each term that is not explicitly defined in the present application is to be understood to have a meaning that is commonly accepted by those skilled in the art. If the construction of a term would render it meaningless or essentially meaningless in its context, the term's definition should be taken from a standard dictionary.

The use of numerical values in the various ranges specified herein, unless expressly indicated otherwise, is considered to be approximations as though the minimum and maximum values within the stated ranges were both preceded by the word “about.” In this context, the term “about” is meant to encompass the stated value±a deviation of 1%, 2%, 3%, 4%, or not more than 5% of the stated value. In this manner, slight variations above and below the stated ranges can be used to achieve substantially the same results as the values within the ranges. In addition, the disclosure of these ranges is intended as a continuous range including every value between the minimum and maximum values.

Unless otherwise indicated, % solids or weight % (wt %) are stated in reference to the total weight of a specific formulation, composition, compound or masterbatch.

As used herein, “polymers” may refer to homopolymers, copolymers, interpolymers, terpolymers, etc. A “polymer” has two or more of the same or different monomer derived units. A “homopolymer” is a polymer having derived monomer units that are the same. A “copolymer” is a polymer having two or more derived monomer units that are different from each other. A “terpolymer” is a polymer having three monomer derived units that are different from each other. The term “different” as used to refer to monomer derived units indicates that the monomer derived units differ from each other by at least one atom or are different isomerically. Accordingly, the definition of copolymer, as used herein, includes terpolymers and the like. Likewise, the definition of polymer, as used herein, includes copolymers and the like.

In this invention, a polyolefin composition is provided comprising: (A) about 60 to about 96 wt % of at least one recycled polyolefin; (B) about 2 to about 20 wt % of at least one random alpha-olefinic copolymer and (C) about 2 to about 20 wt % of at least one tackifier; wherein the polyolefin composition has a weight ratio of random alpha-olefinic copolymer to tackifier of between about 0.2 to about 5.0; and wherein the polyolefin composition has a melt flow rate increase of about 3 to about 400% compared to the same polyolefin composition without the random alpha-olefinic copolymer and tackifier.

For the purposes of the present description and of the subsequent claims, the term “recycled polyolefin” is used to indicate a material recovered from post-consumer waste (PCR), industrial waste, and/or post-industrial waste (PIR), as opposed to virgin polymers.

“Post-consumer waste” refers to objects having completed at least a first use cycle (or life cycle), i.e., having already served their first purpose; while “post-industrial waste” and “industrial waste” refer to manufacturing scrap, which does not normally reach a consumer. The term “virgin” denotes the newly produced materials and/or objects prior to their first use, which have not already been recycled.

The recycled polyolefin comprises at least one polymer selected from the group consisting of ethylene polymers and propylene polymers. Any type of ethylene polymers or propylene polymers known in the art can be utilized as the recycled polyolefin known in the art.

Ethylene polymers otherwise known as “polyethylene” include polyethylene homopolymers and ethylene-alpha-olefin copolymers comprising at least 50 mol % ethylene derived units. The ethylene-alpha-olefin copolymers can have an alpha-olefin comonomer(s) content greater than 5 wt %, greater than 7 wt % or greater than 10 wt %, based on the total weight of polymerizable monomers.

Ethylene-alpha-olefin copolymers include comonomers comprising one or more C₃ to C₄₀ olefin derived units. In another embodiment, the ethylene-alpha-olefin copolymers comprise C₃ to C₄₀ olefin derived units. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups.

Exemplary C₃ to C₄₀ olefin comonomers include, but are not limited to, propylene, butene, pentene, hexene, heptene, octene, nonene, decene, undecene, dodecene, norbornene, norbomadiene, dicyclopentadiene, cyclopentene, cycloheptene, cyclooctene, cyclooctadiene, cyclododecene, 7-oxanorbomene, 7-oxanorbornadiene, and substituted derivatives and isomers thereof. Examples of substituted derivatives and isomers are, but are not limited to, 1,5-cyclooctadiene, 1-hydroxy-4-cyclooctene, 1-acetoxy-4-cyclooctene, 5-methylcyclopentene, and norbomadiene.

Exemplary comonomers include, but are not limited to, propylene, isobutylene, 1-butene, 1-pentene, 1-hexene, 3-methyl-1-pentene, 4-methyl-1-pentene, and 1-octene, non-conjugated dienes, polyenes, butadienes, isoprenes, pentadienes, hexadienes (for example, 1,4-hexadiene), octadienes, styrene, halo-substituted styrene, alkyl-substituted styrene, tetrafluoroethylenes, vinylbenzocyclobutene, naphthenics, cycloalkenes (for example, cyclopentene, cyclohexene, cyclooctene), and mixtures thereof. Typically, the ethylene is copolymerized with one C₃-C₂₀ alpha-olefin.

Exemplary diene or triene comonomers include, but are not limited to, 7-methyl-1,6-octadiene; 3,7-dimethyl-1,6-octadiene; 5,7-dimethyl-1,6-octadiene; 3,7,11-trimethyl-1,6,10-octatriene; 6-methyl-1,5 heptadiene; 1,3-butadiene; 1,3-pentadiene, norbornadiene, 1,6-heptadiene; 1,7-octadiene; 1,8-nonadiene; 1,9-decadiene; 1,10-undecadiene; norbornene; tetracyclododecene; or mixtures thereof. In another embodiment, the diene or triene comonomer is at least one selected from the group consisting of butadienes, hexadienes, and octadienes. In yet another embodiment, the diene or triene comonomer is at least one selected from the group consisting of 1,4-hexadiene; 1,9-decadiene; 4-methyl-1,4-hexadiene; 5-methyl-1,4-hexadiene; dicyclopentadiene; and 5-ethylidene-2-norbomene (ENB), 1,3-butadiene, 1,3-pentadiene, norbornadiene, and dicyclopentadiene; C₈-C₄₀ vinyl aromatic compounds including sytrene, o-, m-, and p-methylstyrene, divinylbenzene, vinylbiphenyl, vinylnapthalene; and halogen-substituted C₈-C₄₀ vinyl aromatic compounds such as chlorostyrene and fluorostyrene.

Polyethylene polymers include, but are not limited to, low density polyethylene, linear low density polyethylene, medium density polyethylene, high density polyethylene, ultra-low density polyethylene and ultra-high molecular weight polyethylene.

Low density polyethylene is generally prepared at high pressure using free radical initiators or in gas phase processes using Ziegler-Natta or vanadium catalysts. Low density polyethylene typically has a density in the range of about 0.916 g/cm³ to about 0.950 g/cm³. Typical low density polyethylene produced using free radical initiators is known in the industry as “LDPE”. LDPE is also known as “branched” or “heterogeneously branched” polyethylene because of the relatively large number of long chain branches extending from the main polymer backbone.

Polyethylene in the same density range of 0.916 g/cm³ to 0.950 g/cm³, which is linear and does not contain long chain branching, is known as linear low density polyethylene (LLDPE) and is typically produced by conventional Ziegler-Natta catalysts or with metallocene catalysts. “Linear” means that the polyethylene has few, if any, long chain branches.

Medium density polyethylene (MDPE), typically has a density between 0.926 and 0.940 g/cm³ and is generally produced by low pressure polymerization techniques using transition metal catalysts such as Ziegler-Natta or metallocene catalysts

High density polyethylene (HDPE), typically has a density greater than about 0.950 g/cm³ and is generally prepared with Ziegler-Natta catalysts or chrome catalysts.

Ultra-high molecular weight polyethylene (UHMWPE) refers to HDPE with much higher molecular weight, typically 10 times higher. UHMWPE is typically produced by metallocene catalysts.

Ultra-low density polyethylene (ULDPE) can be produced by a number of different processes yielding polyethylene having a density less than about 0.916 g/cm³. In other embodiments, the ULDPE has a density in the range of about 0.890 g/cm³ to about 0.915 g/cm³ or about 0.900 g/cm³ to about 0.915 g/cm³.

Propylene polymers otherwise known as “polypropylene” include propylene homopolymers and propylene copolymers comprising at least 50 mol % propylene derived units. The term “polypropylene” includes but is not limited, to atactic polypropylene (aPP), isotactic polypropylene (iPP), defined as having at least 10% or more isotactic pentads, highly isotactic polypropylene, defined as having 50% or more isotactic pentads, syndiotactic polypropylene (sPP), defined as having at 10% or more syndiotactic pentads, homopolymer polypropylene (hPP), also called propylene homopolymer or homopolypropylene, and so-called random copolymer polypropylene (RCP) also called propylene random copolymer. Herein, an RCP can include a copolymer of propylene and 1 to 10 wt % of an olefin derived unit chosen from ethylene and C₄ to C₈ alpha-olefins. A polyolefin is “atactic”, also referred to as “amorphous”, if it has less than 10% isotactic pentads and syndiotactic pentads.

Propylene copolymers, also referred to as “propylene-alpha-olefin copolymers” contain polymers where the propylene is copolymerized with ethylene or one C₄-C₂₀ alpha-olefin.

Suitable comonomers for copolymerizing with propylene include, but are not limited to, ethylene, 1-butene, 1-pentene, 1-hexene, 1-heptene, 1-octene, 1-nonene, 1-decene, 1-unidecene, 1-dodecene, 4-methyl-1-pentene, 4-methyl-1-hexene, 5-methyl-1-hexene, vinylcyclohexene, and styrene.

Exemplary propylene copolymers comprise derived units of propylene/ethylene, propylene/1-butene, propylene/1-hexene, propylene/4-methyl-1-pentene, propylene/1-octene, propylene/ethylene/1-butene, propylene/ethylene/ethylidene norbornene (ENB), propylene/ethylene/1-hexene, propylene/ethylene/1-octene, propylene/styrene, and propylene/ethylene/styrene.

The propylene copolymers comprise derived units of ethylene or C₄-C₂₀ alpha-olefin derived units (or “comonomer-derived units”) within the range of from 5 wt % to 50 wt %, 6 wt % to 40 wt %, 7 wt % to 35 wt %, 8 wt % to 20 wt %, and 10 wt % to 15 wt % by weight of the copolymer. The propylene-alpha-olefin copolymer may also comprise derived units of two different comonomer-derived units. Further, these copolymers and terpolymers may comprise diene-derived units. The amount of dienederived units can range from 10 wt % or less of diene derived units (or “diene”), 8 wt % or less, 5 wt % or less, 3 wt % or less, based on the total weight of the terpolymer. In another embodiment, the amount of diene-derived units can range from 0.1 wt % to 10 wt %, 0.5 wt % to 8 wt %, and 1 wt % to 5 wt %.

Suitable dienes include, but are not limited to, 1,4-hexadiene, 1,6-octadiene, 5-methyl-1,4-hexadiene, 3,7-dimethyl-1,6-octadiene, dicyclopentadiene (DCPD), ethylidene norbornene (ENB), norbornadiene, 5-vinyl-2-norbornene (VNB), or combinations thereof.

Propylene copolymers can be a random or block copolymer, propylene-based terpolymer, or a branched polypropylene, or any variation thereof (having some properties of each). Random propylene copolymers have comonomer derived units randomly distributed along the polymer backbone. Block copolymers have comonomer derived units occurring in long sequences.

The propylene homopolymers and copolymers described herein can be produced using any suitable catalyst and/or process known for producing polypropylene homopolymers and copolymers. The polypropylene homopolymers and copolymers may be conventional in composition, and made by gas phase, slurry, or solution type processes.

It is implied by the definition of waste and known to a person skilled in the art that impurities can be present in recycled polyolefin. By impurities, both intentionally and unintentionally added materials to the waste stream are included. These impurities include, but are not limited to, other polymers, additives and fillers.

Such polymer which can be present as impurities in the recycled polyolefin can include, but are not limited to, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, acrylonitrile butadiene styrene (ABS) resins, ethylene propylene rubber (EPR), vulcanized EPR, ethylene propylene diene monomer rubber (EPDM), block copolymer, styrenic block copolymers, polyamides, polycarbonates, polyethylene terephthalate (PET) resins, cross linked polyethylene, copolymers of ethylene and vinyl alcohol (EVOH), polymers comprising aromatic monomers, polyesters, polyacetal, polyvinylidine fluoride, polyethylene glycols, polyisobutylene and/or combinations thereof. An example of polymers comprising aromatic monomers is polystyrene.

Such additives that can be present as impurities in the recycled polyolefin can include, but are not limited to, antioxidants (A.O.), anti-acids, anti-cling additives, plasticizers, tackifiers, UV stabilizers, anti-blocking agents, cross-linking agents, release agents, anti-static agents, anti-microbials, biocides, foaming agents, blowing agents, clarifier agents, flame retardants, catalysts, pigments, colorants, dyes, waxes or combinations thereof. Examples of antioxidants include, but are not limited to, sterically hindered phenolics, such as IRGANOX™ 1010 or IRGANOX™ 1076 by BASF; phosphorous based A.O., such as IRGAFOS™ 168 by BASF; sulphur based A.O., such as Irganox PS-802 FL™ by BASF; nitrogen based A.O., such as, 4,4′-bis (1,1′-dimethylbenzyl)diphenylamine; and A.O. blends. Examples of anti-acids include, but are not limited to, calcium stearate, sodium stearate, zinc stearate, magnesium and zinc oxides, synthetic hydrotalcite, lactates and lactylates, and combinations thereof. Examples of tackifiers include, but are not limited to, polybutenes, terpene resins, aliphatic and aromatic hydrocarbon resins, alkali metal and glycerol stearates, and hydrogenated rosins. An examples of a UV stabilizers include, but are not limited to, bis-(2′2′6′6-tetramethyl-4-piperidyl)-sebacate. Examples of nucleating agents include, but are not limited to, sodium benzoate and 1,3:2,4-bis(3,4-dimethylobenzylideno) sorbitol. Examples of anti-blocking agents include, but are not limited to, diatomaceous earth, synthetic silica, silicates, and synthetic zeolites. Silicates include, but are not limited to, kaolin, sodium aluminum silicate, calcined kaolin, aluminum silicate or calcium silicate. Examples of anti-static agents include, but are not limited to, glycerol esters, ethoxylated amines, and ethoxylated amides. Typically, these additives can be present in quantities from about 100 to about 2000 ppm for each individual additive.

Such fillers that can be present as impurities in the recycled polyolefin can include, but are not limited, coal, fly ash, calcium carbonate, barium sulfate, carbon black, metal oxides, inorganic material, natural material, alumina trihydrate, magnesium hydroxide, bauxite, talc, mica, barite, kaolin, silica, post-consumer glass, or post-industrial glass, synthetic and natural fiber, or any combination thereof. The fillers can be organic, inorganic, or a combination of both, such as with different morphologies.

In one embodiment, the percentage of impurities in the recycled polyolefin is at least 0.1, 0.5, 1, 5, 10, 15, 20, 25, 30, or 35 wt % and/or not more than 90, 85, 80, 75, 70, 65, or 60 wt % based on the weight of the recycled polyolefin. In other embodiments, the percentage of impurities can range from about 0.1 to about 86 wt %, about 0.5 to about 85 wt %, about 1 to about 80 wt %, about 5 to about 75 wt %, about 10 to about 70 wt %, about 15 to about 65 wt %, and about 20 to about 60 wt % based upon the weight of the recycled polyolefin in the polyolefin composition. Other amounts below and above these ranges can be present.

In another embodiment for some types of recycled polyolefin, the percentage of impurities in the recycled polyolefin is from about 0.1 to about 10 wt %, about 0.1 to about 5 wt %, about 0.5 to about 5 wt %, and about 0.5 to about 3 wt % based upon the weight of the recycled polyolefin in the polyolefin composition. Other amounts below and above these ranges can be present.

In at least one other embodiment, the percentage of fillers in the recycled polyolefin is from about 5 to about 85 wt %, about 10 to about 85 wt %, about 20 to about 85 wt %, about 30 to about 85 wt %, about 40 to about 85 wt %, and from 50 to about 85 wt % based upon the weight of the recycled polyolefin in the polyolefin composition. Other amounts below and above these ranges can be present.

For the purpose of the present invention, the weight percentage of the recycled polyolefin shall be considered the weight percentage of the recycled polyethylene-rich polyolefin and/or polypropylene-rich recycled polyolefin, including the impurities.

In other embodiments of the invention, the amount of recycled polyolefin in the polyolefin composition can range from at least 60, 61, 62, 63, 64, 65, 66, 67, 68, 69, 70, 71, 72, 73, 74, 75, 76, 77, 78, 79, 80, 81, 82, 83, 84, 85, 86, 87, 88, or 89 wt % and/or not more than 90, 91, 92, 93, 94, 95, or 96 wt % based on the weight of the polyolefin composition. Other ranges can be from about 60 to about 96 wt %, about 65 to about 90 wt %, about 70% to about 85 wt %, and about 75% to about 85 wt % based on the weight of the polyolefin composition.

A recycled polyolefin is considered a polyethylene-rich recycled polyolefin when it comprises at least 50 wt %, at least 55 wt %, at least 60 wt %, at least 65 wt %, at least 70 wt %, at least 80 wt %, at least 85 wt %, at least 90 wt %, at least 95 wt %, at least 97 wt %, or at least 98 wt % ethylene polymers. In such a polyethylene-rich recycled polyolefin, polyethylene is also referred to as the majority component.

A recycled polyolefin is considered a polypropylene-rich recycled polyolefin when it comprises of at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 97 wt %, or at least 98% propylene polymers. In such a polypropylene-rich recycled polyolefin, polypropylene is also referred to as the majority component.

Random alpha-olefinic polymers can be any that is known in the art, including but not limited to homopolymers and copolymers. Random alpha-olefinic copolymers can be any that is known in the art. In one embodiment of the invention, random alpha-olefinic copolymers are also referred to as amorphous polyolefins (APO) or amorphous poly-alpha-olefins (APAO) and include, but are not limited to, amorphous propylene-ethylene copolymers which can comprise varying amounts of ethylene or propylene. For example, the propylene-ethylene copolymers can comprise at least 1, 3, 5, 7, 10, 12, 14, 15, 17, 18, or 20 and/or not more than 70, 65, 60, 55, 50, 45, 40, 35, 30, 27, or 25 weight percent of ethylene. Moreover, the propylene-ethylene copolymers can comprise in the range of about 1 to about 70, about 3 to about 65, about 5 to about 60, about 7 to about 55, about 10 to about 50, about 12 to about 45, about 14 to about 40, about 15 to about 35, about 17 to about 30, about 18 to about 27, or about 20 to about 25 weight percent of ethylene. For example, the propylene-ethylene copolymers can comprise at least 40, 50, 60, 65, or 70 and/or not more than 99, 95, 90, 85, or 80 weight percent of propylene. Moreover, the propylene-ethylene copolymers can comprise in the range of about 40 to about 99, about 50 to about 95, about 60 to about 90, about 65 to about 85, or about 70 to about 80 weight percent of propylene.

Furthermore, APO can include propylene-ethylene copolymers which can contain derived units of one or more C₄-C₁₀ alpha-olefins. These C₄-C₁₀ alpha-olefins can include, for example, 1-butene, 1-pentene, 1-hexene, 1-heptene, 1-octene, 1-nonene, 1-decene, and combinations thereof. According to one or more embodiments, the copolymers can comprise at least 0.5, 1, 2, 3, 4, or 5 and/or not more than 40, 30, 25, 20, 15, or 10 weight percent of at least one C₄-C₁₀ alpha-olefin. Moreover, the copolymers can comprise in the range of about 0.5 to about 40, about 1 to about 30, about 2 to about 25, about 3 to about 20, about 4 to about 15, or about 5 to about 10 weight percent of at least one C₄-C₁₀ alpha-olefin. Exemplary commercial random alpha-olefinic copolymers include Aerafin™ 17 and Eastoflex™ E1200 obtained from Eastman Chemical Company.

Furthermore, APO can include polypropylene homopolymers Exemplary commercial random alpha-olefinic homopolymers include Eastoflex™ P1010 and Eastoflex™ P1023 obtained from Eastman Chemical Company

In one embodiment of the invention, the random alpha-olefinic copolymers can have a number average molecular weight equal or below 25000 mol/g, equal or below 10000 mol/g. In other embodiments, the number average molecular weight can be from 2500 to 25000 g/mol and/or from 4500 to 10000 g/mol. The polydispersity index of the random alpha-olefinic copolymers can range from about 4.0 to about 10.0 or from about 5.0 and about 7.5.

The number average molecular weight is measured using a Malvern Viscotek HT-350A High Temperature Gel Permeation Chromatograph (HTGPC) equipped with 2 Viscotek VE1122 pumps, a Viscotek Model 430 vortex heater stirrer autosampler, a VE7510 GPC degasser, a HTGPC Module 350A oven, a Microlab 500 series auto syringe for sample preparation, and a triple detection system consisting of a combination of laser light scattering, refractometer, and differential viscosity detectors. The GPC contains 1× PLGel 5 micron Guard 50×7.5 mm column and 2×PLGel 5 micron mixed-C 300×7.5 mm columns running 1,2,4-trichlorobenzene as the solvent at a flow rate of 0.7 ml/min at 135° C. 50 to 70 mg of each sample are weighed into sample vials and mixed with 10 mL of 1,2,4-trichlorobenzene to make a 5.0 to 7.0 mg/mL blend. The vials are placed in a Viscotek Model 430 vortex heater stirrer autosampler to equilibrate at room temperature, for about 1 hour, under agitation using a magnetic stirrer bar, then the samples are heated for no more than 4 hours at 135° C. For each specimen, two injections are used, and the chromatograms for each injection are collected. The samples are analyzed by conventional GPC using a single narrow polystyrene standard calibration, light scattering, triple detection and universal calibration. The analysis of the light scattering data, the conventional GPC analysis, triple detection analysis, and universal calibration analysis are done using same Malvern OmniSEC software.

The weight average molecular weight (Mw) and number average molecular weight (Mn) are determined for each sample using the Malvern OmniSEC software. The polydispersity Index (PDI) is calculated by dividing the weight average molecular weight by the number average molecular weight (PDI=Mw/Mn).

The random alpha-olefinic copolymers can have a glass transition temperature (Tg) (Differential scanning calorimetry according ASTM D3418-15; 20° C./min) equal or below −10° C., equal or below −25° C., or equal or below −35° C.

Tackifiers, also referred to as “tackifier resin” include, but are not limited to, cycloaliphatic hydrocarbon resins, C5 hydrocarbon resins, C5/C9 hydrocarbon resins, aromatically-modified C5 resins, C9 hydrocarbon resins, pure monomer resins, C5 resins, and C9 resins, terpene resins, terpene phenolic resins, terpene styrene resins, rosin esters, modified rosin esters, liquid resins of fully or partially hydrogenated rosins, fully or partially hydrogenated rosin esters, fully or partially hydrogenated modified rosin resins, fully or partially hydrogenated rosin alcohols, fully or partially hydrogenated C5 resins, fully or partially hydrogenated C5/C9 resins, fully or partially hydrogenated aromatically-modified C5 resins, fully or partially hydrogenated C9 resins, fully or partially hydrogenated pure monomer resins, fully or partially hydrogenated C5/cycloaliphatic resins, fully or partially hydrogenated C5/cycloaliphatic/styrene/C9 resins, fully or partially hydrogenated cycloaliphatic resins; and combinations thereof. Exemplary commercial tackifiers include Regalite™ and Eastotac™ H hydrocarbon resins obtained from Eastman Chemical Company. Furthermore, the tackifiers can comprise functionalized groups.

The term “PMR” as used herein means pure monomer resins. Pure monomer resins are produced from the polymerization of styrene-based monomers, such as, styrene, alpha-methyl styrene, vinyl toluene, and other alkyl substituted styrenes. Pure monomer resins are produced by any method known in the art. Pure monomer feedstock for the production of pure monomer resins are in some cases synthetically generated or highly purified monomer species. For example, styrene can be generated from ethyl benzene or alpha methyl styrene from cumene. In one embodiment, pure monomer hydrocarbon resins are prepared by cationic polymerization of styrene-based monomers such as styrene, alpha-methyl styrene, vinyl toluene, and other alkyl substituted styrenes using Friedel-Crafts polymerization catalysts such as Lewis acids (e.g., boron trifluoride (BF₃), complexes of boron trifluoride, aluminum trichloride (AlCl₃), and alkyl aluminum chlorides). Solid acid catalysts can also be utilized to produce pure monomer resins. The pure monomer resins disclosed herein are non-hydrogenated, partially hydrogenated, or fully hydrogenated resins. The term “hydrogenated” as used herein is also indicated alternatively in the shorthand “H2” and when H2 is used preceding or following a resin type it is intended to indicate that resin type is hydrogenated or partially hydrogenated, such as “PMR H2” and “C5 H2” for example. When “H2” is used herein, “H2” is meant to encompass both fully hydrogenated resin samples and partially hydrogenated resin samples. Thus, “H2” refers to the condition in which the resin is either fully hydrogenated or at least partially hydrogenated. Pure monomer resins are in some instances obtained as Piccolastic® styrenic hydrocarbon resins, Kristalex® styrenic/alkyl styrenic hydrocarbon resins, Piccotex® alkyl styrenic hydrocarbon resins, and Regalrez® hydrogenated or partially hydrogenated pure monomer resins from Eastman Chemical Company (Kingsport, Tenn., US).

The term “C5 resin” as used herein means aliphatic C5 hydrocarbon resins that are produced from the polymerization of monomers comprising C5 and/or C6 olefin species boiling in the range from about 20° C. to about 200° C. at atmospheric pressure. These monomers are typically generated from petroleum processing, e.g., cracking. The aliphatic C5 hydrocarbon resins of this invention can be produced by any method known in the art. In one embodiment, aliphatic C5 hydrocarbon thermoplastic resins are prepared by cationic polymerization of a cracked petroleum feed containing C5 and C6 paraffins, olefins, and diolefins also referred to as “C5 monomers.” These monomer streams are comprised of cationically polymerizable monomers such as 1,3-pentadiene which is the primary reactive component along with cyclopentene, pentene, 2-methyl-2-butene, 2-methyl-2-pentene, cyclopentadiene, and dicyclopentadiene. The polymerizations are catalyzed using Friedel-Crafts polymerization catalysts such as Lewis acids (e.g., boron trifluoride (BF₃), complexes of boron trifluoride, aluminum trichloride (AlCl₃), and alkyl aluminum chlorides). In addition to the reactive components, nonpolymerizable components in the feed include saturated hydrocarbons that are in some instances co-distilled with the unsaturated components such as pentane, cyclopentane, or 2-methylpentane. Solid acid catalysts can also be utilized to produce aliphatic C5 hydrocarbon resins. Aliphatic C5 hydrocarbon resins include non-hydrogenated, partially hydrogenated, or fully hydrogenated resins. Aliphatic C5 resins can be obtained as Piccotac® C5 and Eastotac® C5 H2 resins from Eastman Chemical Company (Kingsport, Tenn., US).

The term “C5/C9 resin” as used herein means an aliphatic/aromatic hydrocarbon C5/C9 resin that is produced from the polymerization of monomers comprising at least one unsaturated aromatic C8, C9, and/or C10 species boiling in the range from about 100° C. to about 300° C. at atmospheric pressure and at least one monomer comprising C5 and/or C6 olefin species boiling in the range from about 20° C. to about 200° C. at atmospheric pressure. In one embodiment, C5 and/or C6 species include paraffins, olefins, and diolefins also referred to as “C5 monomers.” These monomer streams are comprised of cationically polymerizable monomers such as 1,3-pentadiene which is the primary reactive component along with cyclopentene, pentene, 2-methyl-2-butene, 2-methyl-2-pentene, cyclopentadiene, and dicyclopentadiene. In one embodiment, unsaturated aromatic C8, C9, and/or C10 monomers are derived from petroleum distillates resulting from naphtha cracking and are referred to as “C9 monomers.” These monomer streams are comprised of cationically polymerizable monomers such as styrene, alpha methyl styrene, beta-methyl styrene, vinyl toluene, indene, dicyclopentadiene, divinylbenzene, and other alkyl substituted derivatives of these components. The cationic polymerization is in some instances catalyzed using Friedel-Crafts polymerization catalysts such as Lewis acids (e.g., boron trifluoride (BF₃), complexes of boron trifluoride, aluminum trichloride (AlCl₃), and alkyl aluminum chlorides). Solid acid catalysts are also utilized to produce aliphatic/aromatic C5/C9 hydrocarbon thermoplastic resins. In addition to the reactive components, non-polymerizable components include, aromatic hydrocarbons such as xylene, ethyl benzene, cumene, ethyl toluene, indane, methylindane, naphthalene and other similar specifies. The non-polymerizable components of the feed stream are in some embodiments incorporated into the resins via alkylation reactions. Aliphatic/aromatic C5/C9 hydrocarbon resins include non-hydrogenated, partially hydrogenated resins, and hydrogenated resins. Aliphatic/aromatic C5/C9 thermoplastic resins can be obtained as Piccotac® resin from Eastman Chemical Company. The proportion of C5 to C9 is not limited. In other words, the amount of C5 monomer in the C5/C9 resin can be anywhere from 0.1 to 100% and vice versa the amount of C9 monomer in the C5/C9 resin can be from 0.1 to 100%.

The term “C9 resin” as used herein means an aromatic C9 hydrocarbon resin that is a resin produced from the polymerization of monomers comprising unsaturated aromatic C8, C9, and/or C10 species boiling in the range from about 100° C. to about 300° C. at atmospheric pressure. These monomers are typically generated from petroleum processing, e.g., cracking. The aromatic C9 hydrocarbon thermoplastic resins of this invention can be produced by any method known in the art. Aromatic C9 hydrocarbon resins are in one embodiment prepared by cationic polymerization of aromatic C8, C9, and/or C10 unsaturated monomers derived from petroleum distillates resulting from naphtha cracking and are referred to as “C9 monomers.” These monomer streams are comprised of cationically polymerizable monomers such as styrene, alpha methyl styrene (AMS), beta-methyl styrene, vinyl toluene, indene, dicyclopentadiene, divinylbenzene, and other alkyl substituted derivatives of these components. Aliphatic olefin monomers with four to six carbon atoms are also present during polymerization in some embodiments of C9 resins. The polymerization is in some instances catalyzed using Friedel-Crafts polymerization catalysts such as Lewis acids (e.g., boron trifluoride (BF₃), complexes of boron trifluoride, aluminum trichloride (AlCl₃), and alkyl aluminum chlorides). In addition to the reactive components, nonpolymerizable components include, but are not limited to, aromatic hydrocarbons such as xylene, ethyl benzene, cumene, ethyl toluene, indane, methylindane, naphthalene, and other similar chemical species. The nonpolymerizable components of the feed stream are in some embodiments incorporated into the thermoplastic resins via alkylation reactions. C9 hydrocarbon resins include non-hydrogenated, partially hydrogenated, or fully hydrogenated resins. Aromatic C9 hydrocarbon resins can be obtained as Picco® C9 resin, and aliphatic hydrogenated and aliphatic/aromatic partially hydrogenated C9 H2 hydrocarbon resins can be obtained as Regalite® resin from Eastman Chemical Company.

The term “DCPD resin” as used herein means dicyclopentadiene (DCPD), most commonly formed through ring opening metathesis polymerization (ROMP) of dicyclopentadiene in the presence of a strong acid catalyst, such as maleic acid or aqueous sulphuric acid, or thermal polymerization. Dicyclopentadiene is also formed in some embodiments by a Diels Alder reaction from two cyclopentadiene molecules and exists in two stereo-isomers: endo-DCPD and exo-DCPD. Typically, greater than 90% of the DCPD molecules present in commercial grades of DCPD are in the endo form. DCPD thermoplastic resins include aromatic-modified DCPD resins as well as hydrogenated, partially hydrogenated, and non-hydrogenated resins, though in most instances herein only H2 DCPD is described since it is the most readily commercially available form of DCPD. Aromatic-modified DCPD is also contemplated as a DCPD resin. Aromatic modification is, for instance, by way of C9 resin oil, styrene, or alpha methyl styrene (AMS), and the like. Hydrogenated and partially hydrogenated DCPD and hydrogenated and partially hydrogenated aromatic-modified DCPD resin is commercially available as Escorez® 5000-series resin (ExxonMobil Chemical Company, TX, US).

The term “terpene resin” or “polyterpene resin” as used herein means resins produced from at least one terpene monomer. For example, α-pinene, β-pinene, d-limonene, and dipentene can be polymerized in the presence of aluminum chloride to provide polyterpene thermoplastic resins. Other examples of polyterpene thermoplastic resins include Sylvares® TR 1100 and Sylvatraxx® 4125 terpene thermoplastic resin (AZ Chem Holdings, LP, Jacksonville, Fla., US), and Piccolyte® A125 terpene thermoplastic resin (Pinova, Inc., Brunswick, Ga., US). Terpene resins can also be modified with aromatic compounds. Sylvares® ZT 105LT and Sylvares® ZT 115 LT terpene resins are aromatically modified (Az Chem Holdings, LP, Jacksonville, Fla., US).

It is to be understood that encompassed by the above definitions of certain types of thermoplastic resins, such as DCPD, PMR, C5, C9, C5/C9, terpene, and the like, including hydrogenated, partially-hydrogenated, and non-hydrogenated versions of these resins, that these resins include resins of similar types generated by mixing or blending of dissimilar feedstocks to produce heterogeneous mixtures of the feedstocks used to generate the thermoplastic resins. Furthermore, it is to be understood that at least with respect to the PMR and terpene resins discussed herein these resins encompass various known derivatives of such resins such as phenol-modified and rosin-modified versions of the resins.

The tackifier has a glass transition temperature (Tg) (Differential scanning calorimetry according ASTM D3418-15; 20° C./min) equal or above 25° C., equal or above 30° C., equal or above 35° C., equal or above 40° C., equal or above 45° C., equal or above 50° C., equal or above 55° C., equal or above 60° C., equal or above 65° C., or equal or above 70° C., or equal or above 75° C., or equal or above 80° C., or equal or above 85° C. In other embodiments, the tackifier has a glass transition temperature (Differential scanning calorimetry according ASTM D3418-15; 20° C./min) ranging from about 30° C. to about 90° C., about 35° C. to about 90° C., about 40° C. to about 90° C., about 45° C. to about 90° C., about 50° C. to about 90° C., about 55° C. to about 90° C., about 60° C. to about 90° C., about 65° C. to about 90° C., about 70° C. to about 90° C., about 75° C. to about 90° C., and about 80° C. to about 90° C.

The present invention relates to polyolefin compositions having improved flow properties while retaining acceptable mechanical properties. Polyethylene-rich recycled polyolefin compositions particularly can have improved flow and improved elongation at break while retaining acceptable mechanical properties and/or providing an advantageous balance of properties for a particular application. The invention provides compositions comprising at least one recycled polyolefin (A), at least one random alpha-olefinic copolymer (B) and at least one tackifier (C). In some embodiments, compositions and methods described herein relate to recycled polyolefins selected from the group consisting of ethylene-rich or propylene-rich recycled polyolefins wherein the random alpha-olefinic copolymer is at least one amorphous propylene-ethylene random copolymer, such as Aerafin™ and Eastoflex™ (from Eastman Chemical), together with at least one hydrogenated C9-based tackifiers, such as Regalite™ R1125 and Plastolyn™ R1140 (from Eastman Chemical), and processes of making such polyolefin compositions. In at least one embodiment, through the addition of low levels of a propylene-ethylene random copolymer such as Aerafin™ and a hydrogenated C9-based tackifier such as Regalite™, into the recycled polyolefin, flow properties such as melt flow rate (MFR) can be enhanced while retaining acceptable mechanical properties for the resultant polyolefin composition comprising recycled polyolefin. The low molecular weight Aerafin™ and Regalite™ can reduce the MFR while having an unexpected synergistic behavior towards the mechanical properties. Acceptable mechanical properties are defined subsequently in this disclosure.

The present invention also relates to polyolefin compositions having improved flow properties and improved impact resistance while retaining acceptable mechanical properties. Additionally, polyethylene-rich recycled polyolefin compositions particularly can have improved flow and improved elongation at break while retaining acceptable mechanical properties and/or providing an advantageous balance of properties for a particular application.

The invention provides compositions comprising at least one recycled polyolefin (A), at least one random alpha-olefinic copolymer (B), optionally, at least one tackifier (C), and at least one additional polymer (D). The recycled polyolefin (A), the random alpha-olefinic polymer (B), the optional tackifier (C), and the additional polymer (D) have previously been defined and discussed in this disclosure.

In some embodiments, compositions and methods described herein relate to recycled polyolefins selected from the group consisting of ethylene-rich or propylene-rich recycled polyolefins wherein the random alpha-olefinic copolymer is at least one amorphous propylene-ethylene random copolymer, such as Aerafin™ and Eastoflex™ (from Eastman Chemical), together with at least one additional polymer, such as medium density polyethylene (MDPE) such as Elite™ 5940ST (Dow Chemical, USA), and optionally, together with at least one hydrogenated C9-based tackifier, such as Regalite™ R1125 and Plastolyn™ R1140 (from Eastman Chemical), and processes of making such polyolefin compositions.

In at least one embodiment, through the addition of low levels of a propylene-ethylene random copolymer such as Aerafin™ and an ethylene-acrylate copolymer into the recycled polyolefin, flow properties such as melt flow rate (MFR) can be enhanced while retaining acceptable mechanical properties for the resultant polyolefin composition comprising recycled polyolefin. The low molecular weight random alpha-olefinic copolymer along with ethylene-acrylate copolymer can increase the MFR and increase the impact strength while having an unexpected synergistic behavior towards other mechanical properties. In at least one aspect of the embodiment, the polyolefin composition has acceptable yield strength and increased elongation at break compared to the same polyolefin composition without the at least one random alpha-olefinic copolymer, the optional tackifier, and the at least one additional polymer. In other embodiments, the polyolefin composition maintains acceptable mechanical properties. Acceptable mechanical properties are defined subsequently in this disclosure.

The surprisingly improved elongation at break results in a polyethylene-rich polyolefin composition that is less brittle, more easily de-moldable without breaking, and more tolerant of high filler content in the recycled polyolefin feed stream and final composition. High filler content is frequently used to increase the modulus of recycled polyolefin materials, with the corresponding disadvantage of the final composition being too brittle. This invention with a surprising increase in elongation at break can enable the use of these highly filled recycled feed streams in applications where the streams were previously too brittle. Possible applications that can benefit from the increased elongation at break and resulting flexibility include but are not limited to stretch films, wrap films, agricultural films, flooring materials, latches and snap locks, storage containers, and garden furniture.

In at least one embodiment, the recycled polyolefin can have a melt flow rate (MFR), as measured per ISO1133, 2.16 kg at 190° C. of from about 0.1 g/10 min to about 10 g/10 min, from about 0.1 g/10 min to about 5 g/10 min, and from about 0.1 g/10 min to about 2 g/10 min. Fora polyethylene-rich recycled polyolefin, the MFR, as measured per ISO 1133, 2.16 kg at 190° C. can range from about 10 g/10 min or less, about 5 g/10 or less, about 1 g/10 min or less, or about 0.5 g/10 min or less.

In at least one embodiment the recycled polyolefin can have a melt flow rate (MFR), as measured per ISO1133, 2.16 kg at 230° C. or from about 0.1 g/10 min to about 10 g/10 min, from about 0.1 g/10 min to about 5 g/10 min, and from about 0.1 g/10 min to about 2 g/10 min. For a polypropylene-rich recycled polyolefin, the MFR, as measured per ISO 1133, 2.16 kg at 230° C. can range from about 10 g/10 min or less, about 5 g/10 or less, about 1 g/10 min or less, or about 0.5 g/10 min or less.

In at least one embodiment, the percentage of random alpha-olefinic copolymer (B) and tackifier (C) in the polyolefin composition is from about 4 to about 40 wt %, about 4 to about 20 wt %, about 4 to about 14 wt %, or about 7 to about 10 wt % based upon the weight of the polyolefin composition. In another embodiment, the amount of random alpha-olefinic copolymer (B) and tackifier (C) in the polyolefin composition is at least 4, 5, 6, 7, 8, 9, 10, 11, 12, 13, 14, or 15 wt % and not more than 40, 39, 38, 37, 36, 35, 34, 33, 32, 31, 30, 29, 28, 27, 26, 25, 24, 23, 22, 21, or 20 wt % based upon the weight of the polyolefin composition.

In at least one embodiment, the percentage of random alpha-olefinic copolymer (B) and additional polymer (D) in the polyolefin composition is from about 3 wt % to about 80 wt %, about 3% to about 60%, about 3 wt % to about 45 wt %, about 3 wt % to about 20 wt %, about 3 wt % to about 25 wt %, about 3 wt % to about 30 wt %, about 3 wt % to about 35 wt %, about 10 wt % to about 20 wt %, about 10 wt % to about 25 wt %, about 10 wt % to about 30 wt %, about 10 wt % to about 35 wt %, about 15 wt % to about 20 wt %, about 15 wt % to about 25 wt %, about 15 wt % to about 30 wt %, about 15 wt % to about 35 wt %, about 20 wt % to about 30 wt %, about 20 wt % to about 35 wt %, about 20 wt % to about 45 wt %, or about 10 wt % to about 20 wt % based upon the weight of the polyolefin composition.

In another embodiment, the amount of random alpha-olefinic copolymer (B) and additional polymer (D) in the polyolefin composition is at least 3, 4, 5, 6, 7, 8, 9, 10, 11, 12, 13, 14, or 15 wt % and not more than 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, or 40 wt % based upon the weight of the polyolefin composition. In other embodiments, the percentage of random alpha-olefinic copolymer (B) and additional polymer (D) in the polyolefin composition is from about 3 to about 40 wt %, about 3 to about 20 wt %, about 3 to about 14 wt %, or about 7 to about 10 wt % based upon the weight of the polyolefin composition. In another embodiment, the amount of random alpha-olefinic copolymer (B) additional polymer (D) in the polyolefin composition is at least 16, 17, 18, 19, 20, 21, 22, 23, 24, 25, 26, 27, 28, or 29 wt % and not more than 45, 44, 43, 42, 41, 40, 39, 38, 37, 36, 35, 34, 33, 32, 31, or 30 wt % based upon the weight of the polyolefin composition.

The percentage of the random alpha-olefinic polymer can be at least 2, 3, 4, 5, 6, 7, 8, 9, or 10 wt % and/or not greater than 20, 19, 18, 17, 16, or 15 wt % based on the weight of the polyolefin composition. The percentage of the random alpha-olefinic copolymer (B) can range from about 2 to about 20 wt %, about 2 to about 10 wt %, about 5 to about 10 wt % based upon the weight of the polyolefin composition. The percentage of the tackifier (C) can be at least 2, 3, 4, 5, 6, 7, 8, 9, or 10 wt % and/or not greater than 20, 19, 18, 17, 16, 15, 14, 13, 12 or 11 wt % based on the weight of the polyolefin composition. The percentage of the tackifier (C) is from about 2 to about 20 wt %, from about 2 to about 10 wt %, from about 2 to about 7 wt %, and from about 2 to about 5 wt %. The weight ratio of the random alpha-olefinic copolymer (B) to the tackifier (C) is between 0.2 to 5.0, 0.3 to 5.0, 0.4 to 5.0, 0.5 to 5.0, 0.6 to 5.0, 0.7 to 5.0, 0.8 to 5.0, 0.9 to 5.0, 1.0 to 5.0, 1.1 to 5.0, 1.2 to 5.0, 1.3 to 5.0, 1.4 to 5.0, 1.5 to 5.0, 1.6 to 5.0, 1.7 to 5.0, 1.8 to 5.0, 1.9 to 5.0, 2.0 to 5.0, 2.1 to 5.0, 2.2 to 5.0, 2.3 to 5.0, 2.4 to 5.0, 2.5 to 5.0, 2.6 to 5.0, 2.7 to 5.0, 2.8 to 5.0, 2.9 to 5.0, 3.0 to 5.0, 3.1 to 5.0, 3.2 to 5.0, 3.3 to 5.0, 3.4 to 5.0, 3.5 to 5.0, 3.6 to 5.0, 3.7 to 5.0, 3.8 to 5.0, 3.9 to 5.0 or 4.0 to 5.0. The percentage of the random alpha-olefinic polymer can be at least 2, 3, 4, 5, 6, 7, 8, 9, or 10 wt % and/or not greater than 20, 19, 18, 17, 16, or 15 wt % based on the weight of the polyolefin composition. The percentage of the random alpha-olefinic copolymer (B) can range from about 2 to about 20 wt %, about 2 to about 10 wt %, about 5 to about 10 wt % based upon the weight of the polyolefin composition. The percentage of the optional tackifier (C) can be at least 0.5, 1, 2, 3, 4, 5, 6, 7, 8, 9, or 10 wt % and/or not greater than 20, 19.5, 19, 18, 17, 16, 15, 14, 13, 12 or 11 wt % based on the weight of the polyolefin composition. The percentage of the optional tackifier (C) is from about 0.5 to about 20 wt %, from about 1 to about 10 wt %, from about 2 to about 7 wt %, and from about 2 to about 5 wt %. The weight ratio of the random alpha-olefinic copolymer (B) to the optional tackifier (C) is between 0.2 to 5.0, 0.3 to 5.0, 0.4 to 5.0, 0.5 to 5.0, 0.6 to 5.0, 0.7 to 5.0, 0.8 to 5.0, 0.9 to 5.0, 1.0 to 5.0, 1.1 to 5.0, 1.2 to 5.0, 1.3 to 5.0, 1.4 to 5.0, 1.5 to 5.0, 1.6 to 5.0, 1.7 to 5.0, 1.8 to 5.0, 1.9 to 5.0, 2.0 to 5.0, 2.1 to 5.0, 2.2 to 5.0, 2.3 to 5.0, 2.4 to 5.0, 2.5 to 5.0, 2.6 to 5.0, 2.7 to 5.0, 2.8 to 5.0, 2.9 to 5.0, 3.0 to 5.0, 3.1 to 5.0, 3.2 to 5.0, 3.3 to 5.0, 3.4 to 5.0, 3.5 to 5.0, 3.6 to 5.0, 3.7 to 5.0, 3.8 to 5.0, 3.9 to 5.0 or 4.0 to 5.0. The weight ratio between the random alpha-olefinic copolymer (B) and the additional polymer (D) is between 0.2 to 20.0, 0.2 to 15.0, 0.2 to 10.0, 0.2 to 7.5, 0.2 to 5.0, 0.3 to 5.0, 0.4 to 5.0, 0.5 to 5.0, 0.6 to 5.0, 0.7 to 5.0, 0.8 to 5.0, 0.9 to 5.0, 1.0 to 5.0, 1.1 to 5.0, 1.2 to 5.0, 1.3 to 5.0, 1.4 to 5.0, 1.5 to 5.0, 1.6 to 5.0, 1.7 to 5.0, 1.8 to 5.0, 1.9 to 5.0, 2.0 to 5.0, 2.1 to 5.0, 2.2 to 5.0, 2.3 to 5.0, 2.4 to 5.0, 2.5 to 5.0, 2.6 to 5.0, 2.7 to 5.0, 2.8 to 5.0, 2.9 to 5.0, 3.0 to 5.0, 3.1 to 5.0, 3.2 to 5.0, 3.3 to 5.0, 3.4 to 5.0, 3.5 to 5.0, 3.6 to 5.0, 3.7 to 5.0, 3.8 to 5.0, 3.9 to 5.0 or 4.0 to 5.0. The percentage of the additional polymer (D) can be at least 1 wt % and/or not greater than 60 wt % based on the total weight of the polyolefin composition. The percentage of additional polymer (D) can range from about 1 wt % to about 60 wt %, from about 5 wt % to about 40 wt %, from about 5 wt % to about 20 wt %, and from about 10 wt % to about 20 wt %, based upon the weight of the polyolefin composition.

In one embodiment of this invention, a polyolefin composition is provided comprising (A) about 60 to about 96 wt % of at least one recycled polyolefin with a MFR <10 g/10 min (ISO1133); B) about 2 to about 20 wt % of at least one random alpha-olefinic copolymers with a Brookfield viscosity equal or below 25,000 mPa·s (ASTM D 3236, 190° C.) and C) about 2 to about 20 wt % of at least one tackifier with a Ring and Ball softening point equal or above 70° C. (ASTM E 28 or ASTM D6090 or ASTM D6166); wherein the weight ratio of B/C is between 0.2 and 5.0; and wherein the compositions have an MFR increase of about 3 to about 400% compared to the same polyolefin composition without the random alpha-olefinic copolymer and tackifier. In an aspect of this embodiment, the polyolefin composition maintains acceptable mechanical properties. Acceptable mechanical properties are defined subsequently in this disclosure.

In another embodiment of this invention, a polyolefin composition comprising (A) about 60 to about 96 wt % of at least one recycled polyolefin with a MFR <10 g/10 min (ISO1133); B) about 2 to about 20 wt % of at least one random alpha olefinic copolymer with a glass transition temperature equal or below −10° C. (ASTM D 3418-15) and C) about 2 to about 20 wt % of at least one tackifier with a glass transition temperature equal or above 25° C. (ASTM D 3418-15); wherein the weight ratio of B/C is between 0.2 and 5.0; and wherein the polyolefin composition has an MFR increase of about 3 to about 400% compared to the same polyolefin composition without the random alpha-olefinic copolymer and tackifier. In an aspect of this embodiment, the polyolefin composition maintains acceptable mechanical properties. Acceptable mechanical properties are defined subsequently in this disclosure.

In one embodiment of this invention, a polyolefin composition is provided comprising (A) about 60 to about 96 wt % of at least one recycled polyolefin with a MFR <10 g/10 min (ISO1133); B) about 2 to about 20 wt % of at least one random alpha-olefinic copolymers with a Brookfield viscosity equal or below 25,000 mPa·s (ASTM D 3236, 190° C.); optionally, C) about 2 to about 20 wt % of at least one tackifier with a Ring and Ball softening point equal or above 70° C. (ASTM E 28 or ASTM D6090 or ASTM D6166); and D) about 2% to about 60% at least one additional polymer; wherein the weight ratio of B/C is between 0.2 and 5.0; and wherein the compositions have an MFR increase of about 3 to about 400% compared to the same polyolefin composition without the random alpha-olefinic copolymer, additional polymer, and optional tackifier. In an aspect of this embodiment, the polyolefin composition maintains acceptable mechanical properties. In other embodiments, the polyolefin composition has an increase in impact strength of about 2% to about 150% or of about 2% to about 200% compared to the same polyolefin composition without the random alpha-olefinic copolymer, additional polymer, and optional tackifier. In at least one aspect of the above embodiment, the polyolefin composition can have an increase in the elongation at break of as much as about 250% or up to about 300% or up to about 350% or up to about 400% compared to the same polyolefin composition without the random alpha-olefinic copolymer, additional polymer, and optional tackifier. Acceptable mechanical properties are defined subsequently in this disclosure.

In another embodiment of this invention, a polyolefin composition comprising (A) about 60 to about 96 wt % of at least one recycled polyolefin with a MFR <10 g/10 min (ISO1133); B) about 2 to about 20 wt % of at least one random alpha olefinic copolymer with a glass transition temperature equal or below −10° C. (ASTM D 3418-15); optionally, C) about 2 to about 20 wt % of at least one tackifier with a glass transition temperature equal or above 25° C. (ASTM D 3418-15); and D) about 2% to about 45% at least one additional polymer; wherein the weight ratio of B/C is between 0.2 and 5.0; and wherein the compositions have an MFR increase of about 3 to about 400% compared to the same polyolefin composition without the random alpha-olefinic copolymer, additional polymer, and optional tackifier. In an aspect of this embodiment, the polyolefin composition maintains acceptable mechanical properties. In other embodiments, the polyolefin composition has an increase in impact strength of about 2% to about 150% or of about 2% to about 200% compared to the same polyolefin composition without the random alpha-olefinic copolymer, additional polymer, and optional tackifier. In at least one aspect of the above embodiment, the polyolefin composition has an increase in the elongation at break of as much as about 250% or up to about 300% or up to about 350% or up to about 400% compared to the same polyolefin composition without the random alpha-olefinic copolymer, additional polymer, and optional tackifier. Acceptable mechanical properties are defined subsequently in this disclosure.

In another embodiment of the invention, a polyolefin composition is provided comprising (A) about 60 to about 96 wt % of at least one recycled polyolefin with a MFR <10 g/10 min (ISO1133); B) about 2 to about 20 wt % of at least one random alpha-olefinic copolymer with a glass transition temperature equal or below −10° C. (ASTM D 3418-15) and a nominal molecular weight less than or equal to 25,000 g/mol (ISO 16014), and C) about 2 to about 20 wt % of at least one tackifier with a glass transition temperature equal or above 25° C. (ASTM D 3418-15); wherein the weight ratio of B to C is between 0.2 and 5.0; and wherein the polyolefin composition has an MFR increase of about 3 to about 400% compared to the same polyolefin composition without the random alpha-olefinic copolymer and tackifier. In at least one aspect of this embodiment, the polyolefin composition maintains acceptable mechanical properties. Acceptable mechanical properties are defined subsequently in this disclosure.

In another embodiment of this invention, a polyolefin composition comprising (A) about 60 to about 96 wt % of at least one recycled polyolefin with a MFR <10 g/10 min (ISO1133); B) about 2 to about 20 wt % of at least one random alpha olefinic copolymer with a glass transition temperature equal or below −10° C. (ASTM D 3418-15) and a nominal molecular weight equal or below 25,000 g/mol (ISO 16014); optionally, C) about 2 to about 20 wt % of at least one tackifier with a glass transition temperature equal or above 25° C. (ASTM D 3418-15); and D) about 2% to about 60% at least one additional polymer; wherein the weight ratio of B/C is between 0.2 and 5.0; and wherein the compositions have an MFR increase of about 3 to about 400% compared to the same polyolefin composition without the random alpha-olefinic copolymer, additional polymer, and optional tackifier. In an aspect of this embodiment, the polyolefin composition maintains acceptable mechanical properties. In other embodiments, the polyolefin composition has an increase in impact strength of about 2% to about 150% or of about 2% to about 200% compared to the same polyolefin composition without the random alpha-olefinic copolymer, additional polymer, and optional tackifier. In at least one aspect of the above embodiment, the polyolefin composition has an increase in the elongation at break of as much as about 250% or up to about 300% or up to about 350% or up to about 400% compared to the same polyolefin composition without the random alpha-olefinic copolymer, additional polymer, and optional tackifier. Acceptable mechanical properties are defined subsequently in this disclosure.

In another embodiment of the invention, a polyolefin composition is provided comprising (A) about 60 to about 96 wt % of at least one recycled polyolefin with a MFR <10 g/10 min (ISO1133); B) about 2 to about 20 wt % of at least one random alpha-olefinic copolymer with a glass transition temperature equal or below −10° C. (ASTM D 3418-15) and a nominal molecular weight equal or below 25,000 g/mol (ISO 16014), and C) about 2 to about 20 wt % of at least one tackifier with a glass transition temperature equal or above 45° C. (ASTM D 3418-15); wherein the weight ratio of B to C is between 0.2 and 5.0; and wherein the polyolefin composition has an MFR increase of about 3 to about 400% compared to the same polyolefin composition without the random alpha-olefinic copolymer and tackifier and the polyolefin composition maintains acceptable mechanical properties. Acceptable mechanical properties are defined subsequently in this disclosure.

In another embodiment of the invention, a polyolefin composition is provided comprising (A) about 60 to about 96 wt % of at least one recycled polyolefin with a MFR <10 g/10 min (ISO1133); B) about 2 to about 20 wt % of at least one random alpha-olefinic copolymer with a glass transition temperature equal or below −10° C. (ASTM D 3418-15) and a nominal molecular weight equal or below 10,000 g/mol (ISO 16014), and C) about 2 to about 20 wt % of at least one tackifier with a glass transition temperature equal or above 45° C. (ASTM D 3418-15); wherein the weight ratio of B to C is between 0.2 and 5.0; and wherein the polyolefin composition has an MFR increase of about 3 to about 400% compared to the same polyolefin composition without the random alpha-olefinic copolymer and tackifier. In at least one aspect of this embodiment, the polyolefin composition maintains acceptable mechanical properties. Acceptable mechanical properties are defined subsequently in this disclosure.

In at least one embodiment, the random-alpha olefin is a propylene homopolymer. In at least one embodiment, the at least one random alpha-olefinic copolymer comprises propylene homopolymer(s) and ethylene-propylene copolymer(s).

In embodiments of the invention, the polyolefin compositions can have a MFR increase, as measured per ISO1133, 2.16 kg at 190° C. of at least 3, 4, 5, 10, 15, 20, 25, 30, 35, 40, 45, 50, 55, 60, 65, 70, 75, 80, 85, 90, 100, 105, 110, 115, 120, 125, 130, 135, 140, 145, 150, 155, 160, 165, 170, 175, 180, 185, 190, 200, 225, 250, 275, 300, 325, 350, 375, or 400% compared to the same polyolefin composition without the random alpha-olefinic copolymer and tackifier, or compared to the same polyolefin composition without the random alpha-olefinic copolymer and additional polymer, or compared to the same polyolefin composition without the random alpha-olefinic copolymer, tackifier, and additional polymer. In other embodiments, the polyolefin composition can have a MFR increase ranging from about 3% to about 400% about 20% to about 400%, about 50% to about 400%, about 3% to about 200%, about 15% to about 200%, about 20% to about 200%, about 3% to about 150%, about 10% to about 150%, about 15% to about 150%, or about 30 to about 300% compared to the same polyolefin composition without the random alpha-olefinic copolymer and tackifier, or compared to the same polyolefin composition without the random alpha-olefinic copolymer and additional polymer, or compared to the same polyolefin composition without the random alpha-olefinic copolymer, tackifier, and additional polymer.

In embodiments of the invention, the polyolefin compositions can have an elongation at break increase, as measured per ISO 527-2:2012 at 23° C. and a speed of 50 mm/min of at least 5, 10, 15, 20, 25, 30, 35, 40, 45, 50, 55, 60, 65, 70, 75, 80, 85, 90, 100, 105, 110, 115, 120, 125, 130, 135, 140, 145, 150, 155, 160, 165, 170, 175, 180, 185, 190, 200, 225, 250, 275, 300, 325, 350, 375, or 400% compared to the same polyolefin composition without the random alpha-olefinic copolymer and additional polymer, or compared to the same polyolefin composition without the random alpha-olefinic copolymer, tackifier, and additional polymer, or compared to the same polyolefin composition without the random alpha-olefinic copolymer and tackifier. In other embodiments, the polyolefin composition can have an elongation at break increase ranging from about 5% to about 400% about 20% to about 400%, about 50% to about 400%, about 5% to about 200%, about 15% to about 200%, about 20% to about 200%, about 5% to about 150%, about 10% to about 150%, about 15% to about 150%, or about 30 to about 300% compared to the same polyolefin composition without the random alpha-olefinic copolymer and additional polymer, or compared to the same polyolefin composition without the random alpha-olefinic copolymer, tackifier, and additional polymer, or compared to the same polyolefin composition without the random alpha-olefinic copolymer and tackifier.

In embodiments of the invention, the polyolefin compositions can have an impact strength increase, as measured per ISO 179-1 or ISO 180 of at least 2, 10, 15, 20, 25, 30, 35, 40, 45, 50, 55, 60, 65, 70, 75, 80, 85, 90, 100, 105, 110, 115, 120, 125, 130, 135, 140, 145, 150, 155, 160, 165, 170, 175, 180, 185, 190, 200, 225, 250, 275, 300, 325, 350, 375, or 400% compared to the same polyolefin composition without the random alpha-olefinic copolymer and additional polymer, or compared to the same polyolefin composition without the random alpha-olefinic copolymer, tackifier, and additional polymer. In other embodiments, the polyolefin composition can have a MFR increase ranging from about 2% to about 400% about 20% to about 400%, about 50% to about 400%, about 2% to about 200%, about 15% to about 200%, about 20% to about 200%, about 2% to about 150%, about 10% to about 150%, about 15% to about 150%, or about 30 to about 300% compared to the same polyolefin composition without the random alpha-olefinic copolymer and additional polymer, or compared to the same polyolefin composition without the random alpha-olefinic copolymer, tackifier, and additional polymer.

In addition to the MFR, other rheological parameters can also be positively affected such as spiral flow and melt viscosity. The polyolefin composition can have a spiral flow that is from about 5% to about 200%, about 10% to about 175%, about 25% to about 150%, about 50% to about 125%, or about 50% to about 100% above the spiral flow of the same polyolefin composition without the random alpha-olefinic copolymer and tackifier. Spiral flow is measured by using a mold with a spiral with a width of 10 mm and 2 mm depth. The length of the spiral can go up to 800 mm. The polyolefin composition can have a melt viscosity that is from about 5% to about 200%, about 10% to about 175%, about 25% to 150%, about 50 to about 125%, or about 50% to about 100% above the melt viscosity of the same polyolefin composition without the random alpha-olefinic copolymer and tackifier. Melt viscosity is measured with a rheometer.

In addition, the polyolefin composition can have at least one acceptable mechanical property selected from the group consisting of tensile strength at yield (yield strength ISO527-2 or ASTM D882), elongation at break, elongation at yield (tensile strain at yield), Young's modulus (elasticity modulus or E-modulus), tensile strength at maximum load, tensile strain at maximum load, tensile strength at break, tensile strain at break, flexural strength, toughness, film toughness, flexural modulus (bending modulus or G-modulus ISO178), 1% secant modulus, 2% secant modulus, unnotched Charpy impact strength, notched Charpy impact strength (notched impact strength ISO179-1), unnotched Izod impact strength, notched Izod impact strength (ISO180), dart drop impact strength (ASTM D1709A), Elmendorf tear strength (ASTM D1922), and puncture resistance.

As used herein, “acceptable mechanical properties” refers to at least one mechanical property related to the polyolefin composition or any article comprising the polyolefin composition wherein the mechanical property is at least 66%, 70%, 75%, 80%, 85%, 90%, 100%, 105%, 110%, 115%, 120%, 125%, 130%, 135%, 140%, 150%, 155%, 160%, 165%, 170%, 175%, 180%, 185%, 190%, 200%, 225%, 250%, 275%, 300%, 325%, 350%, 375%, 400%, 425%, 450%, 475%, 500%, 525%, 550%, or 575% or about 600%, of the mechanical property compared to the same polyolefin composition without the random alpha-olefinic copolymer and tackifier, or compared to the same polyolefin composition without the random alpha-olefinic copolymer and additional polymer, or compared to the same polyolefin composition without the random alpha-olefinic copolymer, tackifier, and additional polymer.

In other embodiments of the invention, mechanical properties are “acceptable” if at least one mechanical property of the polyolefin composition or any article comprising the polyolefin composition is from about 66% to about 600%, from about 66% to about 550%, about 66% to about 500%, about 66% to about 450%, about 66% to about 400%, about 66% to about 350%, about 66% to about 300%, about 66% to about 250%, about 66% to about 200%, about 66% to about 150%, about 66% to about 120%, about 70% to about 600%, from about 70% to about 550%, about 70% to about 500%, about 70% to about 450%, about 70% to about 400%, about 70% to about 350%, about 70% to about 300%, about 70% to about 250%, about 70% to about 200%, about 70% to about 150%, about 70% to about 120%, about 75% to about 600%, from about 75% to about 550%, about 75% to about 500%, about 75% to about 450%, about 75% to about 400%, about 75% to about 350%, about 75% to about 300%, about 75% to about 250%, about 75% to about 200%, about 75% to about 150%, about 75% to about 120%, about 80% to about 600%, from about 80% to about 550%, about 80% to about 500%, about 80% to about 450%, about 80% to about 400%, about 80% to about 350%, about 80% to about 300%, about 80% to about 250%, about 80% to about 200%, about 80% to about 150%, about 80% to about 120%, 90% to about 600%, from about 90% to about 550%, about 90% to about 500%, about 90% to about 450%, about 90% to about 400%, about 90% to about 350%, about 90% to about 300%, about 90% to about 250%, about 90% to about 200%, about 90% to about 150%, about 90% to about 120%, 100% to about 600%, from about 100% to about 550%, about 100% to about 500%, about 100% to about 450%, about 100% to about 400%, about 100% to about 350%, about 100% to about 300%, about 100% to about 250%, about 100% to about 200%, about 100% to about 150%, or about 100% to about 120% of the same mechanical property of the same polyolefin composition without the random alpha-olefinic copolymer and tackifier, or without the random alpha-olefinic copolymer, tackifier and additional polymer, or without the random alpha-olefinic copolymer and additional polymer.

Various end-use applications for the polyolefin compositions can require a different balance of mechanical properties where values for some properties can be outside of this “acceptable” range and the composition is fit-for-use in the application.

In another embodiment, a polyolefin composition is provided comprising about 85 to about 96 wt % of at least one recycled polyolefin, about 2 to about 10 wt % of at least one random alpha-olefinic copolymer and about 2 to about 5 wt % of at least one tackifier; wherein the MFR, as measured per ISO1133 (2.16 kg at 190° C. for a polyethylene-rich recycled polyolefin, at 230° C. for a polypropylene-rich recycled polyolefin) of the polyolefin composition is from about 25 to about 80% above the MFR of the same polyolefin composition without the random alpha-olefinic copolymer and tackifier; wherein the polyolefin composition has a yield strength (ISO527-2) from about 5 to about 15% below the yield strength of the same polyolefin composition without the random alpha-olefinic copolymer and tackifier, a flexural modulus (ISO178 or ASTM D882) from about 10 to about 20% below the yield strength of the same polyolefin composition without the random alpha-olefinic copolymer and tackifier, and a notched impact strength (ISO178 or ASTM D256) of about 5 to about 15% below the notched impact strength of the same polyolefin composition without the random alpha-olefinic copolymer and tackifier.

In another embodiment of this invention, the polyolefin compositions or any article comprising the polyolefin compositions can display changes in at least one property directly or indirectly related to changes in mechanical properties. Such properties include, but are not limited to, thermal properties (Vicat softening point, heat deflection temperature, sealing temperature, seal strength (ASTM F2029, hot tack ASTM F1921), optical properties (haze e.g. ASTM D1003, gloss e.g. ASTM D2457, light transmission, clarity), dimensional stability, heat resistance, barrier properties (MVTR e.g. ASTM F1249, OTR e.g. ASTM D3985), cold flexibility, melting temperatures, density, machine direction (MD) and transverse direction (TD) stretch ratios, enhanced uni-axial or biaxial orientation, shrink ratio, or melt strength.

A process to make the polyolefin composition is provided comprising melt blending: A) about 60 to about 96 wt % of at least one recycled polyolefin; B) about 2 to about 20 wt % of at least one random alpha-olefinic copolymer C) about 2 to about 20 wt % of at least one tackifier; and D) optionally, at least one additional polymer; wherein the polyolefin composition has a weight ratio of random alpha-olefinic copolymer to tackifier of between about 0.2 to about 5.0; and wherein the polyolefin composition has a melt flow rate increase of about 3 to about 400% compared to the same polyolefin composition without the random alpha-olefinic copolymer and tackifier and optional additional polymer.

In another embodiment, a process to make the polyolefin composition is provided comprising melt blending: A) about 40 to about 96 wt % of at least one recycled polyolefin; B) about 2 to about 20 wt % of at least one random alpha-olefinic copolymer; C) optionally, at least one tackifier, and D) at least one additional polymer; wherein the polyolefin composition has a melt flow rate increase of about 3% to about 400% compared to the same polyolefin composition without the at least one random alpha-olefinic copolymer, the at least one additional polymer, and optional tackifier. In at least one aspect of the above embodiment, the polyolefin composition has an MFR increase of about 3% to about 400% and has an increase in in impact strength of about 2% to about 150% or about 2% to about 200%. In other embodiments, the polyolefin composition has an MFR increase of about 3% to about 400% and has an increase in the elongation at break up to about 250% or up to about 300% or up to about 350% or up to about 400%. In another embodiment of the invention, the polyolefin composition has an MFR, impact strength and elongation at break greater than the same polyolefin composition without the at least one random alpha-olefinic copolymer and the at least one additional polymer. In other embodiments, the polyolefin composition maintains acceptable mechanical properties. In another embodiment, a process to make the polyolefin composition is provided comprising melt blending: A) about 40 to about 96 wt % of at least one polypropylene-rich recycled polyolefin; B) about 2 to about 20 wt % of at least one random alpha-olefinic copolymer, C) optionally at least one tackifier, and D) at least one additional polymer; wherein the polyolefin composition has an elongation at break greater than the same polyolefin composition without the at least one random alpha-olefinic copolymer, the at least one additional polymer, and optional tackifier. In at least one aspect of the above embodiment, the polyolefin composition has an MFR greater than the same polyolefin composition without the at least one random alpha-olefinic copolymer, the at least one additional polymer, and optional tackifier. In other embodiments, the polyolefin composition maintains acceptable mechanical properties. In at least one aspect of the above embodiment, the polyolefin composition has an elongation at break increase of about 65% to about 100% greater than the same polyolefin composition without the at least one random alpha-olefinic copolymer and the at least one additional polymer.

In another embodiment, a process to make the polyolefin composition is provided comprising: 1) dry blending A) about 60 to about 96 wt % of at least one recycled polyolefin, B) about 2 to about 20 wt % of at least one random alpha-olefinic copolymer, C) about 2 to about 20 wt % of at least one tackifier, and D) optionally, at least one additional polymer; wherein the polyolefin composition has a weight ratio of random alpha-olefinic copolymer to tackifier of between about 0.2 to about 5.0; and 2) melt blending the components; wherein the polyolefin composition has a melt flow rate increase of about 3 to about 400% compared to the same polyolefin composition without the random alpha-olefinic copolymer and tackifier.

In another embodiment, a process to make the polyolefin composition is provided comprising: 1) dry blending A) about 40 to about 96 wt % of at least one recycled polyolefin, B) about 2 to about 20 wt % of at least one random alpha-olefinic copolymer, C) optionally, about 2 to about 20 wt % of at least one tackifier, and D) about 2% to about 10% at least one additional polymer; and 2) melt blending the components; wherein the polyolefin composition has a melt flow rate increase of about 3% to about 400% and can have an increase in impact strength of about 2% to about 150% or of about 2% to about 200% compared to the same polyolefin composition without the at least one random alpha-olefinic copolymer, the at least one additional polymer, and optionally, the at least one tackifier resin. In at least one aspect of the above embodiment, the polyolefin composition also has an increase in the elongation at break of as much as about 250% or up to about 300% or up to about 350% or up to about 400%. In some embodiments of the invention, the polyolefin composition maintains acceptable mechanical properties. The polyolefin compositions may be formed by melt blending the recycled polyolefin (A), random alpha-olefinic copolymer (B), optionally, at least one tackifier (C), and optionally, the at least one additional polymer (D) by any means known in the art. In one embodiment, dry blending powders, flakes, pellets or combinations are utilized prior to routing to the melt blending step. Examples of equipment used in dry blending include, but is not limited to, a tumble blender, ribbon blender, Henschel mixer, double-cone blender or other suitable blender, where recycled polyolefins (A), random alpha-olefinic copolymer(s) (B) optionally, at least one tackifier(s) (C), optionally, at least one additive, and optionally, at least one filler and optionally, at least one additional polymer (D) are brought into contact first, without intimate mixing; and the components are subsequently melt blended in a mixer or extruder or any other type mixing equipment known to a person skilled in the art.

In another embodiment, the polyolefin compositions may be formed by melt blending the recycled polyolefin (A), random alpha-olefinic copolymer (B), and optionally, at least one tackifier (C), optionally, at least one additive, optionally, at least one filler and optionally, at least one additional polymer (D) as powders, flakes, pellets or combinations thereof together directly in a mixer, single or twin-screw extruder or other equipment known to a person skilled in the art; or alternatively, the compositions may be formed by (dry-) blending powders, flakes, pellets or combinations thereof of the recycled polyolefin (A), random alpha-olefinic copolymer (B), and optionally, at least one tackifier (C), optionally, at least one additive, optionally, at least one filler and optionally, at least one additional polymer (D), at the main hopper or side feeder of a profile or film extruder, or injection molding machine or any other type of polymer processing equipment known to a person skilled in the art and subsequently melt blending in the aforementioned processing equipment. The processing equipment may be the final stage of blending as part of an article fabrication step, such as in the extruder used to melt and convey the composition prior to forming a sheet or pellets.

As used herein, the term “melt blending” involves the use of shear force, extensional force, compressive force, ultrasonic energy, electromagnetic energy, thermal energy or combinations comprising at least one of the foregoing forces or forms of energy and is conducted in a processing equipment wherein the aforementioned forces are exerted by a single screw, multiple screws, intermeshing co-rotating or counter-rotating screws, non-intermeshing corotating or counter-rotating screws, reciprocating screws, screws with pins, barrels with pins, rolls, rams, helical rotors, or combinations comprising at least one of the foregoing. Melt blending may be conducted in machines such as, single or multiple screw extruders, Buss kneader, Eirich mixers, Farrel Continuous Mixer, Haake mixer, a Brabender internal mixer, helicones, Ross mixer, Banbury mixer, roll mills, molding machines such as injection molding machines, vacuum forming machines, blow molding machines, or the like, or combinations comprising at least one of the foregoing machines. It is generally desirable during melt of the composition to impart a specific energy of about 0.01 to about 10 kilowatt-hours/kilogram (kW h/kg) to the composition. In another embodiment, melt blending is performed in a twin-screw extruder, such as a Brabender co-rotating twin screw extruder, where the screw temperature zones are set from about 110° C. to about 200° C. for a polyethylene-rich recycled polyethylene and from about 140 to about 220° C. for a polypropylene-rich recycled polyolefin.

In at least one embodiment, the random alpha-olefinic copolymer (B), or the tackifier (C), or a combination of both are added involving a “master batch” approach, where the final random alpha-olefinic copolymer and/or tackifier concentration is achieved by combining a recycled polyolefin with an appropriate amount of random alpha-olefinic copolymer and/or tackifier that has been previously prepared at a higher additive concentration in a “carrier polymer” (master batch).

Such “carrier polymers” for the masterbatch can be ethylene polymers and/or propylene polymers which include, but are not limited to, LDPE, LLDPE, HDPE, aPP, iPP, sPP, hPP, RCP and/or combinations thereof. The carrier polymers may be virgin or recycled polyolefins. The carrier polymer may be identical or may be different from the recycled polyolefin (A) or the majority component in the recycled polyolefin (A).

As used herein, the term “identical” implies equality regarding at least the origin (such as consumer waste), the chemical backbone (such as polyethylene), the morphology (such as LLDPE), the physical properties (such as density) and the rheology properties (such as MFR). For example, two polymers that both originate from post-consumer waste, both are a polypropylene rich recycled polyolefin, both contain mainly HDPE, both have a density above 0.950 g/cm² and an MFR of 3 g/10 min are considered identical.

As used herein, the term “different” can include, but is not limited to, differences in origin (such as consumer waste), chemical backbone (such as polyethylene), morphology (such as LLDPE), physical properties (such as density), and rheology properties (such as MFR). For example, the use of polypropylene as carrier polymer for a composition containing a polyethylene-rich recycled polyolefin as recycled polyolefin (A) or the use of a polyethylene with an MFR of 7.5 g/10 min (ISO 1133, 190° C., 2.16 kg) as carrier polymer for a composition containing a polyethylene-rich recycled polyolefin with an MFR of 2.0 g/10 min ((ISO 1133, 190° C., 2.16 kg) as recycled polyolefin (A) are both considered different from the recycled polyolefin (A).

In at least one embodiment, the random alpha-olefinic copolymer (B), optionally, the at least one tackifier (C), and at least one additional polymer (D), or a combination of (B), (D) and/or/optionally (C) are added involving a “master batch” approach, where the final concentration of random alpha-olefinic copolymer and/or tackifier and/or additional polymer is achieved by combining a recycled polyolefin with an appropriate amount of random alpha-olefinic copolymer and/or tackifier and/or additional polymer that has been previously prepared at a higher additive concentration in a “carrier polymer” (master batch). In at least one aspect of the above embodiment, the carrier polymer is at least one selected from the group consisting of: the recycled polyolefin (A), the random alpha-olefinic copolymer (B), and the at least one additional polymer (D).

In at least one embodiment, the percentage of the random alpha-olefinic copolymer (B), optionally, the tackifier (C), optionally, the additional polymer (D), or any combination of (B+C+D) is from about 5 to about 70 wt %, based upon the weight of the masterbatch composition. In other embodiments, the percentage of the random alpha-olefinic copolymer (B), optionally, the tackifier (C), optionally, the additional polymer (D), or any combination of (B+C+D) ranges from about 20 to about 60 wt % or about 40 to about 50 wt % based upon the weight of the masterbatch composition. The masterbatch composition may include additional additives, fillers or polymers.

In at least one embodiment, the percentage of the random alpha-olefinic copolymer (B) and the at least one additional polymer (D), or a combination of both (B+D) is from about 5 to about 70 wt %, based upon the weight of the masterbatch composition. In other embodiments, the percentage of the random alpha-olefinic copolymer (B) and the at least one additional polymer (D), or a combination of both (B+D) ranges from as about 20 to about 60 wt % or about 40 to about 50 wt %. The masterbatch composition may include additional additives, fillers or polymers.

The masterbatch compositions may be formed by any method known in the art. In one embodiment, the masterbatch compositions are formed by first dry blending powders, flakes, pellets or combinations thereof using, for example, a tumble blender, where carrier polymer and at least one random alpha-olefinic copolymer and/or tackifier (and optional additive, fillers or additional polymers) are brought into contact first, without out intimate mixing the carrier polymers and the random alpha-olefinic copolymer and/or tackifier and subsequently melt blending in a mixer or any other type mixing equipment known to a person skilled in the art.

In another embodiment, the masterbatch composition is formed by melt blending the carrier polymer and at least one random alpha-olefinic copolymer and/or tackifier (and optional additive, fillers or additional polymers) as powders, flakes, pellets or combinations thereof together directly in a mixer, single or twin-screw extruder or other equipment known to a person skilled in the art; or by (dry-) blending powders, flakes, pellets or combinations thereof of the carrier polymers and at least one random alpha-olefinic copolymer and/or tackifier (and optional additive, fillers or additional polymers) at the main hopper or side feeder of a profile or film extruder or any other type of polymer processing equipment known to a person skilled in the art and subsequently melt blending in the aforementioned processing equipment.

The carrier polymer for use in the masterbatch can have a MFR ranging from about 0.5 to about 25, about 4 to about 25, about 5 to about 25, about 6 to about 25, about 7 to about 25, about 8 to about 25, about 9 to about 25, about 10 to about 25, about 11 to about 25, about 12 to about 25, about 13 to about 25, about 14 to about 25, and about 15 to about 25 g/10 min (ISO1133, 190° C., 2.16 kg).

The carrier polymer for use in the masterbatch can have a MFR ranging from about 0.5 to about 25, about 4 to about 25, about 5 to about 25, about 6 to about 25, about 7 to about 25, about 8 to about 25, about 9 to about 25, about 10 to about 25, about 11 to about 25, about 12 to about 25, about 13 to about 25, about 14 to about 25, and about 15 to about 25 g/10 min (ISO1133, 230° C., 2.16 kg).

In another embodiment, the masterbatch composition is formed by melt blending the carrier polymer and the random alpha-olefinic copolymer (B) and/or the tackifier (C) in a twin-screw extruder, such as a Brabender co-rotating twin screw extruder, where the screw temperature zones are set from about 85° C. to about 160° C. for masterbatch composition using a virgin LDPE with an MFR of about 2 to about 7.5 g/10 min (ISO1133, 190° C., 2.16 kg) and from about 120 to about 185° C. for masterbatch composition using a virgin iPP with an MFR of about 2 to about 25 g/10 min (ISO 1133, 230° C., 2.16 kg). The masterbatch compositions can be in the form of pellets, granules, powder or flakes and may also be additionally coated or dusted to improve processing. Such coatings or dusting agents include, but are not limited to, polyethylene waxes, polypropylene waxes, talcum or silica.

In at least one embodiment, the polyolefin compositions produced are in the form of pellets, granules, powder or flakes, suitable for further processing into articles containing such compositions.

Additionally, other polymers, additives or fillers may be included in the polyolefin composition, in one or more components of the composition, and/or in a product formed from the composition, such as a film, as desired.

Such other polymers, which can be included in the compositions, can include, but are not limited to, ethylene vinyl acetate, ethylene methyl acrylate, ethylene ethyl acrylate, ethylene n-butyl acrylate, terpolymers of ethylene, ethyl acrylate and maleic anhydride, copolymers of acrylic acid, polymethylmethacrylate or any other polymers polymerizable by a high-pressure free radical process, LLDPE, LDPE, MDPE, HDPE, ethylene 1-hexene copolymer, co- and ter-polymers of ethylene and alpha-olefins, co- and ter-polymers of propylene and alpha-olefins, plastomers, metallocene-catalyzed polyolefins, maleic modified polyolefins, maleic modified polypropylene and polyethylene based polymers, polyvinylchloride, polybutene-1, isotactic polybutene, acrylonitrile butadiene styrene (ABS) resins, MBS (methacrylate butadiene styrene) resins, ethylene propylene rubber (EPR), vulcanized EPR, EPDM (ethylene propylene diene monomer rubber), block copolymer, styrenic block copolymers, maleic modified styrenic block copolymers, polyamides, polycarbonates, PET resins, cross linked polyethylene, copolymers of ethylene and vinyl alcohol (EVOH), polymers of aromatic monomers such as polystyrene, polyesters, polyacetal, polyvinylidine fluoride, polyethylene glycols, polyisobutylene, and/or combinations thereof.

In at least one embodiment, at least one the “other polymer” can be used as a carrier polymer.

In at least one embodiment of this invention, a polyolefin composition is provided comprising at least one “other polymer” as an “additional polymer.” The term “other polymer” and “additional polymer” are used interchangeably.

Some of these “other” or “additional” polymers were surprisingly found to improve the impact performance of the inventive polyolefin compositions. At least one rheological, physical and mechanical property such as MFR, elongation, tensile strength, flexural strength, flexural modulus, and tensile Young's modulus (E-modulus) was unexpectedly improved by the addition of the other polymers and/or an advantageous balance of physical and rheological properties was provided. The “other” or “additional” polymer(s) can be used as a carrier in a masterbatch process, an additive in a masterbatch, dry blended into the composition, or incorporated into the polyolefin composition by any process known to one skilled in the art. The at least one “other” or “additional” polymer included in the polyolefin compositions may be about 1% to about 60% of the polyolefin composition, about 2% to about 60%, about 3% to about 60%, about 4% to about 60%, about 5% to about 60%, about 6% to about 60%, about 7% to about 60%, about 8% to about 60%, about 9% to about 60%, about 10% to about 60%, about 11% to about 60%, about 12% to about 60%, about 13% to about 60%, about 14% to about 60%, about 15% to about 60%, about 16% to about 60%, about 17% to about 60%, about 18% to about 60%, about 19% to about 60%, about 20% to about 60%, about 25% to about 60%, about 30% to about 60%, about 35% to about 60%, about 40% to about 60%, about 45% to about 60%, about 3 wt % to about 35 wt %, about 3 wt % to about 30 wt %, about 3 wt % to about 25 wt %, about 3 wt % to about 20 wt %, about 3 wt % to about 15 wt %, about 3 wt % to about 10 wt %, about 10 wt % to about 35 wt %, about 10 wt % to about 30 wt %, about 10 wt % to about 25 wt %, about 10 wt % to about 20 wt %, about 20 wt % to about 35 wt %, about 20 wt % to about 30 wt %, about 20 wt % to about 25 wt %, and about 30 wt % to about 35 wt % of the polyolefin composition.

In at least one embodiment of this invention, the at least one “other” or “additional” polymer included in the polyolefin compositions may be about 1 wt % to about 45 wt % of the polyolefin composition, about 2 wt % to about 45 wt %, about 3 wt % to about 45 wt %, about 4 wt % to about 45 wt %, about 5 wt % to about 45 wt %, about 6 wt % to about 45 wt %, about 7 wt % to about 45 wt %, about 8 wt % to about 45 wt %, about 9 wt % to about 45 wt %, about 10 wt % to about 45 wt %, about 11 wt % to about 45 wt %, about 12 wt % to about 45 wt %, about 13 wt % to about 45 wt %, about 14 wt % to about 45 wt %, about 15 wt % to about 45 wt %, about 16 wt % to about 45 wt %, about 17 wt % to about 45 wt %, about 18 wt % to about 45 wt %, about 19 wt % to about 45 wt %, about 20 wt % to about 45 wt %, about 25 wt % to about 45 wt %, about 30 wt % to about 45 wt %, about 35 wt % to about 45 wt %, about 40 wt % to about 45 wt % of the polyolefin composition. In at least one embodiment of this invention, the at least one “other” or “additional” polymer included in the polyolefin compositions may be about 1 wt % to about 25 wt % of the polyolefin composition, about 2 wt % to about 25 wt %, about 3 wt % to about 25 wt %, about 4 wt % to about 25 wt %, about 5 wt % to about 25 wt %, about 6 wt % to about 25 wt %, about 7 wt % to about 25 wt %, about 8 wt % to about 25 wt %, about 9 wt % to about 25 wt %, about 10 wt % to about 25 wt %, about 11 wt % to about 25 wt %, about 12 wt % to about 25 wt %, about 13 wt % to about 25 wt %, about 14 wt % to about 25 wt %, about 15 wt % to about 25 wt %, about 16 wt % to about 25 wt %, about 17 wt % to about 25 wt %, about 18 wt % to about 25 wt %, about 19 wt % to about 25 wt %, about 20 wt % to about 25 wt % of the polyolefin composition.

In one embodiment, at least one “other” or “additional” polymer that modifies the impact property and/or other physical and/or rheological property of the polyolefin composition may be prepared as a masterbatch comprising: (A) about 20 to about 70 wt % of at least one random alpha-olefinic copolymer; (B) about 40 to about 80 wt % of at least one “other” or “additional” polymer. Suitable “other” or “additional” polymers include, but are not limited to, for example: an ethylene-acrylate copolymer, ethylene ethyl acrylate copolymer, ethylene methyl acrylate copolymer, ethylene butyl acrylate copolymer, terpolymers of ethylene, ethyl acrylate and maleic anhydride (available as LOTADER™ 4700 from SK Functional Polymers, Paris France), MDPE (available as Eltex™ HD3930UA, INEOS, IL, USA), HDPE, LLDPE, LDPE, virgin PP homopolymer, PP copolymer, ethylene-hexene, ethylene-octene, and ethylene-butene copolymers (available as INNATE™, ENGAGE™, AFFINITY™ and AFFINITY™ GA from Dow Chemical, Midland, Mich., USA), ethylene block copolymers and propylene block copolymers (available as INFUSE™ and INTUNE™, Dow). Depending on the application and the desired final properties, the usage levels of the masterbatch can be varied between about 2 wt % and about 50 wt % of the polyolefin composition. In at least one aspect of this embodiment, the usage levels of the masterbatch can range from about 2 wt % to about 50 wt %, about 3 wt % to about 50 wt %, about 4 wt % to about 50 wt %, about 5 wt % to about 50 wt %, about 6 wt % to about 50 wt %, about 7 wt % to about 50 wt %, about 8 wt % to about 50 wt %, about 9 wt % to about 50 wt %, about 10 wt % to about 50 wt %, about 11 wt % to about 50 wt %, about 12 wt % to about 50 wt %, about 13 wt % to about 50 wt %, about 14 wt % to about 50 wt %, about 15 wt % to about 50 wt %, about 16 wt % to about 50 wt %, about 17 wt % to about 50 wt %, about 18 wt % to about 50 wt %, about 19 wt % to about 50 wt %, about 20 wt % to about 50 wt %, about 25 wt % to about 50 wt %, about 30 wt % to about 50 wt %, about 35 wt % to about 50 wt %, and about 40 wt % to about 50 wt % of the polyolefin composition. In other embodiments of the invention, at least one “other” or “additional” polymer that modifies the impact property and/or other physical and/or rheological property of the polyolefin composition may be prepared as a masterbatch comprising: (A) about 20 to about 60 wt % of at least one random alpha-olefinic copolymer; (B) about 40 to about 65 wt % of at least one “other” or “additional” polymer. In at least one aspect of the above embodiment, at least one “other” or “additional” polymer that modifies the impact property and/or other physical and/or rheological property of the polyolefin composition may be prepared as a masterbatch comprising: (A) about 40 to about 60 wt % of at least one random alpha-olefinic copolymer; (B) about 40 to about 65 wt % of at least one “other” or “additional” polymer. In other embodiments, at least one “other” or “additional” polymer that modifies the impact property and/or other physical and/or rheological property of the polyolefin composition may be prepared as a masterbatch comprising: (A) about 20 to about 60 wt % of at least one random alpha-olefinic copolymer; (B) about 40 to about 80 wt % of at least one “other” or “additional” polymer

In at least one embodiment, a polyolefin composition comprising: (A) about 60 to about 96 wt % of at least one recycled polyolefin; B) about 2 to about 20 wt % of at least one random alpha-olefinic copolymer; C) at least one tackifier and (D) about 2 to about 20 wt % of at least one additional polymer selected from the group consisting of ethylene vinyl acetate, ethylene methyl acrylate, ethylene ethyl acrylate, ethylene n-butyl acrylate, and terpolymers of ethylene, ethyl acrylate and maleic anhydride, is provided; wherein the polyolefin composition has a weight ratio of random alpha-olefinic copolymer to tackifier of between about 0.2 to about 5.0; and wherein the polyolefin composition has a melt flow rate increase of about 3 to about 400% compared to the same polyolefin composition without the random alpha-olefinic copolymer and the tackifier; and wherein the polyolefin composition maintains acceptable mechanical properties. In at least one embodiment, a polyolefin composition is provided comprising: (A) about 60 to about 96 wt % of at least one recycled polyolefin; B) about 2 to about 20 wt % of at least one random alpha-olefinic copolymer; C) at least one tackifier and (D) about 2 to about 20 wt % of at least one additional polymer; wherein the polyolefin composition has a weight ratio of random alpha-olefinic copolymer to tackifier of between about 0.2 to about 5.0; and wherein the polyolefin composition has a melt flow rate increase of about 3 to about 400% compared to the same polyolefin composition without the random alpha-olefinic copolymer, the additional polymer, and the tackifier; and wherein the polyolefin composition maintains acceptable mechanical properties.

In at least one embodiment, a polyolefin composition comprising: (A) about 60 to about 96 wt % of at least one recycled polyolefin; (B) about 2 to about 20 wt % of at least one random alpha-olefinic copolymer; (C) optionally, at least one tackifier, and (D) about 2 to about 20 wt % of at least one additional polymer selected from the group consisting of ethylene vinyl acetate, ethylene methyl acrylate, ethylene ethyl acrylate, ethylene n-butyl acrylate, and terpolymers of ethylene, ethyl acrylate and maleic anhydride, is provided; wherein the polyolefin composition has a weight ratio of random alpha-olefinic copolymer to tackifier of between about 0.2 to about 5.0; and wherein the polyolefin composition has a melt flow rate increase of about 3% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties. In at least one embodiment, a polyolefin composition is provided comprising: (A) about 60 to about 96 wt % of at least one recycled polyolefin; (B) about 2 to about 20 wt % of at least one random alpha-olefinic copolymer; (C) optionally, at least one tackifier, and (D) about 2 to about 20 wt % of at least one additional polymer; wherein the polyolefin composition has a weight ratio of random alpha-olefinic copolymer to tackifier of between about 0.2 to about 5.0; and wherein the polyolefin composition has a melt flow rate increase of about 3% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties. In some aspects of this embodiment, the polyolefin composition also has an increase in the elongation at break of as much as about 250% or up to about 300% or up to about 350% or up to about 400% compared to the same polyolefin composition without the random alpha-olefinic copolymer, the additional polymer, and optionally, the tackifier.

In at least one embodiment a polyolefin composition comprising recycled polyolefin (A), at least one random alpha-olefinic copolymer (B), optionally, at least one tackifier resin (C) and at least one additional polymer (D), where at least one additional polymer is selected from the group consisting of ethylene vinyl acetate, ethylene methyl acrylate, ethylene ethyl acrylate, ethylene n-butyl acrylate, and terpolymers of ethylene, ethyl acrylate and maleic anhydride; wherein the percentage of B+C+D is from about 5 to about 70 wt % based upon the weight of the total polyolefin composition. In other embodiments, the percentage of B+C+D ranges from about 10 to about 30 wt % or from about 5 to about 20 wt % or from about 5 to about 35 wt % or from about 10 to about 35 wt % or from about 20 to about 45 wt % based upon the weight of the total polyolefin composition In other embodiments of the invention, the weight ratio of B+C to D is between about 0.2 to about 20, between about 0.2 and about 5.0, about 0.5 and about 2.0. In other embodiments, the weight ratio of B to C is between 0.2 and 5.0. The polyolefin composition can have a MFR increase of about 3% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties. In some aspects of this embodiment, the polyolefin composition also has an increase in the elongation at break of as much as about 250% or up to about 300% or up to about 350% or up to about 400% compared to the same polyolefin composition without the random alpha-olefinic copolymer, the additional polymer, and optionally, the tackifier.

In embodiments of the invention, the polyolefin compositions can have the percentage of B+C+D from about 5 to about 70 wt % or from about 10 to about 30 wt % or from about 5 to about 20 wt % from about 5 to about 35 wt % or from about 10 to about 35 wt % or from about 20 to about 45 wt % based upon the weight of the total polyolefin composition. In other embodiments of the invention, the polyolefin compositions can have the percentage of B+C+D from about 5 wt % to about 70 wt %, about 5 wt % to about 60 wt %, about 5 wt % to about 50 wt %, about 5 wt % to about 40 wt %, about 5 wt % to about 30 wt %, about 5 wt % to about 25 wt %, about 5 wt % to about 20 wt %, about 5 wt % to about 15 wt %, about 5 wt % to about 10 wt %, about 10 wt % to about 70 wt %, about 10 wt % to about 60 wt %, about 10 wt % to about 50 wt %, about 10 wt % to about 40 wt %, about 10 wt % to about 35 wt %, about 10 wt % to about 30 wt %, about 10 wt % to about 25 wt %, about 10 wt % to about 20 wt %, about 20 wt % to about 70 wt %, about 20 wt % to about 60 wt %, about 20 wt % to about 50 wt %, about 20 wt % to about 40 wt %, about 20 wt % to about 35 wt %, about 20 wt % to about about 30 wt %, about 20 wt % to about 25 wt %, about 30 wt % to about 70 wt %, about 30 wt % to about 60 wt %, about 30 wt % to about 50 wt %, about 30 wt % to about 40 wt %, about 30 wt % to about 35 wt %, about 15 wt % to about 70 wt %, about 15 wt % to about 60 wt %, about 15 wt % to about 50 wt %, about 15 wt % to about 40 wt %, about 15 wt % to about 35 wt %, about 15 wt % to about 30 wt %, about 15 wt % to about 25 wt %, about 15 wt % to about 20 wt %, about 25 wt % to about 70 wt %, about 25 wt % to about 60 wt %, about 25 wt % to about 50 wt %, about 25 wt % to about 40 wt %, about 25 wt % to about 35 wt %, about 25 wt % to about 30 wt %, about 35 wt % to about 70 wt %, about 35 wt % to about 60 wt %, about 35 wt % to about 50 wt %, about 35 wt % to about 40 wt %, about 35 wt % to about 35 wt %, based upon the weight of the total polyolefin composition.

In at least one embodiment a polyolefin composition comprising recycled polyolefin (A), at least one random alpha-olefinic copolymer (B), at least one tackifier resin (C) and at least one additional polymer (D), where at least one additional polymer is selected from the group consisting of linear low density polyethylene, low density polyethylene, medium density polyethylene, ethylene-hexene copolymer, ethylene-butene copolymer, and ethylene-octene copolymer; wherein the percentage of B+C+D is from about 5 to about 70 wt % based upon the weight of the total polyolefin composition. In other embodiments, the percentage of B+C+D ranges from about 20 to 45 wt %, and about 10 to 20 wt %. In other embodiment of the invention, the weight ratio of B+C to D is between about 0.2 to about 20, between about 0.2 and about 5.0, about 0.5 and about 2.0. In other embodiments, the weight ratio of B to C is between 0.2 and 5.0. The polyolefin composition can have a MFR increase of about 3% to 400% compared to the same polyolefin composition without at least one random alpha-olefinic copolymer, tackifier resin(s) and additional polymer(s). In at least one aspect of the above embodiment, the polyolefin composition has an MFR increase of about 3% to about 400% and has an increase in the elongation at break of about 30% to about 150% compared to the same polyolefin composition without the at least one random alpha-olefinic copolymer, tackifier resin(s) and additional polymer(s); and wherein the polyolefin composition maintains acceptable mechanical properties.

In at least one embodiment a polyolefin composition comprising recycled polyolefin (A), at least one random alpha-olefinic copolymer (B), optionally, at least one tackifier resin (C) and at least one additional polymer (D), where at least one additional polymer is selected from the group consisting of linear low density polyethylene, low density polyethylene, medium density polyethylene, ethylene-hexene copolymer, ethylene-butene copolymer, and ethylene-octene copolymer; wherein the percentage of B+C+D is from about 5 to about 70 wt % based upon the weight of the total polyolefin composition. In other embodiments, the percentage of B+C+D ranges from about 10 to about 30 wt % or from about 5 to about 20 wt % or from about 5 to about 35 wt % or from about 10 to about 35 wt % or from about 20 to about 45 wt % based upon the weight of the total polyolefin composition In other embodiments of the invention, the weight ratio of B+C to D is between about 0.2 to about 20, between about 0.2 and about 5.0, about 0.5 and about 2.0. In other embodiments, the weight ratio of B to C is between 0.2 and 5.0. The polyolefin composition can have a MFR increase of about 3% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties. In some aspects of this embodiment, the polyolefin composition also has an increase in the elongation at break of as much as about 250% or up to about 300% or up to about 350% or up to about 400% compared to the same polyolefin composition without the random alpha-olefinic copolymer, the additional polymer, and optionally, the tackifier.

In at least one embodiment a polyolefin composition comprising recycled polyolefin (A), at least one random alpha-olefinic copolymer (B), at least one tackifier resin (C) and at least one additional polymer (D), where at least one additional polymer is selected from the group consisting of linear low density polyethylene, low density polyethylene, medium density polyethylene, ethylene-hexene copolymer, ethylene-butene copolymer, and ethylene-octene copolymer; wherein the percentage of B+C+D ranges from about 5 to about 70 wt %, about 20 to about 45 wt %, or about 10 to about 20 wt % based upon the weight of the total polyolefin composition; wherein the weight ratio of B+C to D is between about 0.1 to about 20, between about 0.1 to about 5.0, or about 0.1 to about 2.0, or about 0.3 to about 3.0, or about 0.2 to about 2.0; wherein the polyolefin composition has a MFR increase of about 3% to 400% compared to the same polyolefin composition without at least one random alpha-olefinic copolymer, tackifier resin(s) and additional polymer(s); and wherein the polyolefin composition has an increase in the elongation at break of about 30% to about 150% compared to the same polyolefin composition without the at least one random alpha-olefinic copolymer, tackifier resin(s) and additional polymer(s); and wherein the polyolefin composition maintains acceptable mechanical properties. Acceptable mechanical properties were defined in this specification.

In at least one embodiment a polyolefin composition comprising recycled polyolefin (A), at least one random alpha-olefinic copolymer (B), optionally, at least one tackifier resin (C), and at least one additional polymer (D), where at least one additional polymer is selected from the group consisting of linear low density polyethylene, low density polyethylene, medium density polyethylene, ethylene-hexene copolymer, ethylene-butene copolymer, and ethylene-octene copolymer; wherein the percentage of B+C+D ranges from about 5 to about 70 wt % or from about 10 to about 30 wt % or from about 5 to about 20 wt % or from about 5 to about 35 wt % or from about 10 to about 35 wt % or from about 20 to about 45 wt % based upon the weight of the total polyolefin composition; wherein the weight ratio of B+C to D is between about 0.1 to about 20, between about 0.1 to about 5.0, or about 0.1 to about 2.0, or about 0.3 to about 3.0, or about 0.2 to about 2.0; wherein the weight ratio of B to C is between 0.2 and 5.0; wherein the polyolefin composition has a MFR increase of about 3% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties. In some aspects of this embodiment, the polyolefin composition also has an increase in the elongation at break of as much as about 250% or up to about 300% or up to about 350% or up to about 400% compared to the same polyolefin composition without the random alpha-olefinic copolymer, the additional polymer, and optionally, the tackifier.

In at least one embodiment, a polyolefin composition comprising polyethylene-rich recycled polyolefin (A), at least one random alpha-olefinic copolymer (B), at least one tackifier resin (C) and at least one additional polymer (D). The additional polymer can be, but is not limited to, a linear low density polyethylene, a low density polyethylene, a medium density polyethylene, an ethylene-hexene copolymer, an ethylene-butene copolymer, or an ethylene-octene copolymer. The polyolefin composition can be prepared where the percentage of B+C+D is from about 5 to about 70 wt % or about 20 to about 45 wt % based upon the weight of the total polyolefin composition. The weight ratio of B to C in the polyolefin composition can be between 0.2 and 5.0. Also, in certain embodiments, the polyolefin composition has an MFR increase of about 100% to 250% and has an increase in the elongation at break of about 100% to about 400% compared to the same polyolefin composition without at least one random alpha-olefinic copolymer, tackifier resin(s) and additional polymer(s); and the polyolefin maintains acceptable mechanical properties.

In at least one embodiment, a polyolefin composition comprising polyethylene-rich recycled polyolefin (A), at least one random alpha-olefinic copolymer (B), optionally, at least one tackifier resin (C) and at least one additional polymer (D). The additional polymer can be, but is not limited to, a linear low density polyethylene, a low density polyethylene, a medium density polyethylene, an ethylene-hexene copolymer, an ethylene-butene copolymer, or an ethylene-octene copolymer. The polyolefin composition can be prepared where the percentage of B+C+D is from about 5 to about 70 wt % or from about 10 to about 30 wt % or from about 5 to about 20 wt % or from about 5 to about 35 wt % or from about 10 to about 35 wt % or from about 20 to about 45 wt % based upon the weight of the total polyolefin composition. The weight ratio of B to C in the polyolefin composition can be between 0.2 and 5.0. Also, in certain embodiments, the polyolefin composition has an MFR increase of about 3% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties. In some aspects of this embodiment, the polyolefin composition also has an increase in the elongation at break of as much as about 250% or up to about 300% or up to about 350% or up to about 400%.

In at least one embodiment, a polyolefin composition comprising polyethylene-rich recycled polyolefin (A), at least one random alpha-olefinic copolymer (B), at least one tackifier resin (C) and at least one additional polymer (D); wherein the additional polymer is selected from a linear low density polyethylene, a low density polyethylene, a medium density polyethylene, an ethylene-hexene copolymer, an ethylene-butene copolymer, or an ethylene-octene copolymer; wherein the percentage of B+C+D is from about 5 to about 70 wt % or about 20 to about 45 wt % based upon the weight of the total polyolefin composition; wherein the weight ratio of B to C in the polyolefin composition is from about 0.2 and 5.0; wherein the polyolefin composition has an MFR increase of about 100% to 250% and has an increase in the elongation at break of about 100% to about 600% compared to the same polyolefin composition without at least one random alpha-olefinic copolymer, tackifier resin(s) and additional polymer(s); and wherein the polyolefin maintains acceptable mechanical properties.

In at least one embodiment, a polyolefin composition comprising polyethylene-rich recycled polyolefin (A), at least one random alpha-olefinic copolymer (B), optionally, at least one tackifier resin (C) and at least one additional polymer (D); wherein the additional polymer is selected from a linear low density polyethylene, a low density polyethylene, a medium density polyethylene, an ethylene-hexene copolymer, an ethylene-butene copolymer, or an ethylene-octene copolymer; wherein the percentage of B+C+D is from about 5 to about 70 wt % or from about 10 to about 30 wt % or from about 5 to about 20 wt % or from about 5 to about 35 wt % or from about 10 to about 35 wt % or from about 20 to about 45 wt % based upon the weight of the total polyolefin composition; wherein the weight ratio of B to C in the polyolefin composition is from about 0.2 and 5.0; wherein the polyolefin composition has an MFR increase of about 38% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties. In some aspects of this embodiment, the polyolefin composition also has an increase in the elongation at break of as much as about 250% or up to about 300% or up to about 350% or up to about 400% compared to the same polyolefin composition without the random alpha-olefinic copolymer, the additional polymer, and optionally, the tackifier.

In at least one embodiment of the invention, a polyolefin composition is provided comprising polypropylene-rich recycled polyolefin (A), at least one random alpha-olefinic copolymer (B), at least one tackifier resin (C) and at least one additional polymer (D); wherein the percentage of B+C+D can range from about 5 to about 70 wt % or about 20 to about 45 wt % based upon the weight of the total polyolefin composition. The weight ratio of B to C can be between 0.2 and 5.0. The polyolefin composition can have an MFR increase of about 3% to about 60% compared to the same polyolefin composition without at least one random alpha-olefinic copolymer, tackifier resin(s) and additional polymer(s) and maintains acceptable mechanical properties. In some aspects of this embodiment, the polyolefin composition also has an increase in the elongation at break of about 30% to about 150%. In other aspects of this embodiment, the polyolefin composition also has an increase in the flexural strength of about 40% and maintains acceptable mechanical properties.

In at least one embodiment of the invention, a polyolefin composition is provided comprising polypropylene-rich recycled polyolefin (A), at least one random alpha-olefinic copolymer (B), optionally, at least one tackifier resin (C) and at least one additional polymer (D); wherein the percentage of B+C+D can range from about 5 to about 70 wt % or from about 10 to about 30 wt % or from about 5 to about 20 wt % or from about 5 to about 35 wt % or from about 10 to about 35 wt % or from about 20 to about 45 wt % based upon the weight of the total polyolefin composition. The weight ratio of B to C can be between 0.2 and 5.0. The polyolefin composition can have an MFR increase of has an MFR increase of about 3% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties. In some aspects of this embodiment, the polyolefin composition also has an increase in the elongation at break of as much as about 250% or up to about 300% or up to about 350% or up to about 400% compared to the same polyolefin composition without the random alpha-olefinic copolymer, the additional polymer, and optionally, the tackifier.

In at least one embodiment of the invention, a polyolefin composition is provided comprising polypropylene-rich recycled polyolefin (A), at least one random alpha-olefinic copolymer (B), at least one tackifier resin (C) and at least one additional polymer (D); wherein the percentage of B+C+D is from about 5 to about 70 wt % or from about 20 to about 45 wt % based upon the weight of the total polyolefin composition; wherein the weight ratio of B to C is between 0.2 and 5.0; wherein the polyolefin composition has an MFR increase of about 3% to about 60%, the polyolefin composition also has an increase in the flexural strength of about 40% and maintains acceptable mechanical properties compared to the same polyolefin composition without at least one random alpha-olefinic copolymer, tackifier resin(s) and additional polymer(s). In some aspects of this embodiment, the polyolefin composition also has an increase in the elongation at break of about 30% to about 150%.

In at least one embodiment of the invention, a polyolefin composition is provided comprising polypropylene-rich recycled polyolefin (A), at least one random alpha-olefinic copolymer (B), optionally, at least one tackifier resin (C), and at least one additional polymer (D); wherein the percentage of B+C+D is from about 5 to about 70 wt % or from about 10 to about 30 wt % or from about 5 to about 20 wt % or from about 5 to about 35 wt % or from about 10 to about 35 wt % or from about 20 to about 45 wt % based upon the weight of the total polyolefin composition; wherein the weight ratio of B to C is between 0.2 and 5.0; wherein the polyolefin composition has an MFR increase of about 3% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties. In some aspects of this embodiment, the polyolefin composition also has an increase in the elongation at break of as much as about 250% or up to about 300% or up to about 350% or up to about 400% compared to the same polyolefin composition without the random alpha-olefinic copolymer, the additional polymer, and optionally, the tackifier.

In at least one embodiment of the invention, a polyolefin composition is provided comprising a recycled polyolefin (A),), a random alpha-olefinic copolymer (B) with a glass transition temperature equal or below −10° C. (ASTM D 3418-15) and a nominal molecular weight equal or below 25,000 g/mol (ISO 16014), a tackifier (C) with a glass transition temperature equal or above 45° C. (ASTM D 3418-15), (C) and an additional polymer (D), wherein the additional polymer can be, but is not limited to a linear low density polyethylene, a medium density polyethylene, an ethylene methylacrylate copolymer an ethylene-hexene copolymer, ethylene-butene copolymer, or an ethylene-octene copolymer, wherein the percentage of B+C+D is from about 5 to about 30 wt % or about 10 to about 20 wt % based upon the weight of the total polyolefin composition; wherein the weight ratio of B+C to D is between about 0.1 to about 20, between about 0.1 to about 5.0, or about 0.1 to about 2.0, or about 0.3 to about 3.0, or about 0.2 to about 2.0; wherein the weight ratio of B to C is between about 0.2 and 5.0; wherein the polyolefin composition has an MFR increase of about 3 to 400% compared to the same polyolefin composition without the random alpha-olefinic copolymer, the tackifier and additional polymer; and wherein the polyolefin composition maintains acceptable mechanical properties.

In at least one embodiment of the invention, a polyolefin composition is provided comprising a recycled polyolefin (A),), a random alpha-olefinic copolymer (B) with a glass transition temperature equal or below −10° C. (ASTM D 3418-15) and a nominal molecular weight equal or below 25,000 g/mol (ISO 16014), a tackifier (C) optionally, with a glass transition temperature equal or above 45° C. (ASTM D 3418-15), (C) and an additional polymer (D), wherein the additional polymer can be, but is not limited to a linear low density polyethylene, a medium density polyethylene, an ethylene methylacrylate copolymer an ethylene-hexene copolymer, ethylene-butene copolymer, or an ethylene-octene copolymer, wherein the percentage of B+C+D is from about 5 to about 70 wt % or from about 10 to about 30 wt % or from about 5 to about 20 wt % or from about 5 to about 35 wt % or from about 10 to about 35 wt % or from about 20 to about 45 wt % based upon the weight of the total polyolefin composition; wherein the weight ratio of B+C to D is between about 0.1 to about 20, between about 0.1 to about 5.0, or about 0.1 to about 2.0, or about 0.3 to about 3.0, or about 0.2 to about 2.0; wherein the weight ratio of B to C is between about 0.2 and 5.0; wherein the polyolefin composition has an MFR increase of about 3% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties.

In at least one embodiment of the invention, a polyolefin composition is provided comprising a recycled polyolefin (A), a random alpha-olefinic copolymer (B) with a glass transition temperature equal or below −10° C. (ASTM D 3418-15) and a nominal molecular weight equal or below 10,000 g/mol (ISO 16014), a tackifier (C) with a glass transition temperature equal or above 45° C. (ASTM D 3418-15), (C) and an additional polymer (D), wherein the additional polymer can be, but is not limited to a linear low density polyethylene, a medium density polyethylene, an ethylene methylacrylate copolymer, an ethylene-hexene copolymer, ethylene-butene copolymer, or an ethylene-octene copolymer, wherein the percentage of B+C+D is from about 5 to about 30 wt % or about 10 to about 20 wt % based upon the weight of the total polyolefin composition; wherein the weight ratio of B+C to D is between about 0.1 to about 20, between about 0.1 to about 5.0, or about 0.1 to about 2.0, or about 0.3 to about 3.0, or about 0.2 to about 2.0; wherein the weight ratio of B to C is between about 0.2 and 5.0; wherein the polyolefin composition has an MFR increase of about 5 to 400% compared to the same polyolefin composition without the random alpha-olefinic copolymer, the tackifier and additional polymer; and wherein the polyolefin composition maintains acceptable mechanical properties.

In at least one embodiment of the invention, a polyolefin composition is provided comprising a recycled polyolefin (A), a random alpha-olefinic copolymer (B) with a glass transition temperature equal or below −10° C. (ASTM D 3418-15) and a nominal molecular weight equal or below 10,000 g/mol (ISO 16014), optionally, a tackifier (C) with a glass transition temperature equal or above 45° C. (ASTM D 3418-15), (C) and an additional polymer (D), wherein the additional polymer can be, but is not limited to a linear low density polyethylene, a medium density polyethylene, an ethylene methylacrylate copolymer an ethylene-hexene copolymer, ethylene-butene copolymer, or an ethylene-octene copolymer, wherein the percentage of B+C+D is from about 5 to about 70 wt % or from about 10 to about 30 wt % or from about 5 to about 20 wt % or from about 5 to about 35 wt % or from about 10 to about 35 wt % or from about 20 to about 45 wt % based upon the weight of the total polyolefin composition; wherein the weight ratio of B+C to D is between about 0.1 to about 20, between about 0.1 to about 5.0, or about 0.1 to about 2.0, or about 0.3 to about 3.0, or about 0.2 to about 2.0; wherein the weight ratio of B to C is between about 0.2 and 5.0; wherein the polyolefin composition has an MFR increase of about 3% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties.

In at least one embodiment of the invention, a polyolefin composition is provided comprising a recycled polyolefin (A), a random alpha-olefinic copolymer (B), a tackifier (C) and an additional polymer (D), wherein the additional polymer can be, but is not limited to a linear low density polyethylene, a medium density polyethylene, an ethylene methylacrylate copolymer an ethylene-hexene copolymer, ethylene-butene copolymer, or an ethylene-octene copolymer, wherein the percentage of B+C+D is from about 5 to about 30 wt % or about 10 to about 20 wt % based upon the weight of the total polyolefin composition; wherein the weight ratio of B+C to D is between about 0.1 to about 20, between about 0.1 to about 5.0, or about 0.1 to about 2.0, or about 0.3 to about 3.0, or about 0.2 to about 2.0; wherein the weight ratio of B to C is between about 0.2 and 5.0; wherein the polyolefin composition has an MFR increase of about 3 to 400% compared to the same polyolefin composition without the random alpha-olefinic copolymer, the tackifier and additional polymer; and wherein the polyolefin composition maintains acceptable mechanical properties.

In at least one embodiment of the invention, a polyolefin composition is provided comprising a recycled polyolefin (A), a random alpha-olefinic copolymer (B), a tackifier (C) and an additional polymer (D), wherein the additional polymer can be, but is not limited to a linear low density polyethylene, a medium density polyethylene, an ethylene methylacrylate copolymer an ethylene-hexene copolymer, ethylene-butene copolymer, or an ethylene-octene copolymer, wherein the percentage of B+C+D is from about 5 to about 70 wt % or from about 10 to about 30 wt % or from about 5 to about 20 wt % or from about 5 to about 35 wt % or from about 10 to about 35 wt % or from about 20 to about 45 wt % based upon the weight of the total polyolefin composition; wherein the weight ratio of B+C to is between about 0.1 to about 20, between about 0.1 to about 5.0, or about 0.1 to about 2.0, or about 0.3 to about 3.0, or about 0.2 to about 2.0; wherein the weight ratio of B to C is between about 0.2 and 5.0; wherein the polyolefin composition has an MFR increase of about 3% to about 400% or of about 5% to about 200% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties. In some aspects, the polyolefin composition also has an increase in the elongation at break of as much as about 250% or up to about 300% or up to about 350% or up to about 400% compared to the same polyolefin composition without the random alpha-olefinic copolymer, the additional polymer, and optionally, the tackifier; and wherein the polyolefin composition maintains acceptable mechanical properties.

In a specific aspect of this embodiment, the additional polymer (D) is a maleic modified polyethylene or polypropylene, wherein the percentage of D is between about 1 and 5 wt % or about 1 and 3 wt %; wherein the weight ratio of B+C to D is between about 2 and 20 or about 5 and 10; wherein the polyolefin composition has an MFR increase of about 3% to about 100% and exhibits an improved compatibilization to impurities present in the recycled polyolefin (A); and wherein the polyolefin composition maintains acceptable mechanical properties.

In another specific aspect of this embodiment, the additional polymer (D) is linear low density polyethylene (LLDPE) and the recycled polyolefin is a polypropylene-rich recycled polyolefin, wherein the percentage of D is between about 5 and about 30 wt %, about 10 and about 20 wt %; wherein the weight ratio of B+C to D is between about 0.2 and about 2, or about 0.3 and about 1; wherein the polyolefin composition has an MFR increase of about 3% to about 100% and a notched impact strength increase of about 5% to about 200% compared to the same polyolefin composition without the random alpha-olefinic copolymer, tackifier and additional polymer and wherein the polyolefin composition maintains acceptable mechanical properties.

In yet another specific aspect of this embodiment, a polyolefin composition is prepared wherein the additional polymer is used as carrier polymer for a masterbatch where the percentage of B+C is between about 5 to about 70 wt %, or about 40 to about 60 wt % based upon the weight of the masterbatch. The percentage of masterbatch can range from about 5 to about 40 wt %, or about 10 to about 20 wt % of the total polyolefin composition; wherein the polyolefin composition has an MFR increase of about 5% to about 100% or of about 5% to about 200% or of about 5% to about 400% compared to the same polyolefin composition without the masterbatch and wherein the polyolefin composition maintains acceptable mechanical properties. In some aspects of this embodiment, the polyolefin composition also has an increase in the elongation at break of as much as about 250% or up to about 300% or up to about 350% or up to about 400% compared to the same polyolefin composition without the masterbatch.

In at least one embodiment, a polyolefin composition is provided comprising a recycled polyolefin (A), a random alpha-olefinic copolymer (B), a tackifier (C) and an additional polymer (D) is prepared where the alpha-olefinic copolymer (B) and the tackifier (C) are first prepared as a masterbatch using a carrier polymer. The carrier polymer may be virgin or recycled polyolefin and may be identical or may be different from the recycled polyolefin (A) or the majority component in the recycled polyolefin (A) or the additional polymer (D). The percentage of B+C is between about 5 to about 70 wt % or from about 40 to about 60 wt % based upon the weight of the masterbatch and the weight ratio of B to C is between 0.2 and 5.0. The percentage of masterbatch can range from about 5 to about 40% or from 10 to 20% of the total polyolefin composition. The ratio of the masterbatch to the additional polymer (D) can range from about 0.2 to about 20, or about 0.2 to about 5.0, or about 0.5 to about 2.0 and wherein the polyolefin composition has an MFR increase of about 3 to 400% compared to the same polyolefin composition without the random alpha-olefinic copolymer, the tackifier and additional polymer and wherein the polyolefin composition maintains acceptable mechanical properties.

In at least one embodiment, a polyolefin composition is provided comprising a recycled polyolefin (A), a random alpha-olefinic copolymer (B), a tackifier (C) and an additional polymer (D) is prepared where the alpha-olefinic copolymer (B) and the tackifier (C) are first prepared as a masterbatch using a carrier polymer. The carrier polymer may be virgin or recycled polyolefin and may be identical or may be different from the recycled polyolefin (A) or the majority component in the recycled polyolefin (A) or the additional polymer (D). The percentage of B+C is between about 5 to about 70 wt % or from about 40 to about 60 wt % based upon the weight of the masterbatch and the weight ratio of B to C is between 0.2 and 5.0. The percentage of masterbatch can range from about 5 to about 60% or from 10 to 20% of the total polyolefin composition. The ratio of the masterbatch to the additional polymer (D) can range from about 0.2 to about 20, or about 0.2 to about 5.0, or about 0.5 to about 2.0 and wherein the polyolefin composition has an MFR increase of about 3 to 400% compared to the same polyolefin composition without the random alpha-olefinic copolymer, the tackifier and additional polymer and wherein the polyolefin composition maintains acceptable mechanical properties.

In at least one embodiment, a polyolefin composition is provided comprising a recycled polyolefin (A), at least one random alpha-olefinic copolymer (B), optionally, at least one tackifier (C) and at least one additional polymer (D) is prepared where the alpha-olefinic copolymer (B), at least one additional polymer (D), and optionally, the tackifier (C) are first prepared as a masterbatch using a carrier polymer. The carrier polymer may be virgin or recycled polyolefin and may be identical or may be different from the recycled polyolefin (A) or the majority component in the recycled polyolefin (A) or random alpha-olefinic copolymer (B) or the additional polymer (D). The percentage of B+C is between about 5 to about 70 wt % or from about 40 to about 60 wt % based upon the weight of the masterbatch and the weight ratio of B to C is between 0.2 and 5.0. The percentage of masterbatch can range from about 5 to about 60% or from 10 to 20% of the total polyolefin composition. The ratio of the masterbatch to the additional polymer (D) can range from about 0.2 to about 20, or about 0.2 to about 5.0, or about 0.5 to about 2.0 and wherein the polyolefin composition has an MFR increase of about 38% to about 120% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties.

In at least one embodiment, a polyolefin composition is provided comprising a recycled polyolefin (A), a random alpha-olefinic copolymer (B) with a glass transition temperature equal or below −10° C. (ASTM D 3418-15) and a nominal molecular weight equal or below 25,000 g/mol (ISO 16014), a tackifier (C) with a glass transition temperature equal or above 45° C. (ASTM D 3418-15), and an additional polymer (D) is prepared where the alpha-olefinic copolymer (B), the tackifier (C), are first prepared as a masterbatch using a carrier polymer. The carrier polymer may be virgin or recycled polyolefin and may be identical or may be different from the recycled polyolefin (A) or the majority component in the recycled polyolefin (A) or the additional polymer (D). The percentage of B+C is between about 5 to about 70 wt % or from about 40 to about 60% based upon the weight of the masterbatch and the weight ratio of B to C is between 0.2 and 5.0. The percentage of masterbatch can range from about 5 to about 40% or from 10 to 20% of the total polyolefin composition. The ratio of the masterbatch to the additional polymer (D) can range from about 0.2 to about 20, or about 0.2 to about 5.0, or about 0.5 to about 2.0 and wherein the polyolefin composition has an MFR increase of about 3 to about 400% compared to the same polyolefin composition without the random alpha-olefinic copolymer, the tackifier and additional polymer and wherein the polyolefin composition maintains acceptable mechanical properties.

In at least one embodiment, a polyolefin composition is provided comprising a recycled polyolefin (A), at least one random alpha-olefinic copolymer (B) with a glass transition temperature equal or below −10° C. (ASTM D 3418-15) and a nominal molecular weight equal or below 25,000 g/mol (ISO 16014), optionally, at least one tackifier (C) with a glass transition temperature equal or above 45° C. (ASTM D 3418-15), and at least one additional polymer (D) is prepared where the alpha-olefinic copolymer (B), the at least one additional polymer (D), and, optionally, the tackifier (C), are first prepared as a masterbatch using a carrier polymer. The carrier polymer may be virgin or recycled polyolefin and may be identical or may be different from the recycled polyolefin (A) or the majority component in the recycled polyolefin (A) or the random alpha-olefinic copolymer (B) or the additional polymer (D). The percentage of B+C is between about 5 to about 70 wt % or from about 40 to about 60% based upon the weight of the masterbatch and the weight ratio of B to C is between 0.2 and 5.0. The percentage of masterbatch can range from about 5% to about 60%, from about 10% to about 40% or from about 10% to about 20% of the total polyolefin composition. The ratio of the masterbatch to the additional polymer (D) can range from about 0.2 to about 20, or about 0.2 to about 5.0, or about 0.5 to about 2.0 and wherein the polyolefin composition has an MFR increase of about 38% to about 120% or about 5% to about 200% or about 3% to about 400% and can have an increase in impact strength of about 2% to about 150% or of about 2% to about 200% compared to the same polyolefin composition without the random alpha-olefinic copolymer, the additional polymer, and optionally, the tackifier; and wherein the polyolefin composition maintains acceptable mechanical properties.

In another aspect of this embodiment, the additional polymer can be, but is not limited to, a linear low density polyethylene, a medium density polyethylene, an ethylene methyl-acrylate copolymer, an ethylene-hexene copolymer, an ethylene-butene copolymer, or an ethylene-octene copolymer.

It was surprisingly noticed that the testing standard deviations for the polyolefin compositions were significantly lower than the testing standard deviations of the unmodified recycled polyolefin samples. The significant reduction in testing variation indicates that the polyolefin composition has a more consistent composition and quality than the unmodified recycled polyolefin. This is industrially advantageous in the production of consistent products from recycled polyolefins.

Such additives that can be included in the polyolefin compositions can include, but are not limited to, antioxidants (A.O.) (for example sterically hindered phenolics such as IRGANOX™ 1010 or IRGANOX™ 1076 by BASF, phosphorous based A.O. such as IRGAFOS™ 168 by BASF, sulphur based A.O. such as Irganox PS-802 FL™ by BASF, nitrogen based A.O. such as 4,4′-bis (1,1′-dimethylbenzyl)diphenylamine or A.O. blends), anti-acids (for example calcium stearate, sodium stearate, zinc stearate, magnesium and zinc oxides, synthetic hydrotalcite, lactates and lactylates), anti-cling additives, plasticizers, tackifiers, (e.g., polybutenes, terpene resins, aliphatic and aromatic hydrocarbon resins, alkali metal and glycerol stearates, and hydrogenated rosins), UV stabilizers (for example bis-(2′2′6′6-tetramethyl-4-piperidyl)-sebacate), heat stabilizers, nucleating agents (for example sodium benzoate, 1,3:2,4-bis(3,4-dimethylobenzylideno) sorbitol), anti-blocking agents (for example, diatomaceous earth; synthetic silica; silicates such as kaolin, sodium aluminum silicate, calcined kaolin, aluminum silicate or calcium silicate; synthetic zeolites), cross-linking agents, release agents, anti-static agents (for example glycerol esters, ethoxylated amines, ethoxylated amides), anti-microbial, biocides, foaming agents, blowing agents, clarifier agents, flame retardants, catalysts, pigments, colorants, dyes, waxes or combinations thereof. Typically, these additives can be included in quantities from about 100 to about 2000 ppm for each individual additive.

Such fillers which can be included in the compositions can include, but are not limited to, coal, fly ash, calcium carbonate, barium sulfate, carbon black, metal oxides, inorganic material, natural material, alumina trihydrate, magnesium hydroxide, bauxite, talc, mica, barite, kaolin, silica, post-consumer glass, or post-industrial glass, sawdust, synthetic and natural fiber, or any combination thereof. The fillers can be organic, inorganic, or a combination of both, such as with different morphologies.

Other polymers, additives and fillers can be added in amounts as known to a person skilled in the art. For example, the amount of additive in a polyolefin composition can be less than 10 wt %, less than 5 wt %, less than 1 wt %, and less than 0.3 wt % based upon the weight of the polyolefin composition. In other embodiments of the invention, the amount of filler in the polyolefin composition can be from about 5 to about 85 wt %, from about 5 to about 75 wt %, from about 5 to about 65 wt %, from about 5 to about 55 wt %, from about 5 to about 45 wt %, from about 5 to about 35 wt %, from about 5 to about 25 wt %, and from about 5 to about 20 wt % based upon the weight of the polyolefin composition.

### Visbreaking Process to Produce Polyolefin Compositions

In another embodiment of the invention, a process to produce a polyolefin composition is provided comprising: 1) extruding at least one recycled polyethylene-rich polyolefin in the presence of at least one radical initiator to produce an extruded, visbroken recycled polyethylene-rich polyolefin; and 2) melt blending (A) about 60 to about 96 wt % of the visbroken recycled polyethylene-rich polyolefin; B) about 2 to about 20 wt % of at least one random alpha-olefinic copolymer; C) optionally, about 2 to about 20 wt % of at least one tackifier; and D) optionally, at least one additional polymer; wherein the extruded, visbroken polyolefin composition has a weight ratio of random alpha-olefinic copolymer to tackifier of between about 0.2 to about 5.0; and wherein the extruded, visbroken polyolefin composition has a melt flow rate increase of about 5 to about 1500% compared to the recycled polyolefin.

The recycled polyethylene-rich polyolefin, random alpha-olefinic copolymer, tackifier, and additional or other polymer have previously been described in this specification.

This invention also covers a new process for the visbreaking of the recycled polyolefin and blending to form a polyolefin composition. Visbreaking is defined as subjecting a polyolefin to chain scission which lowers the molecular weight and raises the melt flow rate. In one embodiment, the process employs a single extrusion step which leads to a remarkable increase in the MFR of the starting recycled polyolefin without any crosslinking.

### Starting Material for Visbreaking Process to Produce Polyolefin Compositions

In one embodiment of the invention, the process uses a starting polyethylene which is post-consumer or post-industrial polyethylene-rich polyolefin streams having a density of about 910 to about 1050 kg/m3 or an ethylene plastomer or elastomer having a density of about 855 to about 960 kg/m3. Ethylene elastomers can have a density of about 855 to about 950 kg/m3 and ethylene plastomers can have a density of about 880 to about 950 kg/m3.

### Extrusion Conditions for the Visbreaking Process

In order to increase the melt flow rate of the starting recycled polyethylene-rich polyolefin in a visbreaking process, the recycled polyethylene-rich polyolefin is extruded under particular conditions and using a specific radical initiator. In one embodiment of the invention, the extrusion process is carried out using at least one of high temperature, high shear and/or high speed. Moreover, the increase in MFR desired can be achieved using a single extrusion step. Many prior art processes require complex multiple extrusions. In this invention, a massive increase in MFR can be achieved using a single extrusion.

The extruder may thus be a single screw extruder, a twin screw extruder, such as a co-rotating twin screw extruder or a counter-rotating twin screw extruder; or a multi-screw extruder, such as a ring extruder. Suitable extruders include a single screw extruder or a twin screw extruder. In one embodiment of the invention, the extruder is a co-rotating twin screw extruder.

Suitable extruders typically are from 125 to 2540 cm, from 510 to 1270 cm, or 635 to 1020 cm in length. The residence time for the polymeric feedstock in the extruder is typically from about 30 seconds to about 5 minutes or about 30 secs to about 3 minutes.

The extruder typically has a plurality of heating zones. It is to be noted that during the extrusion process, a substantial amount of heat is often generated from shear heating. Thus, the temperature of the polymeric melt in the extruder may be substantially higher than the temperature set in the heating zone(s) at the barrel of the screw, and may also be substantially higher than the actual zone temperature readings in the extruder. Further, the actual zone temperature readings in different stages of the extruder may also be higher than the temperatures set at the heating zones. The temperatures referred to herein are the temperatures set in the heating zones.

Such extruders are well known in the art and are supplied, for instance, by Coperion, Japan Steel Works, Krauss Maffei Berstorff or Leisteritz.

In one embodiment of the invention, the extrusion is a high temperature extrusion. By high temperature is meant that the highest barrel temperature is set at a minimum of 250° C., or a minimum of 300° C. In other embodiments, the highest barrel temperature is at least 310° C., at least 325° C., at least 340° C. or at least 350° C. The upper limit for the highest barrel zone temperature extruder may be 400° C.

This can translate to a melt temperature of the polymer melt exiting the die of at least of 240° C., at least 290° C., at least 310° C., at least 320° C., at least 330° C. or at least 340° C. The upper limit for the melt temperature exiting the die may be 390° C.

In another embodiment of the invention, the extruder has 10 to 14 zones such as 12 zones. In another embodiment, the high extrusion temperature is applied by zone 3. The maximum extrusion temperature can be applied by zone 3 and is maintained across the remaining zones in the extruder.

The temperature of the die plate may be about 120° C. to about 180° C. In another embodiment, the temperature profile can be set at the following: zone 1 at less than 80° C., zone 2 at 80° C. to 120° C., zone 3 to 12 at 250° C. or more. In another embodiment, the temperature profile can be set at the following: zone 1 at 20° C., zone 2 at 100° C., zone 3 to 12 at 350° C. and die-plate at 150° C.

Without wishing to be limited by theory, we perceive that higher temperatures lead to an increase in MFR and hence a decrease in molecular weight.

In another embodiment of the invention, the extruder can be operated at high screw speed. By high screw speed is meant that the extruder screw turns at a speed of at least 300 rpm, at least 350 rpm, or at least 400 rpm. Screw speeds much higher can also be employed such as 600 rpm or more, 800 rpm or more, or 1000 rpm or more. The upper limit for the screw speed is governed by the extruder in use but may be 1300 rpm. The screw speed can range from 450 to 1200 rpm. It is preferred if the screw speed remains constant throughout the process. Without wishing to be limited by theory, we perceive that higher screw speeds lead to an increase in MFR and hence a decrease in molecular weight.

The throughput is also linked to the MFR increase. The higher the throughput the lower the MFR increase as there is less opportunity for the polymer to be subjected to the visbreaking conditions within the extruder. Whilst therefore high screw speeds are often desired, it is also desirable if throughput values are kept low. A suitable throughput on an industrial extruder maybe 5 to 40 kg/h or 10 to 20 kg/h. Lower throughput leads to higher MFR.

The screw speed is also linked to residence time within the extruder. Faster screw speeds mean shorter residence times. Residence times for the process of the invention within the extruder can range from 30 seconds to 1.5 minutes or 35 seconds to 70 seconds.

In this regard, the specific energy input to the process is also a consideration. The specific energy input (SEI) is the amount of power that is supplied to the extruder motor per kg of polymer material. Higher screw speeds mean more power to the motor. Higher output requires more power to the motor. A high SEI can achieve a high final MFR. The correlation between SEI and MFR is essentially linear.

The energy input to the extruder motor can be measured from the extruder itself. It is a derivable output from the extruder. It will be appreciated that the SEI value is dependent on the size and nature of the extruder used. Thus, SEI can be at least 0.2 kWh/kg, or at least 0.4 kWh/kg measured using Coperion ZSK32.

The process of the invention can also use high shear. The high shear effect can come from one or more kneader 90° screw elements which can be positioned in the mixing zone of the extruder. The extruder screw elements and screw configuration can be designed to promote strong shearing effect with optimized melt mixing.

The extruded, visbroken polyethylene-rich recycled polyolefin exiting the extruder die can be collected in a closed container and kept in liquid state for transporting to the next step or extruder to modify with additives and/or fillers at a lower temperature prior to pelletization. In one embodiment of the invention, the extruded, visbroken polyethylene-rich recycled polyolefin exiting the extruder die can be pelletized using conventional pelletization techniques. It is a further aspect of the invention therefore that the extruded, visbroken recycled polyethylene-rich polyolefin exiting the extruder is pelletized.

### Extruder for the Visbreaking Process

In more detail, the extruder typically comprises a feed zone, a melting zone, a mixing zone and a die zone. Further, the melt pressed through the die is typically solidified and cut to pellets in a pelletizer. The extruder typically has a length over diameter ratio, L/D, of from about 6:1 to about 65:1, or from about 8:1 to 60:1. As it is well known in the art, the co-rotating twin screw extruders usually have a greater L/D than the counter-rotating twin screw extruders. The extruder may have one or more evacuation, or vent, ports for removing gaseous components from the extruder.

Such evacuation ports should be placed in a sufficient downstream location for allowing sufficient reaction time for the initiator with the recycled polyolefin. Suitably the evacuation port can be located within the downstream end of the melting zone or within the mixing zone.

A stripping agent, such as water, steam or nitrogen, is suitably added to the extruder to assist in removing the volatile components from the polymer melt. Such stripping agent, when used, is added upstream of the evacuation port or upstream of the most downstream evacuation port, if there are multiple evacuation ports.

The extruder may also have one or more feed ports for feeding further components, such as polymer, additives and the like, into the extruder. The location of such additional feed ports depends on the type of material added through the port.

### Feed Zone for the Visbreakinq Process

The recycled polyethylene-rich polyolefin is introduced into the extruder through a feed zone. The feed zone directs the recycled polyethylene-rich polyolefin into the melting zone. Typically, the feed zone is formed of a feed hopper and a connection pipe connecting the hopper into the melting zone. Usually, the polymer flows through the feed zone under the action of gravity, i.e., generally downwards.

The residence time of the recycled polyethylene-rich polyolefin (and other components) in the feed zone is typically short, normally not more than 30 seconds, more often not more than 20 seconds, such as not more than 10 seconds. Typically, the residence time is at least 0.1 seconds or at least one second.

### Melting Zone for the Visbreaking Process

The recycled polyethylene-rich polyolefin passes from the feed zone to a melting zone. In the melting zone the recycled polyethylene-rich polyolefin melts. The recycled polyethylene-rich polyolefin is conveyed by drag caused by the rotating screw. The temperature then increases along the length of the screw through dissipation of frictional heat and increases to a level above the melting temperature of the polymer. Thereby the solid particles start to melt.

It is preferred that the screw in the melting zone is designed so that the screw in the melting zone is completely filled. Thereby the solid particles form a compact bed in the melting zone. This happens when there is sufficient pressure generation in the screw channel and the screw channel is fully filled. Typically, the screw in the melting zone comprises conveying elements without substantial backwards flow. However, in order to achieve a compact bed, some barrier or back-mixing elements may need to be installed at a suitable location, for instance, close to the downstream end of the melting zone. The screw design for obtaining a compact particle bed is well known in the extruder industry. Due to frictional heat, the temperature increases along the length of the screw and the recycled polyolefin starts to melt.

### Mixing Zone for the Visbreaking Process

After the melting zone, the recycled polyethylene-rich polyolefin passes to a mixing zone. The screw in the mixing zone typically comprises one or more mixing sections which comprise screw elements providing a certain degree of backward flow. In the mixing zone, the polymer melt is mixed for achieving a homogeneous mixture. The mixing zone may also comprise additional elements, such as a throttle valve or a gear pump.

The temperature in the mixing zone is greater than the melting temperature of the recycled polyolefin. Further, the temperature needs to be greater than the decomposition temperature of the initiator. The temperature needs to be less than the decomposition temperature of the recycled polyolefin.

The overall average residence time in the combined melting zone and the mixing zone of the extruder can beat least about 25 seconds and or at least about 30 seconds. Typically, the average residence time does not exceed 60 seconds or does not exceed 55 seconds. Good results have been obtained when the average residence time was within the range of from 30 to 45 seconds.

As it was discussed above, it is desirable to remove gaseous material from the extruder via one or more evacuation ports or, as they are sometimes called, vent ports. It is possible to use more than one evacuation port. For instance, there may be two ports, an upstream port for crude degassing and a downstream port for removing the remaining volatile material. Such an arrangement is advantageous if there is large amount of gaseous material in the extruder.

The vent ports are suitably located in the mixing zone. However, they may also be located at the downstream end of the melting zone. Especially if there are multiple vent ports it is sometimes advantageous to have the most upstream port within the melting zone and the subsequent port(s) in the mixing zone. It is also possible to add a stripping agent, such as water, steam, CO₂ or N₂, into the extruder.

Such stripping agent, when used, is introduced upstream of the vent port or, when there are multiple vent ports, upstream of the most downstream vent port and downstream of the upstream vent port. Typically, the stripping agent is introduced into the mixing zone or at the downstream end of the melting zone.

The die zone typically comprises a die plate, which is sometimes also called a breaker plate and which is a thick metal disk having multiple holes. The holes are parallel to the screw axis. The molten recycled polyolefin is pressed through the die plate. The molten recycled polyolefin thus forms a multitude of strands. The strands are then passed to the pelletizer. The function of the die plate is to arrest the spiraling motion of the recycled polyolefin melt and force it to flow in one direction. The die zone may also comprise one or more screens which are typically supported by the die plate. The screens are used for removing foreign material from the recycled polyolefin melt and also for removing gels from the polymer. The gels are typically undispersed high molecular weight polymer, for instance, cross-linked polymer.

### Radical Initiator for Visbreakinq Process to Produce Polyolefin Compositions

The radical initiator used in the process of the invention is any that is known in the art. In one embodiment, the radical initiator is one that decomposes at high temperature, i.e., at least 200° C. This means that the Self-Accelerating Decomposition Temperature (SADT) of the initiator of the invention is preferably at least 200° C. The initiator will therefore be stable up until this temperature. The initiator generally will not start degrading therefore until the polymer melt has passed through the extruder, perhaps to zone 3.

If an initiator is used which decomposes at a lower temperature, the initiator decomposes too early or too rapidly in the process and the increase in MFR required is not achieved. For example, peroxides loose activity very quickly making them unsuitable for use in the process of this invention. Alternatively, viewed, the initiator is not a peroxide. Peroxide initiators generally decompose at too low a temperature to be useful in this invention.

The radical initiator can be present in the process of the invention in an amount of at least 0.1, 0.2, 0.3, 0.4, 0.5, 0.6, 0.7, 0.8, 0.9, 1.0, 1.1, 1.2, or 1.3 wt % and/or not more than 2.0, 1.9, 1.8, 1.7, 1.6, 1.5, or 1.4 wt % based on the amount of the recycled polyolefin that is present. In another embodiment of the invention, the radical initiator can be present in the process of the invention in an amount of about 0.01 to about 2.0 wt %, about 0.02 to about 2.0 wt %, about 0.03 to about 2.0 wt %, about 0.04 to about 2.0 wt %, about 0.04 to about 2.0 wt %, about 0.05 to about 2.0 wt %, about 0.06 to about 2.0 wt %, about 0.07 to about 2.0 wt %, about 0.08 to about 2.0 wt %, about 0.09 to about 2.0 wt %, about 0.1 to about 2.0 wt %, about 0.2 to about 2.0 wt %, about 0.3 to about 2.0 wt %, about 0.4 to about 2.0 wt %, about 0.5 to about 2.0 wt %, about 0.6 to about 2.0 wt %, about 0.7 to about 2.0 wt %, about 0.8 to about 2.0 wt %, about 0.9 to about 2.0 wt %, about 1.0 to about 2.0 wt %, about 1.1 to about 2.0 wt %, about 1.2 to about 2.0 wt %, about 1.3 to about 2.0 wt %, about 1.4 to about 2.0 wt %, or about 1.5 to about 2.0 wt % based on the amount of the recycled polyolefin that is present. In other embodiments, the amount of radical initiator ranges from about 0.1 to about 1 wt %, about 0.2 to about 1.0 wt %, about 0.3 to about 1.0 wt %, about 0.4 to about 1.0 wt %, about 0.5 to about 1.0 wt %, or about 0.6 to about 1.0 wt % based on the amount of the recycled polyolefin present. Thus, if you use 100 g of recycled polyolefin, there can be 0.1 to 2.0 g of the radical initiator. The amount of radical initiator above is the total amount added. It will be appreciated that the radical initiator can be added in one batch or in separate batches in different parts of the extruder.

In one embodiment, however, all the initiator is added at the start of the process. By start of the process is meant that the radical initiator is added with the recycled polyolefin to the first zone of the extruder.

In one embodiment of the invention, a portion of the radical initiator is added at the start of the extrusion process, and a portion of the radical initiator is added later in the process. In this embodiment, the amount added at the start of the process represents 30 to 70 wt %, 40 to 60 wt %, or about 50 wt % of the total radical initiator added. The amount added after the start of the process can represent 30 to 70 wt %, 40 to 60 wt %, or 50 wt % of the total radical initiator added.

Radical initiator added later in the process can be added to any later zone in the extrusion process, such as the 4th, 5th, 6th or 7th zone, especially the 6th zone. In one embodiment of the invention, the extruder has 12 zones.

In another embodiment of the invention, the starting recycled polyolefin is dosed in the main hopper of the extruder. The radical initiator can be either dosed at once to the first zone of the extruder or at both first and sixth zones at the same time based on halfsplit of its amount.

The amount of initiator added can be used to control the MFR of the final extruded, visbroken recycled polyethylene-rich polyolefin. Higher amounts of initiator tend to lead to higher MFR values.

The radical initiator used in the invention is preferably not a peroxide. The initiator is at least one compound (E) being capable of thermally decomposing into carbon-based free radicals by breaking at least one single bond, like a carbon-carbon single bond or a carbon-hydrogen bond. The carbon-based free radicals can have the formula (I) or (II):

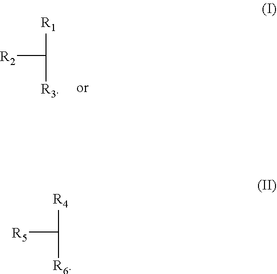

In formula (I) each of R1, R2 and R3 can be independently selected from hydrogen, substituted or unsubstituted straight chain, branched or cyclic saturated or mono-unsaturated hydrocarbons with 1 to 12 carbon atoms, substituted or unsubstituted aromatic hydrocarbons with 6 to 12 carbon atoms or carboxylate groups COOX, with X being a C1-C6-alkyl group, whereby at least one of R1, R2 and R3 is a substituted or unsubstituted aromatic hydrocarbon with 6 to 12 carbon atoms.

In formula (II), R4 and R6 independently are selected from the group consisting of hydrogen, substituted and unsubstituted straight, branched, and cyclic, hydrocarbons with 1 to 12 carbon atoms and substituted and unsubstituted aromatic hydrocarbons with 6 to 12 carbon atoms, and R5 is selected from the group consisting of substituted and unsubstituted straight, branched, and cyclic hydrocarbons with 1 to 12 carbon atoms and substituted and unsubstituted aromatic hydrocarbons with 6 to 12 carbon atoms and wherein at least one of R4, R5 and R6 is a substituted or unsubstituted aromatic hydrocarbon with 6 to 12 carbon atoms.

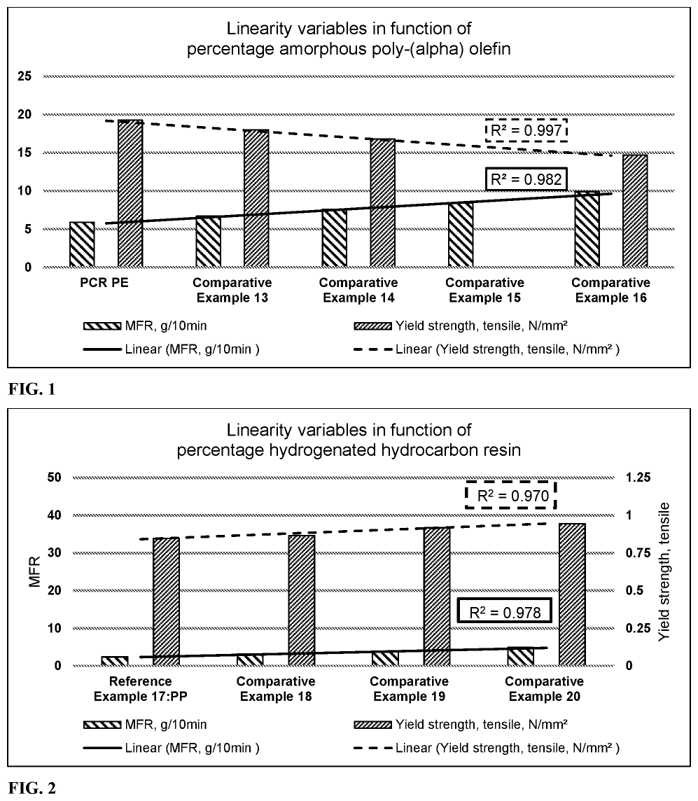

Suitable carbon-based free radicals of formula (I) or (II) are known for example from Chemicals Reviews, 2014, 114, p 5013, FIG. 1, radicals R1 to R61, herein incorporated by reference to the extent it does not contradict the statements herein. Each of R1 and R3 can be independently selected from the group consisting of hydrogen, substituted and unsubstituted straight, branched and cyclic hydrocarbons with 1 to 12 carbon atoms and substituted and unsubstituted aromatic hydrocarbons with 6 to 12 carbon atoms, and R2 can be selected from the group consisting of substituted and unsubstituted straight, branched and cyclic hydrocarbons with 1 to 12 carbon atoms and substituted and unsubstituted aromatic hydrocarbons with 6 to 12 carbon atoms.

As stated above, at least one of the groups R1, R2 and R3 or R4, R5 and R6 is a substituted or unsubstituted aromatic hydrocarbons with 6 to 12 carbon atoms. The carbon-based free radicals of formula (I) or formula (II) being suitable in the present invention are thus preferably generated from one or more compounds (E) of the formula (III) wherein each of R1, R3, R4 and R6 independently is selected from the group consisting of hydrogen, substituted and unsubstituted straight, branched, and cyclic, hydrocarbons with 1 to 12 carbon atoms and substituted and unsubstituted aromatic hydrocarbons with 6 to 12 carbon atoms, and each of R2 and R5 independently is selected from the group consisting of substituted and unsubstituted straight, branched, and cyclic hydrocarbons with 1 to 12 carbon atoms and substituted and unsubstituted aromatic hydrocarbons with 6 to 12 carbon atoms and wherein at least one of R1, R2, R3, R4, R5 and R6 is a substituted or unsubstituted aromatic hydrocarbon with 6 to 12 carbon atoms.

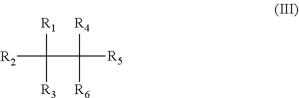

The compound (E) of formula (III) can have a symmetrical as well as an asymmetrical structure. Each of R2 and R5 independently can be selected from a substituted or unsubstituted aromatic hydrocarbon with 6 to 12 carbon atoms or from the group consisting of substituted and unsubstituted aryl groups with 6 to 10 carbon atoms and each of R1, R3, R4 and R6 independently is selected from the group consisting of hydrogen and C1-C6 alkyl groups.

In another embodiment, the initiators (E) have the formula (IV)

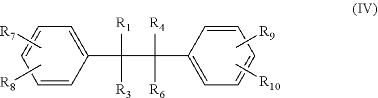

wherein each of R7, R8, R9 and R10 independently is selected from a group consisting of hydrogen atom, C1-6 alkyl groups, C1-2 alkoxy groups, a nitrile group and a halogen atom, and wherein each of R1, R3, R4 and R6 independently is selected from group consisting of hydrogen and C1-6 alkyl groups.

In a still another embodiment, the initiator (E) is selected from the group consisting of 2,3-dimethyl-2,3-diphenylbutane, 2,3-dipropyl-2,3-diphenylbutane, 2,3-dibutyl-2,3-diphenylbutane, 2,3-dihexyl-2,3-diphenylbutane, 2-methyl-3-ethyl-2,3-diphenylbutane, 2-methyl-2,3-diphenylbutane, 2,3-diphenylbutane, 2,3-dimethyl-2,3-di-(p-methoxyphenyl)-butane, 2,3-dimethyl-2,3-di-(p-methylphenyl)-butane, 2,3-dimethyl-2-methylphenyl-3-(p 2′3′-dimethyl-3′-methylphenyl-butyl)-phenyl-butane, 3,4-dimethyl-3,4-diphenylhexane, 3,4-diethyl-3,4-diphenylhexane, 3,4-dipropyl-3,4-diphenylhexane, 4,5-dipropyl-4,5-diphenyloctane, 2,3-diisobutyl-2,3-diphenylbutane, 3,4-di isobutyl-3,4-5 diphenylhexane, 2,3-dimethyl-2,3-di p(tbutyl)-phenyl-butane,5,6-dimethyl-5,6diphenyldecane, 6,7-dimethyl-6,7-diphenyldodecane, 7,8-dimethyl-7,8-di(methoxyphenyl)-tetra-decane, 2,3-diethyl-2,3-diphenylbutane, 2,3-dimethyl-2,3-di(p-chlorophenyl)butane, 2,3-dimethyl-2,3-di(p-iodophenyl)butane, and 2,3-dimethyl-2,3-di(p-nitrophenyl) butane.

In another embodiment, the initiator (E) is selected from the group consisting of 2,3-dimethyl-2,3-diphenylbutane and 3,4-dimethyl-3,4-diphenylhexane.

### Final Post Extrusion Polyolefin Composition by Visbreakinq Process

The extruded, visbroken recycled polyethylene-rich polyolefin which exits the extruder is higher in MFR and lower in molecular weight than the recycled polyolefin. The extruded, visbroken recycled polyethylene-rich polyolefin can have an MFR of at least 4 g/10 min. The increase in MFR of the extruded, visbroken recycled polyethylene-rich polyolefin can be at least 3 fold (i.e. 3× or 200%) higher than the recycled polyolefin. In other embodiments, the extruded, visbroken recycled polyethylene-rich polyolefin can have a MFR at least 4 times higher (300%), at least 4.5 times higher (350%), at least 5 times (400%) higher than the starting recycled polyolefin.

Where the starting MFR of the recycled polyethylene-rich polyolefin is low, e.g., less than 10 g/10 min, the increase in MFR of the extruded, visbroken recycled polyethylene-rich polyolefin can be even more remarkable. In embodiments of the invention, therefore, the increase in MFR of the extruded, visbroken recycled polyethylene-rich polyolefin may be 10 fold (900%) or more, 12 fold (1100%) or more, 13 fold (1200%) or more, 14 fold (1300%) or more, 15 fold (1400%) or more, or 20 fold (1900%) or more. MFR values for the extruded, visbroken recycled polyethylene-rich polyolefin, irrespective of the starting recycled polyolefin, can be at least 8 g/10 min, at least 10 g/10 min, at least 20 g/10 min, at least 25 g/10 min, or at least 50 g/10 min. MFR values of the extruded, visbroken recycled polyethylene-rich polyolefin can be 100 g/10 min or more.

The extruded, visbroken recycled polyethylene-rich polyolefin material does not exhibit a significant amount of crosslinking. The crosslinking degree of the extruded, visbroken recycled polyethylene-rich polyolefin can be less than 0.5 wt % (determined as XHU as explained in the examples), less than 0.4 wt %, or less than 0.3 wt %. In some embodiments, crosslinking can be 0.1 wt % or less or 0.05 wt % or less.

The density of the extruded, visbroken recycled polyethylene-rich polyolefin (also known as the visbroken polymer) remains essentially unchanged. The extruded, visbroken recycled polyethylene-rich polyolefin can be a LDPE having a density of 910 to 1000 kg/m3, or 915 to 985 kg/m3, MDPE having a density of 926 to 940 kg/m3, or an HDPE having a density of 855 to 980 kg/m3.

It is also remarkable that the Mw/Mn value of the extruded, visbroken recycled polyethylene-rich polyolefin appears not to change. Thus, the Mw/Mn can range from 1.5 to 4.0 after extrusion. The pre-extrusion values listed above therefor apply to the post-extrusion recycled polyolefin as well.

The melting points (measured with DSC according to ISO 11357-1) of visbroken recycled polyolefin can be below 100° C., below 90° C. or below 85° C. In one embodiment of the invention, the melting point for the ethylene copolymer, such as an LLDPE, is 120° C. or less.

As the extruded, visbroken recycled polyethylene-rich polyolefin of the invention derives from a visbreaking process as opposed to directly from the polymerization process, the extruded, visbroken recycled polyethylene-rich polyolefin is likely to contain residues deriving from the initiator. For example, when the initiator is one of formula (III) above, the radical is generated via fission of the C—C bond leaving radical groups R1R2R3C and R4R5R6C. As these radicals acquire a proton, the resulting compound may be detected as impurity in the final polymer. Detection methods include NMR. Detection of this compound confirms that the extruded, visbroken recycled polymer derives from visbreaking as opposed to direct synthesis.

The radical R1R2R3C or R4R5R6C may also attach to the polymer chain.

The extruded, visbroken recycled polyethylene-rich polymer can have further additives added to it if desired, however normally this is not required. Various quantities of additives such as pigments, nucleating agents, antistatic agents, fillers, antioxidants, etc. may however be present.

The visbroken recycled polyethylene-rich polyolefin is then melt blended to form an extruded, visbroken polyolefin composition comprising (A) about 60 to about 96 wt % of the extruded, visbroken recycled polyethylene-rich polyolefin; B) about 2 to about 20 wt % of at least one random alpha-olefinic copolymer; C) optionally, about 2 to about 20 wt % of at least one tackifier, and D) optionally, at least one additional polymer; wherein the polyolefin composition has a weight ratio of random alpha-olefinic copolymer to tackifier of between about 0.2 to about 5.0; and wherein the polyolefin composition has a melt flow rate increase of about 5 to about 1500% compared to the non-extruded non-visbroken recycled polyolefin, and wherein the extruded, visbroken polyolefin composition has an MFR increase of about 5 to about 400% compared to the same extruded, visbroken polyolefin composition without the melt blended random alpha-olefinic copolymer, optional tackifier resin and additional polymer. This melt blending step as well as the random alpha-olefinic copolymer and tackifier have been previously discussed in this disclosure. In at least one embodiment of the invention, a polyolefin composition comprising a recycled polyethylene-rich polyolefin (A) which has been subjected to a visbreaking process leading to a reduced notched impact strength, at least one random alpha-olefinic copolymer (B), optionally, at least one tackifier (C), and optionally, at least one additional polymer (D) wherein the percentage of B+D is from about 10 to about 30 wt % or from about 10 to about 20 wt % based upon the weight of the total polyolefin composition; wherein the weight ratio of B to D is between about 0.3 to about 3.0 or about 0.2 to about 2.0; and wherein the extruded, visbroken polyolefin composition has an MFR increase of about 5 to about 100% and a notched impact strength increase of about 5 to about 200% compared to the same extruded, visbroken polyolefin composition without melt blended the random alpha-olefinic copolymer(s), optional tackifier resin(s), and additional polymer(s); and wherein the extruded, visbroken polyolefin composition maintains acceptable mechanical properties.

In at least one embodiment of the invention, a polyolefin composition comprising a recycled polyethylene-rich polyolefin (A) which has been subjected to a visbreaking process leading to a reduced notched impact strength, at least one random alpha-olefinic copolymer (B) with a glass transition temperature equal or below −10° C. (ASTM D 3418-15) and a nominal molecular weight equal or below 25,000 g/mol (ISO 16014), and, optionally, at least one tackifier (C) with a glass transition temperature equal or above 45° C. (ASTM D 3418-15), and optionally, at least one additional polymer (D) wherein the percentage of B+D is from about 10 to about 30 wt % or from about 10 to about 20 wt % based upon the weight of the total polyolefin composition; wherein the weight ratio of B to D is between about 0.3 to about 3.0 or about 0.2 to about 2.0; and wherein the extruded, visbroken polyolefin composition has an MFR increase of about 5 to about 100% and a notched impact strength increase of about 5 to about 200% compared to the same extruded, visbroken polyolefin composition without melt blended the random alpha-olefinic copolymer(s), optional tackifier resin(s), and additional polymer(s); and wherein the extruded, visbroken polyolefin composition maintains acceptable mechanical properties.

In at least one embodiment of the invention, a polyolefin composition is provided comprising an extruded polyethylene-rich recycled polyolefin (A) which has been subjected to a visbreaking process leading to a reduced notched impact strength, at least one random alpha-olefinic copolymer (B), optionally, at least one tackifier (C), and optionally, at least one additional polymer (D), wherein the additional polymer(s) can be, but is not limited to, a linear low density polyethylene, a medium density polyethylene, an ethylene methyl-acrylate copolymer, an ethylene-hexene copolymer, an ethylene-butene copolymer, or an ethylene-octene copolymer, wherein the extruded, visbroken polyolefin composition is prepared where the percentage of B+D is from about 10 to about 30 wt % based upon the weight of the total polyolefin composition, more preferably from about 10 to 20 wt %, and where the weight ratio of B to D is between 0.3 to 3.0, more preferably between 0.2 and 2.0; and wherein the extruded, visbroken polyolefin composition has an MFR increase of about 5 to about 100% and a notched impact strength increase of about 5 to about 200% compared to the same extruded, visbroken polyolefin composition without the random alpha-olefinic copolymer(s), optional tackifier resin(s), and additional polymer(s) and wherein the polyolefin composition maintains acceptable mechanical properties.

In at least one embodiment of the invention, a polyolefin composition is provided comprising a polyethylene-rich recycled polyolefin (A) which has been subjected to a visbreaking process leading to a reduced notched impact strength, at least one random alpha-olefinic copolymer (B) with a glass transition temperature equal or below −10° C. (ASTM D 3418-15) and a nominal molecular weight equal or below 25,000 g/mol (ISO 16014), and, optionally, at least one tackifier (C) with a glass transition temperature equal or above 45° C. (ASTM D 3418-15), (C), and optionally, at least one additional polymer (D), wherein the additional polymer(s) can be, but is not limited to, a linear low density polyethylene, a medium density polyethylene, an ethylene methyl-acrylate copolymer, an ethylene-hexene copolymer, an ethylene-butene copolymer, or an ethylene-octene copolymer, wherein the extruded, visbroken polyolefin composition is prepared where the percentage of B+D is from about 10 to about 30 wt % based upon the weight of the total polyolefin composition, more preferably from about 10 to 20 wt %, and where the weight ratio of B to D is between 0.3 to 3.0, more preferably between 0.2 and 2.0; and wherein the extruded, visbroken polyolefin composition has an MFR increase of about 5 to about 100% and a notched impact strength increase of about 5 to about 200% compared to the same extruded, visbroken polyolefin composition without the random alpha-olefinic copolymer(s), optional tackifier resin(s), and additional polymer(s) and wherein the extruded, visbroken polyolefin composition maintains acceptable mechanical properties.

In at least one aspect of this embodiment, the extruded, visbroken polyolefin compositions show a about 5 to 100% MFR increase and also an increased elongation at yield of about 5 to 100% compared to the same extruded, visbroken polyolefin composition without the random alpha-olefinic copolymer(s), optional tackifier resin(s), and additional polymer(s), while maintaining acceptable mechanical properties.

In another aspect of this embodiment, the additional polymer (D) is virgin polymer with a fractional melt MFR (<1 measured according ISO1133 at 190° C. 2.16 kg), and in yet another aspect of this embodiment the additional polymer is recycled polyolefin with 100-1000% higher notched impact strength compared to the recycled polyethylene-rich polyolefin (A) after visbreaking.

In at least one embodiment, the polyolefin composition is made in a second process step after the visbreaking according to the melt blending as previously discussed in this disclosure. After the visbreaking step and before the melt blending step, the visbroken polyethylene-rich recycled polyolefin can be stored according to conditions as known to persons skilled in the art, in the form of, but not limited to, pellets, flakes, powder. In at least one embodiment, the visbroken polyethylene-rich polyolefin can be stabilized with additives known to persons skilled in the art and stored in molten form.

In at least one other embodiment the visbroken polyethylene-rich recycled polyolefin is directly fed into a melt blending process without intermediate storage. The melt blending process to achieve the extruded, visbroken polyolefin composition, which is followed in-line of the visbreaking process, can only be conducted when the visbroken polyethylene-rich recycled polyolefin is sufficiently cooled, preferably below 250° C., more preferably below 220° C., to allow appropriate feeding and melt blending. This melt blending process has been previously discussed in this disclosure.

In another specific aspect of this embodiment, the dosing level of the random alpha-olefinic copolymer and/or tackifier and/or additional polymer in the extruded, visbroken polyolefin composition can be metered by measuring the melt viscosity of the visbroken polyethylene-rich recycled polyolefin using an in-line rheometer and adapting the dosing level based on this measured melt viscosity to achieve the targeted melt viscosity. Such in-line rheometers are available from companies such as Haake, Leistritz and Brabender.

### Applications

In another embodiment of this invention, articles comprising the polyolefin composition are provided. Articles include, but are not limited to, films (such as mono or multilayer films for packaging, mono or biaxially oriented films, cast films, shrink films, overwrap films, lamination films, laminated films, blown films for plastic bags, agricultural films, protective films for coated parts or cellphone screens, protective packaging films, films for vertical formed fill sealable packaging, films for horizontal formed fill sealable packaging, construction films for underslab moisture barrier, sheets, extruded parts (such single, co and multi extruded profiles, tubes, fibers and pipes, over jacketed wires), injection molded parts (such as battery cases), blow molded parts (such as rigid packaging, bottles and containers for home car, food or personal care), thermoformed articles (such as deep drawn containers or cups for home care, food or personal care) rotomolded articles (such as water tanks), woven and non-woven textiles and foamed articles (such as sealing gaskets). Additional articles include carpets, flooring materials, roofing materials, composites (such as exterior decking), synthetic paper, artificial turf, fibers, thermoplastic elastomers (such as TPO sheets or (over)molded articles), automotive parts (such as dashboards and window seals), computer parts, healthcare parts, building materials, household appliances, electronic parts, electric parts, toys and footwear components. Films of the present disclosure include any suitable film structure and film application. Specific end use films include, for example, blown films, cast films, stretch films, stretch/cast films, stretch cling films, stretch handwrap films, machine stretch wrap, shrink films, shrink wrap films, green house films, laminates, and laminate films. Exemplary films are prepared by any suitable technique, such as for example, techniques utilized to prepare blown, extruded, and/or cast stretch and/or shrink films. multilayer films (or multiple-layer films) may be formed by any suitable method. The total thickness of multilayer films may vary based upon the application desired. Sheet made from a composition of the present disclosure may be used to form a container. Such containers may be formed by thermoforming, solid phase pressure forming, stamping and other shaping techniques. Sheets may also be fanned to cover floors or walls or other surfaces.

Compositions of the present invention may be formed into an article by one of several conventional processes and apparatus known to a person skilled in the art. Exemplary processes include, but are not limited to, casting, extrusion, extrusion coating, co-extrusion, extrusion foaming, compression molding, calendaring, injection molding, thin wall injection molding, low pressure molding, direct injection expanded foam molding, compression molding, transfer molding, blow molding, rotomolding or combinations thereof such as extrusion followed by thermoforming or bi-axially orientation. The combination of processes may be done inline or as a process consisting of separate production steps allowing intermediate storage of semi-finished articles (for example secondary orientation of an extruded film). Articles may also be prepared by melt-in place processes, such as, a thermofix process or as cold formed processes also referred to as solid-phase forming. Additionally, articles may be prepared by additive manufacturing processes including, but not limited to, stereolithografie (SLA), fuse deposit melting (FDM), selective laser sintering (SLS), multi jet fusion (MJF) polyjet, vacuum casting or combinations thereof.

It is implied within the embodiment of this invention that the compositions described in the present invention can also contain virgin polyolefin polymer, and a person skilled in the art can use this specification and the claims appended thereto to modify compositions that contain up to 96 wt % virgin polyolefin polymer, based upon the weight of the composition. A virgin polymer may be identical (except for the origin) or different to the recycled polyolefin or the majority polymer of the recycled polyolefin.

### EXAMPLES

These and other aspects of the present invention may be more fully understood with reference to the following examples, which are merely illustrative of preferred embodiments of the present invention and are not to be construed as limiting the invention.

Materials used in Examples 1-19 are shown in Table 1.

TABLE 1

| Material | Description |
|---|---|
| PCR PE | Homogenized high density polyethylene |
| | regranulate (rHDPE),, 100% post-consumer |
| | recyclate source, without UV Stabilizer |
| | and >98% polyethylene*, MFR 0.8 g/10 min |
| PCR PP | Homogenized, stabilized PP copolymer |
| | regranulate, 100% post-consumer recyclate |
| | source, <3% fillers |
| LDPE Carrier 1 | Low density polyethylene, MFR 22 g/10 min |
| LDPE Carrier 2 | Low density polyethylene, MFR 7.5 g/10 min |
| PP Carrier | PP homo polymer MFR 25 g/10 min |
| Moplen ™ HP400H | Polypropylene homopolymer |
| Aerafin ™ 17 | Amorphous poly-(alpha-)olefin |
| Plastolyn ™ R1140 | Fully hydrogenated hydrocarbon resin |
| Irganox ™ 1010 | Pentaerythritol tetrakis[3-[3,5-di-tert-butyl-4- |
| | hydroxyphenyl]propionate sterically hindered |
| | phenolic primary antioxidant |
| Irgafos ™ 168 | Tris(2,4-di-tert.-butylphenyl)phosphite, |
| | Hydrolytically stable phosphite processing |
| | stabilizer |

*PCR PE contains a small percentage of polypropylene (<0.5%) and carbon black (<1.3%), but also traces of other polymers (<0.03% of polyvinyl chloride, poly-ethylene terephthalate, polycarbonate, polystyrene, acrylonitrile-butadiene-styrene, polyamide, polyurethane)

The significance of the symbols used in these examples, the units expressing the variables mentioned, and the methods of measuring these variables, are explained below.

Test methods for the data in these Examples 1-23 are provided below in Table 2.

TABLE 2

| Test Method | Description |
|---|---|
| MFR (g/10 min) | Melt Flow Rate, measured in g/10 min at 190° C. |
| | under a load of 2.16 kg, except when noted that |
| | 21.6 kg was used, according to ISO1133-1: 2011; |
| | for Examples 10, and 18-20, 230° C. was used |
| Flexural Modulus | Flexural Modulus, measured as Newton per square |
| (N/mm²) | millimeter at 23° C. and a speed of 1 mm/min |
| | according ISO 178: 2019 on a 80 × 10 × 4 mm |
| | specimen machined from universal test specimen |
| | according to ISO 20753 |
| Flexural strength | Flexural strength at yield, measured as Newton |
| at yield (N/mm²) | per square millimeter at 23° C. and a speed of |
| | 1 mm/min according ISO 178: 2019 on a |
| | 80 × 10 × 4 mm specimen machined from |
| | universal test specimen according to ISO 20753 |
| Tensile modulus | Tensile modulus, measured as Newton per square |
| (=E-modulus) | millimeter at 23° C. and a speed of 1 mm/min |
| (N/mm²) | according ISO 527-2: 2012 on a universal test |
| | specimen |
| Tensile strength | Tensile strength at yield, measured as Newton per |
| at yield (N/mm²) | square millimeter at 23° C. and a speed of 50 mm/ |
| | min according ISO 527-2: 2012 on a universal |
| | test specimen* |
| Charpy impact | Notched Charpy impact, measured as 1000 joules |
| strength (kJ/m²) | per square meter at 23° C. and a 2.82 J pendulum |
| | and 609.6 mm drop height according ISO |
| | 179-1: 2010 on a 80 × 10 × 4 mm specimen |
| | machined from universal test specimen according |
| | to ISO 20753 and type A notch (r_{N} = 0.25 mm ± |
| | 0.05 mm) |

*The universal test specimens were prepared by injection molding using an Engel Victory VC 300/80 Tech pro Injection Molding Machine (800 kN clamp force and 35 mm screw diameter) at a 200-230° C. screw temperature profile and a set mold cavity temperature of 25° C.

### Examples 1-8 Polyethylene-Rich PCR Modified with MB Comprising Tackifier or Random Alpha-Olefinic Copolymer

Polyolefin compositions comprising 89.9-99.9 wt % post-consumer polyethylene (PCR PE) with an MFR of 0.8 (190° C., 2.16 kg), 0-2 wt % fully hydrogenated hydrocarbon tackifier resin (Plastolyn™ R1140), 0-5 wt % amorphous poly-alpha-olefin (Aerafin™ 17) and 0.1 wt % of antioxidant/stabilator (Irganox™ 1010 and Irgafos™ 168) based on the weight of the polyolefin composition were prepared by compounding on a Leistritz twin screw extruder at a 145-160° C. screw temperature profile and a screw speed of 170 rpm after manual dry blending the PCR PE with a 50% masterbatch of Plastolyn™ R1140 in virgin low density polyethylene with an MFR of 22 (190° C., 2.16 kg), a 50% masterbatch of Aerafin™ 17 amorphous poly-alpha olefin in virgin low density polyethylene (LDPE) with an MFR of 22 (190° C., 2.16 kg) and Irganox™1010 and Irgafos™168 in powder form. The compositions and properties of the Examples are given in Table 3 and Table 4. The masterbatches were compounded on a Leistritz twin screw extruder at an 85-135° C. screw temperature profile and a screw speed of 170 rpm after manual dry blending.

TABLE 3

| | Ref. Ex. | | | | | |
|---|---|---|---|---|---|---|
| | Example | | | | | |
| | 1: PCR | Inv. | Comp. | Comp. | Comp. | Comp. |
| | PE | Ex. 2 | Ex. 3 | Ex. 4 | Ex. 5 | Ex. 6 |
| PCR PE, wt % | 99.9 | 91.9 | 95.9 | 89.9 | 95.9 | 89.9 |
| Aerafin ™ 17, wt | — | 2 | 2 | 5 | — | — |
| % | | | | | | |
| Plastolyn ™ | — | 2 | — | — | 2 | 5 |
| R1140, wt % | | | | | | |
| LDPE | — | 4 | 2 | 5 | 2 | 5 |
| carrier 1 wt % | | | | | | |
| Irganox ™1010/ | 0.1 | 0.1 | 0.1 | 0.1 | 0.1 | 0.1 |
| Irgafos ™168, wt | | | | | | |
| % | | | | | | |
| MFR, g/10 min | 19.8 | 25.3 | 20.5 | 28.8 | 20.6 | 24.1 |
| (190° C., | | | | | | |
| 21.6 kg) | | | | | | |
| Yield strength, | 12.0 | 11.5 | 11.7 | 9.3 | 12.0 | 12.6 |
| tensile, N/mm² | | | | | | |
| Charpy impact | 17.7 | 16.1 | 17.4 | 16.0 | 17.1 | 13.6 |
| strength, kJ/m² | | | | | | |

The results in Table 3 demonstrate the improved properties of the present invention over the modification of PCR PE either only with a hydrogenated hydrocarbon resin or only with an amorphous poly-(alpha-)olefin in Comparative Example 3-6. The single dosing of amorphous poly-(alpha-)olefin at levels required to have a significant increase of MFR, leads to a decrease of the tensile strength at yield (Comparative Example 4), while dosing at lower levels does not show the desire increase in MFR (Comparative Example 3). The single dosing of hydrogenated hydrocarbon resin at levels required to have a significant increase of MFR, leads to a decrease in Charpy impact strength (Comparative Example 6), while dosing at lower levels does not show the desired increase in MFR (Comparative Example 5). The MFR, tensile strength at yield and Charpy impact strength results in Inventive Example 2 show surprising and unexpected improvements when dosing both hydrogenated hydrocarbon tackifier resin and amorphous poly-(alpha-)olefin, compared to the comparative examples.

TABLE 4

| | Ref. Ex 1: | Inv. | Comp. | Comp. | Calc. |
|---|---|---|---|---|---|
| | PCR PE | Ex. 7 | Ex. 4 | Ex. 5 | Ex. 8* |
| PCR PE, wt % | 99.9 | 85.9 | 89.9 | 95.9 | 85.9 |
| Aerafin ™ 17, wt % | — | 5 | 5 | — | 5 |
| Plastolyn ™ R1140, | — | 2 | — | 2 | 2 |
| wt % | | | | | |
| LDPE | — | 7 | 5 | 2 | 7 |
| carrier 1 wt % | | | | | |
| Irganox ™ 1010/ | 0.1 | 0.1 | 0.1 | 0.1 | 0.1 |
| Irgafos ™ 168, wt % | | | | | |
| Properties | | | | | |
| MFR, g/10 min | 19.8 | 34.9 | 28.8 | 20.6 | 26.5 |
| Yield strength, | 12.0 | 10.3 | 9.3 | 12.0 | 10.1 |
| tensile, N/mm² | | | | | |
| Charpy impact | 17.7 | 15.0 | 16.0 | 17.1 | 16.3 |
| strength, kJ/m² | | | | | |

*Results from Calculated Example 8 are the weighted average of the results from example 4 and 5 with assumption of linearity of the effect on the variables in relation to the total dosed percentage of hydrogenated hydrocarbon resin and an amorphous poly-(alpha-)olefin. This linearity is verified on the MFR, tensile modulus and tensile strength at yield and proves to be correct for dosing levels between 0-10% leading to a linear fit with an R² >0.97 as shown by Examples 13-16 and Examples 18-20.

The results in Table 4 demonstrate the improved properties of the present invention (Example 7) over the calculated properties (Calculated Example 8) of modification of PCR PE with a hydrogenated hydrocarbon resin and an amorphous poly-(alpha-)olefin. The MFR increase is higher than the calculated MFR (Calculated Example 8) based on the weight averaged MFR increase from only dosing hydrogenated hydrocarbon resin or amorphous poly-(alpha-)olefin. Unexpectedly also the yield strength is above the expected yield strength of Calculated Example 8.

### Examples 9-11 Modification of Polypropylene-Rich PCR with MB Comprising Tackifier Resin or Random Alpha-Olefinic Copolymer

Polyolefin compositions comprising of 80-100 wt % post-consumer polypropylene (PCR PP), 0-10 wt % amorphous poly-alpha-olefin (Aerafin™ 17), and 0-2 wt % fully hydrogenated hydrocarbon tackifier resin (Plastolyn™ R1140) based on the total weight of the polyolefin composition were prepared by compounding on a Collin ZK25P twin screw extruder at a 150-210° C. screw temperature profile and screw speed of 250 rpm, after manual dry blending the PCR PP with a 50 wt % masterbatch of Aerafin™ 17 in virgin polypropylene with an MFR of 25 (230° C., 2.16 kg) and a 50 wt % masterbatch of Plastolyn™ R1140 in virgin polypropylene with an MFR of 25 g/10 min (230° C., 2.16 kg). The compositions and properties of the Examples are given in Table 5. The master batches were compounded on a Leistritz twin screw extruder at a 120-180° C. screw temperature profile and a screw speed of 130 rpm after manual dry blending.

TABLE 5

| | Reference | | |
|---|---|---|---|
| | Example 9: | Inventive | Comparative |
| | PCR PP | Example 10 | Example 11 |
| PCR PP, wt % | 100 | 80 | 80 |
| Aerafin ™ 17, wt % | — | 8 | 10 |
| Plastolyn ™ R1140, wt % | — | 2 | — |
| PP carrier, wt % | — | 10 | 5 |
| MFR, g/10 min 230° C., | 14.8 | 23.6 | 22 |
| 2.16 kg | | | |

The results in Table 5 demonstrate the improved properties of the present invention over the modification of PCR PP only with an amorphous poly-(alpha-) olefin in Example 11. The MFR increase is higher than the MFR when only dosing an amorphous poly-(alpha-) olefin (Example 10).

### Comparative Examples 12-16 Random Alpha-Olefinic Copolymer in PCR PE

Comparative polyolefin composition comprising of 80-95 wt % post-consumer polyethylene (PCR PE) and 2.5-10% amorphous poly-alpha-olefin (Aerafin™ 17) based on the total weight of the polyolefin composition were prepared by compounding on a Collin ZK25P twin screw extruder at a 150-210° C. screw temperature profile and screw speed of 200 rpm. After manual dry blending the PCR PE with a 50 wt % masterbatch of Aerafin™ 17 in virgin low density polyethylene with an MFR of 7.5 g/10 min (190° C., 2.16 kg), the masterbatch and the post-consumer polyethylene were compounded on a Leistritz twin screw extruder at a 85-135° C. screw temperature profile and a screw speed of 170 rpm after manual dry blending. Reference Example 12 was similarly prepared without addition of the masterbatch of Aerafin™ 17.

TABLE 6a

| | Ref. | | | | | |
|---|---|---|---|---|---|---|
| | Ex.12: | Comp. | Comp. | Comp. | Comp. | Linearity |
| | PCR PE | Ex. 13 | Ex. 14 | Ex. 15 | Ex. 16 | R² |
| PCR | 100 | 95 | 90 | 85 | 80 | — |
| PE, wt % | | | | | | |
| Aerafin ™ 17, | — | 2.5 | 5 | 7.5 | 10 | — |
| wt % | | | | | | |
| LDPE | — | 2.5 | 5 | 7.5 | 10 | — |
| carrier 2 wt % | | | | | | |
| MFR, | 5.9 | 6.7 | 7.6 | 8.4 | 9.9 | 0.982 |
| g/10 min 190° | | | | | | |
| C., 2.16 kg | | | | | | |
| Tensile | 685 | 620 | 555 | — | 470 | 0.987 |
| modulus, | | | | | | |
| N/mm² | | | | | | |
| Yield | 19.3 | 18.0 | 16.8 | — | 14.7 | 0.997 |
| strength, | | | | | | |
| tensile, | | | | | | |
| N/mm² | | | | | | |

The results in Table 6a support the assumption of linearity (made in Example 8) of the effect on the variables in relation to the total dosed percentage of an amorphous poly-(alpha-)olefin.

### Comparative Examples 17-20 Tackifier Resin in PCR PP

Comparative polyolefin compositions comprising of 80-95 wt % polypropylene homopolymer (Moplen HP400H) and 5-20 wt % fully hydrogenated hydrocarbon tackifier resin (Plastolyn™ R1140) based on the total weight of the polyolefin composition were dry-blend using a 20% masterbatch of Plastolyn™ R1140 in Moplen HP400H prepared by compounding on a Coperion ZSK 18, co-rotating 18 mm twin screw extruder at a 80-190° C. screw temperature profile with a screw speed of 300 rpm. Universal test specimens were prepared from the dry-blends by injection molding using an Engel Victory VC 300/80 Tech pro Injection Molding Machine (800 kN clamp force and 35 mm screw diameter) at a 200-220° C. screw temperature profile and a set mold cavity temperature of 15° C. Reference Example 17 was similarly prepared without addition of the masterbatch of Plastolyn™ R1140.

TABLE 6b

| | Reference | | | | |
|---|---|---|---|---|---|
| | Example 17: | Comparative | Comparative | Comparative | Linearity |
| | PP | Example 18 | Example 19 | Example 20 | R² |
| Moplen | 100 | 95 | 87.5 | 80 | — |
| HP400H, wt % | | | | | |
| Plastolyn ™ R1140, | — | 5 | 12.5 | 20 | — |
| wt % | | | | | |
| MFR, g/10 min | 2.4 | 3.2 | 3.8 | 4.9 | 0.978 |
| 230° C., 2.16 kg | | | | | |
| Tensile modulus, | 1571 | 1824 | 2042 | 2320 | 0.998 |
| N/mm² | | | | | |
| Yield strength, | 33.9 | 34.6 | 36.7 | 37.8 | 0.970 |
| tensile, N/mm² | | | | | |

The results in Table 6b support the assumption of linearity (made in Example 8) of the effect on the variables in relation to the total dosed percentage of a hydrogenated hydrocarbon resin.

Materials used in Examples 21-23 are shown in Table 7.

TABLE 7

| Material | Description |
|---|---|
| PCR PE | homogenized high density polyethylene |
| | regranulate (rHDPE), 100% post-consumer |
| | recyclate source, without UV Stabilizer |
| | and >98% polyethylene*, MFR 0.8 g/10 min |
| LDPE Carrier 2 | Low density polyethylene, MFR 7.5 g/10 min |
| Aerafin ™ 17 | Amorphous poly-(alpha-)olefin |
| Irganox ™ 1010 | Pentaerythritol tetrakis[3-[3,5-di-tert-butyl-4- |
| | hydroxyphenyl]propionate sterically hindered |
| | phenolic primary antioxidant |
| Irgafos ™ 168 | Tris(2,4-di-tert.-butylphenyl)phosphite, |
| | Hydrolytically stable phosphite processing |
| | stabilizer |
| Ca stearate carrier | Calcium stearate |
| Radical initiator | 2,3-Dimethyl-2,3-diphenylbutane |
| | (CAS#1889-67-4) |

*PCR PE contains a small percentage of polypropylene (<0.5%) and carbon black (<1.3%), but also traces of other polymers (<0.03% of polyvinyl chloride, poly-ethylene terephthalate, polycarbonate, polystyrene, acrylonitrile-butadiene-styrene, polyamide, poly urethane)

### Comparative Example 21 Extrusion of PCR PE

A compound comprising of 100% post-consumer polyethylene (PCR PE, 0.8 MFR) was prepared by compounding on a Collin ZK 25E LD 42 twin screw extruder at a 250-350° C. screw temperature profile and a screw speed of 150 rpm.

### Comparative Example 22 Visbreaking of PCR PE

A compound comprising 99.9% post-consumer polyethylene (PCR PE, 0.8 MFR) and 0.1% 2,3-dimethyl-2,3-diphenylbutane (radical initiator) was prepared by compounding on a Collin ZK 25E LD 42 twin screw extruder at a 250-350° C. screw temperature profile and a screw speed of 150 rpm after manual dry blending the PCR PE with the radical initiator.

### Inventive Example 23 Modification of Visbroken rPE with Random Alpha-Olefinic Copolymer

A compound comprising of 79.7% of Comparative Example 22, 10% amorphous poly-alpha-olefin (Aerafin™ 17) and 0.3% of antioxidant/stabilizer (Irganox™ 1010 and Irgafos™ 168) was prepared by compounding on a Collin ZK 25E LD 42 twin screw extruder at a 145-170° C. screw temperature profile and screw speed of 20 rpm, after manual dry blending Comparative Example 22 with a 50% masterbatch of Aerafin™ 17 in virgin low density poly-ethylene with an MFR of 7.5 (190° C., 2.16 kg) and a 75% masterbatch of Irganox™ 1010 and Irgafos™ 168 in calcium stearate (1:2 ratio of Irganox™ 1010 to Irgafos™ 168). The Aerafin™ 17 masterbatch was compounded on a Leistritz twin screw extruder at a 120-180° C. screw temperature profile and a screw speed of 130 rpm after manual dry blending.

TABLE 8

| | | Compar- | Compar- | |
|---|---|---|---|---|
| | | ative | ative | Inventive |
| | | Example | Example | Example |
| | PCR PE | 21 | 22 | 23 |
| PCR PE, MFR 0.8, wt % | 100 | 100 | 99.9 | — |
| Radical initiator (%) | — | — | 0.1 | — |
| Comparative example 22 | — | — | — | 79.9 |
| Aerafin ™ 17, wt % | — | — | — | 10 |
| LDPE carrier 2 wt % | — | — | — | 10 |
| Irganox ™ 1010/ | — | — | — | 0.3 |
| Irgafos ™ 168, wt % | | | | |
| Ca stearate carrier | — | — | — | 0.1 |
| MFR, g/10 min 190° C. | 0.8 | 1.9 | 6.2 | 10.1 |

The results in Table 8 demonstrate the improved properties of the present invention (Inventive Example 23) over the modification of PCR PE by high temperature extrusion (Comparative example 21) or by high temperature extrusion in the presence of a radical initiator (visbreaking) (Comparative Example 22). Modification with an amorphous poly-alpha-olefin after high temperature extrusion in the presence of a radical initiator (visbreaking) leads to a 62.9% higher MFR than only performing a high temperature extrusion in the presence of a radical initiator, and an 430% higher MFR compared to a high temperature extrusion in the absence of a radical initiator. Compared to the original unmodified PCR PE, the Inventive Example 23 exhibits a 1160% higher MFR.

Materials used in the following examples 24-51 are shown in TABLE 9.

TABLE 9

| Material | Description |
|---|---|
| PCR PE2 | homogenized high density polyethylene |
| | regranulate (rHDPE), 100% post-consumer |
| | recyclate source, without UV Stabilizer |
| | and >98% polyethylene*, MFR ~0.3 g/ |
| | 10 min |
| r-HDPE (as is) | homogenized high density polyethylene |
| PCR PE3 | regranulate (rHDPE), 100% post-consumer |
| | recyclate source, without UV Stabilizer |
| | and >98% polyethylene*, lower notched |
| | Charpy impact strength than PCR PE2, |
| | MFR ~0.3 g/10 min |
| PCR PP | GRAF 900323 Upcyclen PPC 10-10-05 |
| | OIT HI grau |
| LLDPE Carrier | Linear low density polyethylene, MFR |
| | 1.0 g/10 min |
| HDPE Carrier | High density polyethylene, MFR 0.8 g/ |
| | 10 min |
| Dowlex 2045G | Linear low density polyethylene, MFR |
| | 1.0 g/10 min |
| Unival DMDH | High density polyethylene, MFR 0.8 g/ |
| 6400 NT7 | 10 min |
| PP Carrier | PINNACLE ™ 1112, MFR 12 g/10 min |
| Aerafin ™ 17 | Amorphous poly-(alpha-)olefin, Softening |
| | Point 130° C. |
| Aerafin ™ 180 | Amorphous poly-(alpha-)olefin, Softening |
| | Point 120° C. |
| Eastotac ™ H-142W | Fully hydrogenated hydrocarbon tackifier |
| | resin |
| Plastolyn ™ R1140 | Fully hydrogenated hydrocarbon tackifier |
| | resin |

*PCR PE2 contains a small percentage of polypropylene (<0.5%), CaCO3 (<1.5%), and inorganic pigment (<0.5%), but also traces of other polymers (<0.03% of polyvinyl chloride, poly-ethylene terephthalate, polycarbonate, polystyrene, acrylonitrile-butadiene-styrene, polyamide, polyurethane)

Test methods for the data in Examples 24-51 are provided below in Table 10.

TABLE 10

| Test Method | Description |
|---|---|
| MFR (g/10 min) | Melt Flow Rate, measured in g/10 min at 190° C. |
| | for PE based materials or 230° C. for PP based |
| | materials as specified under a load of 2.16 kg, |
| | according to ISO1133-1: 2011; Melt-flow- |
| | rate (MFR) was measured using a Zwick extrusion |
| | plastometer for Examples 24-34 and a Testing |
| | Machines Inc.(TMI) XNR-400 Examples 45-51. |
| Flexural Modulus | Flexural Modulus, measured as Newton per square |
| (N/mm²) | millimeter at 23° C. and a speed of 1 mm/min |
| | according ISO 178: 2019 on a 80 × 10 × 4 mm |
| | specimen machined from universal test |
| | specimen according to ISO 20753 |
| Flexural strength | Flexural strength at yield, measured as Newton |
| at yield (N/mm²) | per square millimeter at 23° C. and a speed of |
| | 1 mm/min according ISO 178: 2019 on a 80 × |
| | 10 × 4 mm specimen machined from universal |
| | test specimen according to ISO 20753 |
| Tensile modulus | Tensile modulus, measured as Newton per |
| (N/mm²) | square millimeter at 23° C. and a speed of |
| | 1 mm/min according ISO 527-2: 2012 on a |
| | universal test specimen |
| Tensile strength | Tensile strength at yield, measured as Newton |
| at yield (N/mm²) | per square millimeter at 23° C. and a speed of |
| | 50 mm/min according ISO 527-2: 2012 on a |
| | universal test specimen* |
| Elongation at | Tensile elongation at break, measured as % at |
| break, % | 23° C. and a speed of 50 mm/min according |
| | ISO 527-2: 2012 on a universal test specimen* |
| Notched Izod | Notched Izod impact, measured as 1000 joules |
| impact strength | per square meter at 23° C. according ISO 180 |
| (kJ/m²) | on a 80 × 10 × 4 mm specimen machined from |
| | molded flex bar according to ISO 180 and |
| | type A notch (r_{N} = 0.25 mm ± 0.05 mm) |

*The universal test specimens were prepared by injection molding using a Toyo Injection Molding Machine (90-ton clamp force and 32 mm screw diameter) at a 170-195° C. screw temperature profile and a set mold cavity temperature of 20° C.

### Example 24 PCR PE Composition Prepared Using Masterbatches

Three masterbatches (MB) were compounded on a Werner & Pfleiderer twin-screw extruder with 40 mm diameter, 40/1 L/D with the compositions and at the screw temperature profile and screw speed as listed in Table 11. Two raw material feeders for the random alpha-olefinic copolymers or tackifier resin and the carrier polymer were utilized in the main hopper during the masterbatch process.

TABLE 11
Compositions and processing conditions of PE
masterbatches (MB) used in Examples 24-34.

| | MB | MB | MB |
|---|---|---|---|
| | Eastotac ™ | Plastolyn ™ | Aerafin ™ |
| | H-142W | R1140 | 17 |
| Carrier | Dowlex ™ | Dowlex ™ | Dowlex ™ |
| | 2045G | 2045G | 2045G |
| Carrier polymer | LLDPE | LLDPE | LLDPE |
| type | | | |
| Carrier, wt % | 50 | 50 | 80 |
| Additive, wt % | 50 | 50 | 20 |
| Screw | 120-160 | 120-170 | 130-200 |
| temperature | | | |
| profile (° C.) | | | |
| Screw speed | 200 | 200 | 200 |
| (rpm) | | | |

A polyolefin composition comprising 90 wt % post-consumer polyethylene (PCR PE2), 5 wt % fully hydrogenated hydrocarbon tackifier resin (Eastotac™ H-142W), and 5 wt % Dowlex™ 2045G LLDPE carrier based on the weight of the polyolefin composition was obtained by manually dry blending with the previously described 50% masterbatch of Eastotac™ H-142W tackifier resin in virgin Dowlex™ 2045G linear low density polyethylene carrier (MFR of 1.0, 190° C., 2.16 kg). The blend was injection molded using a 90 ton Toyo Injection Molding machine at a 170-195° C. barrel temperature profile and a mold cavity temperature of 20° C.

### Examples 25-34 PCR PE Compositions Prepared Using Masterbatches

The polyolefin compositions in Examples 25-34 were prepared as in Example 24 and the compositions and properties are as shown in Tables 12 and 13. Reference Example 30 was also prepared as in Example 24 but without the addition of random alpha-olefinic copolymer or tackifier resin.

All examples show an increase in the MFR measured at 190° C., 2.16 kg. Analysis of the data and the composition showed that the LLDPE carrier, the random alpha-olefinic copolymer and tackifier resin all contributed to the increase in MFR; however, surprisingly, the increases were not linear in weight percent of each component.

Inventive Example 31, comprising 5 wt % each of Aerafin 17 and Eastotac H-142W, shows a surprising 289% increase in elongation compared to the original PCR in Reference Example 30, while a 104% increase in elongation was obtained with 5% Aerafin 17 in Comparative Example 28 and only a 49% increase in elongation was obtained with 5% resin Eastotac H-142W in Comparative Example 24.

Inventive Example 34, with addition of 5% Plastolyn R1140 resin to the composition of Comparative Example 29, shows a surprising 526% increase in elongation compared to the original unmodified PCR in Reference Example 30, while a 299% increase in elongation was obtained with 10% Aerafin 17 in Example 29 and only a 93% increase in elongation was obtained with 10% resin Plastolyn R1140 in Comparative Example 27.

Inventive Example 33, with addition of 10% Eastotac H-142W resin to the composition of Example 28, shows a surprising 589% increase in elongation compared to the original PCR in Reference Example 30, while a 104% increase in elongation was obtained with 5% Aerafin 17 in Example 28 and only a 130% increase in elongation was obtained with 10% resin Eastotac H-142W in Example 25. This increase in MFR and elongation resulted in a more advantageous balance of MFR and physical properties than was obtained using either tackifier resin alone or random alpha-olefinic copolymer alone.

Comparative Examples 24 through 27 illustrate that addition of only hydrogenated hydrocarbon resin in the LLDPE carrier resin results in as much as an 84% decrease in Notched Izod impact strength. These compositions contained as much as 20% LLDPE.

Although a Notched Izod impact value at room temperature could not be measured on dog bones of the carrier LLDPE due to its very high flexibility, it was surprisingly found that Examples 28-29 and Inventive Examples 31-34 comprising LLDPE levels as high as 45% of the polyolefin composition exhibited improved Notched Izod compared to the original PCR PE in Reference Example 30. The Notched Izod of examples containing only random alpha-olefinic polymer (Comparative Examples 28 and 29) were 45% and 142% higher than the original PCR, Reference Example 30, while the Inventive Examples 31-34 had Notched Izod values ranging from 38% to 159% higher than the original PCR.

Other polymers may similarly be incorporated into masterbatch compositions to improve the impact performance or other physical properties of the final composition.

TABLE 12
Comparative examples of PCR PE compositions prepared using
masterbatches

| | | | | | | | Ref. Ex. |
|---|---|---|---|---|---|---|---|
| | Comp. | Comp. | Comp. | Comp. | Comp. | Comp. | 30: PCR |
| | Ex. 24 | Ex. 25 | Ex. 26 | Ex. 27 | Ex. 28 | Ex. 29 | PE2 |
| PCR | 90 | 80 | 60 | 80 | 75 | 50 | 100 |
| PE2, wt % | | | | | | | |
| Eastotac ™ H- | 5 | 10 | 20 | — | — | — | — |
| 142W, wt % | | | | | | | |
| Plastolyn ™ R1 | — | — | — | 10 | — | — | — |
| 140, wt % | | | | | | | |
| Aerafin ™ 17, | — | — | — | — | 5 | 10 | — |
| wt % | | | | | | | |
| LLDPE | 5 | 10 | 20 | 10 | 20 | 40 | — |
| Carrier, wt % | | | | | | | |
| Properties | | | | | | | |
| MFR, g/10 min, | 0.5 | 0.5 | 0.9 | 1.0 | 0.9 | 1.3 | 0.3 |
| 190° C. | | | | | | | |
| Yield strength, | 21.8 | 20.0 | 17.9 | 21.6 | 18.7 | 14.9 | 23.9 |
| tensile, | | | | | | | |
| N/mm² | | | | | | | |
| Elongation at | 77.7 | 119.8 | 185.9 | 100.5 | 106.3 | 208.2 | 52.2 |
| break, tensile, | | | | | | | |
| % | | | | | | | |
| Notched Izod | 17.6 | 11.2 | 4.9 | 8.9 | 35.3 | 59.0 | 24.4 |
| impact | | | | | | | |
| strength, | | | | | | | |
| kJ/m² | | | | | | | |

TABLE 13
Inventive PE examples prepared using masterbatches

| | Reference | Inventive | | | |
|---|---|---|---|---|---|
| | Example 30: | Example | Inventive | Inventive | Inventive |
| | PCR PE2 | 31 | Example 32 | Example 33 | Example 34 |
| PCR PE2, wt % | 100 | 65 | 40 | 55 | 40 |
| Eastotac ™ H-142W, wt % | — | 5 | 5 | 10 | — |
| Plastolyn R1140, wt % | — | — | — | — | 5 |
| Aerafin TM 17, wt % | — | 5 | 10 | 5 | 10 |
| LLDPE Carrier, (MFR 1.0, | — | 25 | 45 | 30 | 45 |
| g/10 min, 190° C., 2.16 kg), | | | | | |
| wt % | | | | | |
| Properties | | | | | |
| MFR, g/10 min, 190° C. | 0.3 | 0.8 | 1.1 | 0.9 | 1.0 |
| Yield strength, tensile, N/mm² | 23.9 | 11.7 | 11.9 | 14.3 | 13.2 |
| Elongation, tensile, % | 52 | 203 | 351 | 359 | 326 |
| Notched Izod impact strength, | 24.4 | 33.7 | 60.4 | 46.1 | 63.2 |
| kJ/m² | | | | | |

### Example 35 Modification of Polypropylene-Rich Post-Consumer Polyolefin Via Masterbatch Preparation of PP Masterbatches Used in Examples 35 to 44

The masterbatches (MB) were compounded on a Werner & Pfleiderer twin-screw extruder with 40 mm diameter, 40/1 L/D at the screw temperature profile and screw speed listed in Table 14. Two raw material feeders for the random alpha-olefinic copolymers or tackifier resin and the carrier polymer were utilized in the main hopper during the masterbatch process.

TABLE 14
Compositions and processing conditions of PP masterbatches (MB)
used in Examples 35 to 44.

| | MB Eastotac ™ | MB Plastolyn ™ | |
|---|---|---|---|
| | H-142W | R1140 | MB Aerafin ™ 17 |
| | Pinnacle ™ 1112, | Pinnacle ™ 1112, | Pinnacle ™ 1112, 12 |
| Carrier | 12 MFR | 12 MFR | MFR |
| Carrier | PP | PP | PP |
| polymer | | | |
| type | | | |
| Carrier, | 50 | 50 | 80 |
| wt % | | | |
| Additive, | 50 | 50 | 20 |
| wt % | | | |
| Screw | 140-190 | 140-190 | 130-190 |
| temperature | | | |
| profile (° C.) | | | |
| Screw speed | 185 | 190 | 270 |
| (rpm) | | | |

A polyolefin composition comprising 80 wt % polypropylene-rich post-consumer polyolefin (PCR PP), 10 wt % fully hydrogenated hydrocarbon resin (Eastotac™ H-142W), and 10 wt % Pinnacle™ 1112 carrier (MFR 12 g/10 min, 230° C., 2.16 kg) based on the weight of the polyolefin composition was obtained by manually dry blending with the previously described 50% masterbatch of Eastotac™ H-142W fully hydrogenated hydrocarbon resin in virgin Pinnacle™ 1112 polypropylene carrier with an MFR of 12.0 (230° C., 2.16 kg). The blend was injection molded on a 90 ton Toyo Injection Molding machine at a 170-195° C. barrel temperature profile and a mold cavity temperature of 20° C.

### Examples 36-44 Modification of Polypropylene-Rich Post-Consumer Polyolefin Via Masterbatch

The polypropylene-rich polyolefin compositions in Examples 36 through 44 were prepared as in Example 35 and the compositions and properties are as shown in Tables 15 and 16. The Reference Example 39 PCR PP was prepared without the addition of random alpha-olefinic copolymer or tackifier resin.

TABLE 15
PP PCR compositions prepared using masterbatches

| | | | | | Reference |
|---|---|---|---|---|---|
| | | | | | Example |
| | Comparative | Comparative | Comparative | Comparative | 39: PCR |
| Description | Exampe 35 | Example 36 | Example 37 | Example 38 | PP |
| PCR PP, wt % | 80 | 85 | 80 | 60 | 100 |
| Eastotac ™ H- | — | — | — | — | — |
| 142W, wt % | | | | | |
| Plastolyn ™ R1140, wt % | — | 10 | 10 | 20 | — |
| Aerafin ™ 17, wt % | — | — | — | — | — |
| PP Carrier, wt % | 10 | 5 | 10 | 20 | — |
| Physical Properties | | | | | |
| MFR (g/10 min) | 27.0 | 23.6 | 29.2 | 32.1 | 20.5 |
| Ultimate Tensile (yield) | 28 | 27 | 28 | 29 | 27 |
| Strength, MPa | | | | | |
| Elongation at Break, % | 9 | 12 | 4 | 2 | 10 |
| Tensile Young's | 1649 | 1556 | 1816 | 2114 | 1415 |
| Modulus, MPa | | | | | |
| Flex Strength, MPa | 34 | 34 | 39 | 44 | 34 |
| Flex Modulus, MPa | 1182 | 1157 | 1399 | 1731 | 1116 |
| Notched Izod, MPa | 2.5 | 3.4 | 1.9 | 1.5 | 4.2 |

TABLE 16
PP PCR compositions prepared using masterbatches

| | | | Inventive | Inventive | |
|---|---|---|---|---|---|
| | Comparative | Comparative | Example | Example | Inventive |
| Description | Example 40 | Example 41 | 42 | 43 | Example 44 |
| PCR PP, wt % | 75 | 50 | 40 | 65 | 55 |
| Eastotae ™ H-142W, wt % | ?+0 | 5 | ?+0 | ?+0 | |
| Plastolyn ™ R1140, wt % | ?+0 | ?+0 | ?+0 | 5 | 10 |
| Aerafin ™ 17, wt % | 5 | 10 | 10 | 5 | 5 |
| vPP Carrier, wt % | 20 | 40 | 45 | 25 | 30 |
| Physical Properties | | | | | |
| MFR (g/10 min) | 20.6 | 20.5 | 21.2 | 27.0 | 32.6 |
| Ultimate Tensile (yield) | 27 | 27 | 26 | 27 | 26 |
| Strength, MPa | | | | | |
| Elongation at Break, % | 17 | 21 | 26 | 14 | 6 |
| Tensile Young's Modulus, | 1328 | 1327 | 1279 | 1473 | 1621 |
| MPa | | | | | |
| Flex Strength, MPa | 33 | 34 | 32 | 47 | 49 |
| Flex Modulus, MPa | 1083 | 1132 | 1081 | 2059 | 2273 |
| Notched Izod, MPa | 4.6 | 4.3 | 3.4 | 3.3 | 2.1 |

Inventive Example 43 shows that addition of 5% Plastolyn R1140 resin to the composition of Comparative Example 38 results in MFR 31% higher than the unmodified PP PCR (Reference Example 39), which is twice the percent improvement obtained from the addition of 5% Plastolyn R1140 alone in Comparative Example 36. This inventive example also exhibited an unexpected increase of flex strength (39%) and flex modulus (84%) above the values the unmodified PP PCR; the values were also greater than those of Comparative Example 38 containing only the 5% Aerafin 17 APO.

Inventive Example 44 combines 10% Plastolyn R1140 resin with 5% Aerafin 17 APO, resulting in even greater increases in MFR (58%), flex strength (45%), and flex modulus (104%) above the values of the unmodified PP PCR. Surprisingly, the Young's modulus also increased (15%) above the value of the unmodified PP PCR (Reference Example 39) and Comparative Example 38. The surprisingly improved properties of Inventive Examples 43 and 44 resulted in a more advantageous balance of MFR and physical properties than was obtained using either tackifier resin alone or random alpha-olefinic copolymer alone.

Inventive Example 42 containing 5% Eastotac H-142W resin and 10% Aerafin 17 APO exhibited an MFR greater than Comparative Example 41 containing only 10% Aerafin 17 APO. Additionally, this Inventive Example surprisingly had elongation at break 152% greater than the unmodified PCR PP while maintaining the other physical properties. The elongation of this Inventive Example was also greater than Comparative Examples 41 and 35 with equivalent amounts of either random alpha-olefinic copolymer only or tackifier resin only, respectively.

### Examples 45-51 PCR PE Compositions Prepared by Direct Addition

The dry blend samples without masterbatch were fully compounded on a Leistritz twin screw extruder with 18 mm diameter, 40/1 L/D at the screw temperature profile and screw speed listed in Table 17. One raw material feeder for the dry blended mixture of random alpha-olefinic copolymers and/or tackifier resin and the PCR PE3 were utilized in the main hopper during the full compound process.

Test specimens were prepared by injection molding on a 90-ton Toyo Injection Molding machine at a 170-195° C. barrel temperature profile, 32 mm screw diameter, and a mold cavity temperature of 20° C.

TABLE 17
Compositions, processing conditions and properties of full
compounds produced by direct addition.

| | Ref. Ex. | | | | | | |
|---|---|---|---|---|---|---|---|
| | 45: PCR | Comp. | Inv. | Comp. | Inv. | Comp. | Inv. |
| | PE3 | Ex. 46 | Ex. 47 | Ex. 48 | Ex. 49 | Ex. 50 | Ex. 51 |
| PCR | 100 | 90 | 85 | 90 | 85 | 90 | 85 |
| PE3, wt % | | | | | | | |
| Eastotac ™ H- | — | — | 5 | — | 5 | — | 5 |
| 142W, wt % | | | | | | | |
| Aerafin ™ 17, wt | — | 10 | 10 | — | — | — | — |
| % | | | | | | | |
| Aerafin ™ 180, | — | — | — | 10 | 10 | — | — |
| wt % | | | | | | | |
| Aerafin ™ 35, wt | — | — | — | — | — | 10 | 10 |
| % | | | | | | | |
| Processing | | | | | | | |
| conditions | | | | | | | |
| Screw | 140-200 | 140-200 | 140-200 | 140-200 | 140-200 | 140-200 | 140-200 |
| temperature | | | | | | | |
| profile (° C.) | | | | | | | |
| Screw speed | 300 | 300 | 300 | 300 | 300 | 300 | 300 |
| (rpm) | | | | | | | |
| Properties | | | | | | | |
| MFR (g/10 min, | 0.35 | 0.52 | 0.58 | 0.61 | 0.75 | 0.56 | 0.57 |
| 2.16 kg) 190° C. | | | | | | | |
| Ultimate | 22 | 19 | 18 | 19 | 17 | 19 | 19 |
| Tensile | | | | | | | |
| Strength, MPa | | | | | | | |
| Elongation at | 99 | 118 | 168 | 103 | 140 | 121 | 127 |
| Break, % | | | | | | | |

Examples 45-51 increase the compound MFR by 49%-114% above that of Example 45 and increase the compound elongation at break 4%-70% above the elongation of the unmodified Reference Example 45. Surprisingly, Inventive Examples 47, 49 and 51 comprising both tackifier resin and amorphous poly-alpha-olefin significantly increased the elongation at break above the elongation obtained when only amorphous poly-alpha-olefin was added to the unmodified PCR PE3, e.g Example 47 exhibited an elongation 70% greater than the unmodified PCR PE compared to the 19% increase in elongation obtained in Comparative Example 46, and Inventive Example 49 had an elongation 41% greater than the unmodified PCR PE3 compared to the 4% greater elongation of Comparative Example 48. The unexpected interaction between tackifier resin, random alpha-olefinic copolymers and PCR both improves the rheological properties (flow) of the PCR and provides the ability to balance the physical properties of the polyolefin composition to the needs of a targeted application.

It was surprisingly noticed that the testing standard deviations for the modified PCR samples were significantly lower than the testing standard deviations of the unmodified PCR samples. The significant reduction in testing variation indicates that the modified PCR polyolefin composition has a more consistent composition and quality than the unmodified PCR.

TABLE 18

| | Standard | Average |
|---|---|---|
| | deviation | Standard |
| | for Reference | Deviation for |
| | Example 45 | Examples |
| Property: | PCR PE3 | 45-51 |
| MFR at 190° C. (g/10 min) | 0.01 | 0.03 |
| Ultimate Tensile Strength, MPa | 0.17 | 0.15 |
| Elongation at Break, % | 43 | 33 |
| Tensile Young's Modulus, MPa | 24 | 17 |
| Flex Strength, MPa | 0.3 | 0.06 |
| Flex Modulus, MPa | 12 | 2 |
| Notched Izod, KJ/m2 | 4 | 0.5 |
| Notched Izod, −20° C., KJ/m2 | 2 | 0.3 |

Additional materials used in the following Examples are as listed in Table 19 below. Test methods used are found in Table 2.

TABLE 19

| Material | Description |
|---|---|
| Elite ™ 5940ST | medium density fractional melt C8 enhanced |
| | polyethylene resin (MDPE), MFR 0.8 g/10 min |
| Enable ™ 4009MC | medium density fractional melt ethylene 1-hexene |
| Blown | copolymer, MFR 0.9 g/10 min |
| Eltex ™ HD3930UA | linear medium density polyethylene grade, MFR |
| | 3.0 g/10 min |
| EMAC ™ SP2202 | medium viscosity ethylene acrylate copolymer, |
| | 21 wt % methyl acrylate, MFR 0.45 g/10 min |
| EMAC ™ SP2205 | medium viscosity ethylene acrylate copolymer, |
| | 20 wt % methyl acrylate, MFR 2.0 g/10 min |

### Examples 52-56 Modification of Visbroken rHDPE with MB Containing Random Alpha-Olefin and Either Ethylene-1-Octene or Ethylene-1-Hexene MDPE Polyolefin Polymers

Two masterbatches were produced on a Leistritz twin screw extruder at a 135-165° C. screw temperature profile and a screw speed of 150 rpm after manual dry blending of the components.

Masterbatch MB1 was made with 50 wt % Elite™ 5940ST from DOW, a medium density fractional melt C8 enhanced polyethylene resin (MDPE), and 50 wt % Aerafin™ 180, a propylene-ethylene amorphous random copolymer.

Masterbatch MB2 was made with 50 wt % Enable™ 4009MC Blown from Exxon Mobile, a medium density fractional melt ethylene 1-hexene copolymer, and 50 wt % Aerafin™ 180, a propylene-ethylene amorphous random copolymer.

TABLE 20
MB compositions used in Examples 53-56

| | MB1 | MB2 |
|---|---|---|
| Elite ™ 5940ST | 50 wt % | — |
| Enable ™ 4009MC Blown | — | 50 wt % |
| Aerafin ™ 180 | 50 wt % | 50 wt % |

Both MB1 and MB2 were used to modify a recycled polyethylene-rich HDPE stream (PCR PE) that had a reduced impact strength due to exposure to a viscosity breaking (visbreak) process, which induced chain scission in the presence of a radical initiator and exposure to elevated temperatures, e.g. above 320° C. This process reduced the Charpy notched impact strength of the Visbroken recycled HDPE (Reference Example 52) from 35.8 kJ/m² to 4.1 kJ/m² (ISO 179-1).

A Collin ZK25P twin screw extruder at a 145-170° C. screw temperature profile and screw speed of 200 rpm was used to compound 10 wt % or 20 wt % of MB1 or MB2 in the described Visbroken recycled HDPE. The resulting polyolefin compositions were used to make injection molded test bars to evaluate MFR, tensile properties and notched impact strength. Tables 21 and 22 below list the compositions and measured properties.

TABLE 21
Compositions in wt % Example 52-56

| | Reference | | | | |
|---|---|---|---|---|---|
| | Example | | | | |
| | 52: | Inventive | Inventive | Inventive | Inventive |
| | visbroken | example | example | example | example |
| | PCR PE | 53 | 54 | 55 | 56 |
| PCR PE, | 100 | 90 | 80 | 90 | 80 |
| visbroken | | | | | |
| (r-HDPE) | | | | | |
| Elite 5940ST | — | 5 | 10 | — | — |
| (MB1) | | | | | |
| Enable 4009Mc | — | — | — | 5 | 10 |
| Blown (MB2) | | | | | |
| Aerafin 180 | — | 5 | 10 | 5 | 10 |

TABLE 22
Measured properties of compositions Examples 52-56

| | Reference | | | | |
|---|---|---|---|---|---|
| | Example | | | | |
| | 52: | Inventive | Inventive | Inventive | Inventive |
| | visbroken | example | example | example | example |
| Property | PCR PE | 53 | 54 | 55 | 56 |
| MFR at | 4.1 | 4.7 | 5.8 | 5.1 | 6.2 |
| 190° C., | | | | | |
| 2,16kg | | | | | |
| [g/10 min] | | | | | |
| E-modulus | 716 | 598 | 508 | 598 | 506 |
| [MPa] | | | | | |
| Yield | 19.5 | 17.2 | 15.4 | 17.2 | 15.2 |
| strength | | | | | |
| [MPa] | | | | | |
| Elongation | 11.3 | 13.0 | 14.0 | 13.1 | 14.6 |
| at yield | | | | | |
| strength [%] | | | | | |
| Notched | 4.2 | 5.5 | 7.9 | 5.9 | 8.1 |
| Charpy | | | | | |
| impact | | | | | |
| strength | | | | | |
| [kJ/m²] | | | | | |

Inventive Examples 53-56 show a 30% to 90% increase of the notched Charpy impact strength compared to the unmodified reference and simultaneously the inventive examples 53-56 show a 25% to 50% increase in MFR, both caused by the combination of the fractional melt MDPE and the low viscous amorphous polyolefin.

### Examples 57-63 Modification of Visbroken r-HDPE with Random Alpha-Olefin and MDPE Via Direct Dosing

Eltex™ HD3930UA, a linear medium density polyethylene grade from Ineos Olefins & Polymers (Rolle, Switzerland), was used in combination with Aerafin™ 180, a propylene-ethylene amorphous random copolymer from Eastman Chemical, Kingsport, Tenn., USA to modify a recycled HDPE stream that had a reduced impact strength due to exposure to a viscosity breaking (visbreak) process, which induced chain scission in the presence of a radical initiator and exposure to elevated temperatures, e.g. above 320° C. This process reduced the Charpy notched impact strength of the Visbroken recycled HDPE from 35.8 kJ/m² to 4.1 kJ/m² (ISO 179-1).

A Collin ZK25P twin screw extruder at a 145-170° C. screw temperature profile and screw speed of 200 rpm was used to compound 20 wt %, 40 wt % or 60 wt % of Eltex HD3930UA solely or in combination with 5 wt % Aerafin 180 in the described Visbroken recycled HDPE. The Aerafin 180 was dry blended with the Visbroken recycled HDPE and added to the main hopper, the Eltex HD3930UA was added using a second feed hopper, both dosing at the inlet section of the compounder. The resulting polyolefin compositions were used to make injection molded test bars to evaluate MFR, tensile properties and notched impact strength. Tables 23 and 24 below list the blend compositions and measured properties.

TABLE 23
Blend compositions in wt % example 57-63

| | Ref. Ex. | Comp. | Comp. | Comp. | Comp. | Inv. Ex. | Inv. Ex. | Inv. Ex. |
|---|---|---|---|---|---|---|---|---|
| | 52 | Ex. 57 | Ex. 58 | Ex. 59 | Ex. 60 | 61 | 62 | 63 |
| PCR PE, | 100 | 80 | 60 | 40 | 95 | 75 | 55 | 35 |
| visbroken | | | | | | | | |
| (r-HDPE) | | | | | | | | |
| Eltex ™ | — | 20 | 40 | 60 | — | 20 | 40 | 60 |
| HD3930UA | | | | | | | | |
| Aerafin 180 | — | — | — | — | 5 | 5 | 5 | 5 |

TABLE 24
Measured properties for compositions Examples 57-63, using
methods in Table 23.

| | Ref. Ex. | Comp. | Comp. | Comp. | Comp. | Inv. Ex. | Inv. Ex. | Inv. Ex. |
|---|---|---|---|---|---|---|---|---|
| Property | 52 | Ex. 57 | Ex. 58 | Ex. 59 | Ex. 60 | 61 | 62 | 63 |
| MFR at | 4.1 | 3.6 | 3.3 | 3.1 | 4.6 | 4.1 | 3.5 | 3.2 |
| 190° C., | | | | | | | | |
| 2.16 kg | | | | | | | | |
| [g/10 min] | | | | | | | | |
| E-modulus | 716 | 690 | 656 | 615 | 602 | 541 | 558 | 538 |
| [MPa] | | | | | | | | |
| Yield | 19.5 | 18.8 | 18.0 | 17.2 | 17.4 | 16.2 | 16.6 | 15.9 |
| strength | | | | | | | | |
| [MPa] | | | | | | | | |
| Elongation | 11.3 | 11.4 | 11.6 | 11.8 | 12.7 | 13.3 | 12.4 | 12.6 |
| at yield | | | | | | | | |
| strength | | | | | | | | |
| [%] | | | | | | | | |
| Notched | 4.2 | 6.4 | 9.3 | 13.2 | 5.2 | 8.2 | 10.7 | 15.4 |
| Charpy | | | | | | | | |
| impact | | | | | | | | |
| strength | | | | | | | | |
| [kJ/m²] | | | | | | | | |

Table 24 shows that the inclusion of the additional polymer decreased the MFR of the recycled polyolefin composition by 12%-24% comparative examples 57-59 while improving notched impact strength and maintaining elongation. Inventive examples 61-63 show an unexpected greater improvement in impact performance based on the properties of the additional MDPE polymer and the random alpha-olefinic copolymer and a reduced MFR drop by addition of the lower MFR MDPE (e.g. Inventive Example 61 compared to comparative example 57). Inventive example 62 Notched Charpy impact strength is 15% higher compared to comparative example 58. In particular, the inventors were surprised to note that Inventive Example 61 comprising both the additional polymer and the random alpha-olefinic copolymer has MFR equal to the unmodified Reference Example 52 Visbroken r-HDPE PCR PE (14% higher than Comparative Example 57 with only the additional polymer), elongation at yield 17% higher than Comparative Example 57, and Notched Charpy impact strength 28% higher than Comparative Example 57.

### Examples 64-67 Modification of Visbroken PCR PE with Random Alpha-Olefin and Ethylene-Acrylate Copolymers Via Masterbatch

A first masterbatch (MB3) was made with 50 wt % EMAC™ SP2202 from Westlake Chemicals, Houston, Tex., USA, a medium viscosity ethylene acrylate copolymer, and 50 wt % Aerafin™ 180, a propylene-ethylene amorphous random copolymer (Eastman). This MB was produced on a 26 mm twin screw extruder manufactured by Coperion at the processing temperature of 80-190° C. and 150 screw rpm. Two separate feeders were used to accurately control the feed rate of EMAC™ SP2202 and Aerafin™ 180, and those materials fed through the main hopper. The total output obtained was 9 kgs/hr.

A second masterbatch (MB4) was made by the same process with 50 wt % EMAC™ SP2205 from Westlake Chemicals, a medium viscosity ethylene acrylate copolymer, and 50 wt % Aerafin™ 180.

TABLE 25
Masterbatch 3 and Masterbatch 4 compositions

| | MB3 | M B4 |
|---|---|---|
| EMAC SP2202 | 50 wt % | |
| EMAC SP2205 | | 50 wt % |
| Aerafin 180 | 50 wt % | 50 wt % |

MB3 and MB4 were used individually to modify a recycled post-consumer HDPE stream (PCR PE) that had a reduced impact strength due to exposure to a viscosity breaking (visbreak) process that induced chain scission in the presence of a radical initiator and exposure to elevated temperatures, e.g., above 320° C. This process reduced the notched impact strength from 35.8 kJ/m² to 4.1 kJ/m² (ISO 179-1).

A Collin ZK25P twin screw extruder at a 145-170° C. screw temperature profile and screw speed of 200 rpm was used to compound 10 or 20 wt % of MB3 or MB4 in the visbroken recycled HDPE. The compound was used to make injection molded test bars to evaluate MFR, tensile properties and notched impact strength. Table 26 lists the blend compositions. Table 27 lists the measured properties of the prepared polyolefin compositions.

TABLE 26
Blend compositions of Examples 64-67

| | | Inventive | | Inventive | Inventive |
|---|---|---|---|---|---|
| | Reference | Example | Inventive | Example | Example |
| | Example 52 | 64 | Example 65 | 66 | 67 |
| PCR PE, visbroken | 100 wt % | 90 wt % | 80 wt % | 90 wt % | 80 wt % |
| (r-HDPE) | | | | | |
| MB3 EMAC SP2202/ | | 10 wt % | 20 wt % | | |
| Aerafin A180 | | | | | |
| MB4 EMAC SP2205/ | | | | 10 wt % | 20 wt % |
| Aerafin 180 | | | | | |

TABLE 27
Measured properties compositions examples 64-67

| | Reference | | | | |
|---|---|---|---|---|---|
| | Example | | | | |
| | 52: | Inventive | Inventive | Inventive | Inventive |
| | visbroken | Example | Example | Example | Example |
| Property | PCR PE | 64 | 65 | 66 | 67 |
| MFR at | 4.1 | 4.7 | 5.8 | 5.1 | 6.2 |
| 190° C., | | | | | |
| 2.16kg | | | | | |
| [g/10 min] | | | | | |
| E-modulus | 716 | 569 | 464 | 558 | 454 |
| [MPa] | | | | | |
| Yield strength | | | | | |
| [MPa] | 19.5 | 16.2 | 14.2 | 16.2 | 14.1 |
| Elongation | 11.3 | 13.6 | 15.1 | 13.4 | 15.0 |
| at yield | | | | | |
| strength [%] | | | | | |
| Notched | 4.2 | 7.4 | 13.0 | 7.1 | 13.3 |
| impact | | | | | |
| strength | | | | | |
| [kJ/m²] | | | | | |

As can be seen in Table 27 the inventive compositions containing both an ethylene-acrylate copolymer and a random alpha-olefinic copolymer (Inventive Examples 64-67) surprisingly all show a simultaneous increase in MFR and notched impact strength. Inventive Example 56 shows a 51% increase in MFR with a surprising 216% increase in notched impact strength compared to the Reference Example 52 unmodified visbroken r-HDPE (PCR PE). Additionally, the Inventive Examples also show an unexpected 20% to 34% increase in the elongation at yield compared to Reference Example 52.

TABLE 28
Materials examples 68-76

| Material | Description |
|---|---|
| r-HDPE (as is) PCR | homogenized high density polyethylene regranulate (rHDPE), 100% |
| PE4 | post-consumer recyclate source, without UV Stabilizer and >98% |
| | polyethylene*, higher notched Charpy impact strength than PCR |
| | PE3, MFR ~0.3 g/10 min |
| Aerafin ™ 180 | Amorphous poly-(alpha-)olefin, Softening Point 120° C. |
| Eastoflex ™ E1060PL | Amorphous poly-(alpha-)olefin, Softening Point 135° C. |
| EMAC ™ SP2202 | high viscosity (0.45 MFR at 190° C., 2.16 kg) 21.5% ethylene methyl |
| | acrylate (EMA) copolymer |
| EMAC ™ SP2205 | medium viscosity (0.45 MFR at 190° C., 2.16 kg) 20% ethylene |
| | methyl acrylate copolymer |

*PCR PE4 contains a small percentage of polypropylene (<0.5%), CaCO3 (<1.5%), and inorganic pigment (<0.5%), but also traces of other polymers (<0.03% of polyvinyl chloride, poly-ethylene terephthalate, polycarbonate, polystyrene, acrylonitrile-butadiene-styrene, polyamide, polyurethane)

All test methods were as described in Table 10. Ultimate Tensile Strength: for all compositions was equal to the Yield strength as none of the samples showed strain hardening after necking.

### Examples 68-76: Modification of r-HDPE with Random Alpha-Olefinic Copolymer and Ethylene Acrylate Copolymer

A first masterbatch (MB5) was made with 50 wt % EMAC™ SP2202 from Westlake Chemicals, Houston, Tex., USA, a high viscosity (0.45 MFR at 190° C., 2.16 kg) ethylene acrylate copolymer, and 50 wt % Aerafin™ 180, a propylene-ethylene amorphous random copolymer (Eastman). This MB was produced on a 26 mm twin screw extruder manufactured by Coperion at the processing temperature of 80-190° C. and 150 screw rpm. Two separate feeders were used to accurately control the feed rate of EMAC™ SP2202 and Aerafin™ 180, and those materials fed through the main hopper. The total output obtained was 9 kgs/hr.

A second masterbatch (MB6) was made by the same process with 50 wt % EMAC™ SP2205 from Westlake Chemicals, a medium viscosity (0.45 MFR at 190° C., 2.16 kg) ethylene acrylate copolymer, and 50 wt % Aerafin™ 180.

A third masterbatch (MB7) was made by the same process with 50 wt % EMAC™ SP2205 from Westlake Chemicals, a medium viscosity (0.45 MFR at 190° C., 2.16 kg) ethylene acrylate copolymer, and 50 wt % Eastoflex™ E1060PL, a propylene-ethylene amorphous random copolymer (Eastman).

TABLE 29
Masterbatch 3, 4 and 5 compositions

| | MB5 | MB6 | M B7 |
|---|---|---|---|
| EMAC ™ SP2202 | 50 wt % | — | — |
| EMAC ™ SP2205 | — | 50 wt% | 50 wt % |
| Aerafin ™ 180 | 50 wt % | 50 wt% | — |
| Eastoflex ™ | — | — | 50 wt % |
| E1060PL | | | |

MB5, MB6 and MB7 were used individually to modify a recycled 0.3 MFR r-HDPE stream (PCR PE4). No compounding was used, all materials were dry blended according to the compositions in Table 30, and used to produce injection molded test bars by means of a 90-ton Toyo injection molding machine at a 170-182° C. barrel temperature profile and a mold temperature of 27° C. The test bars were used to evaluate MFR, tensile properties and notched impact strength. Table 4 lists the measured properties of the compositions.

TABLE 30
Blend compositions of Examples 68-76

| | Ref. | Inv. | Inv. | Inv. | Inv. | Inv. | Inv. Ex. | Comp. | Comp. |
|---|---|---|---|---|---|---|---|---|---|
| | Ex. 68 | Ex. 69 | Ex. 70 | Ex. 71 | Ex. 72 | Ex. 73 | 74 | Ex. 75 | Ex. 76 |
| r-HDPE | 100 wt % | 90 wt % | 80 wt % | 90 wt % | 80 wt % | 90 wt % | 80 wt % | 90 wt % | 90 wt % |
| (as is) | | | | | | | | | |
| PCR PE4 | | | | | | | | | |
| 0.3 MFR | | | | | | | | | |
| MB5 | — | 10 wt % | 20 wt % | — | — | — | — | — | — |
| EMAC | | | | | | | | | |
| SP2202/ | | | | | | | | | |
| Aerafin | | | | | | | | | |
| A180 | | | | | | | | | |
| MB6 | — | — | — | 10 wt % | 20 wt % | — | — | — | — |
| EMAC | | | | | | | | | |
| SP2205/ | | | | | | | | | |
| Aerafin | | | | | | | | | |
| 180 | | | | | | | | | |
| MB7 | — | — | — | — | — | 10 wt % | 20 wt % | — | — |
| EMAC | | | | | | | | | |
| SP2205/ | | | | | | | | | |
| Eastoflex | | | | | | | | | |
| 1060PL | | | | | | | | | |
| Aerafin | — | — | — | — | — | — | — | 10 wt % | — |
| 180 | | | | | | | | | |
| Eastoflex | — | — | — | — | — | — | — | — | 10 wt % |
| 1060PL | | | | | | | | | |

TABLE 30
Measured properties compositions examples 68-76

| | Ref. Ex. | Inv. Ex. | Inv. Ex. | Inv. Ex. | Inv. Ex. | Inv. Ex. | Inv. Ex. | Comp. Ex. | Comp. Ex. |
|---|---|---|---|---|---|---|---|---|---|
| | 68 | 69 | 70 | 71 | 72 | 73 | 74 | 75 | 76 |
| MFR | 0.35 | 0.53 | 0.67 | 0.54 | 0.78 | 0.49 | 0.66 | 0.67 | 0.67 |
| (190° C., | | | | | | | | | |
| 2.16 kg) | | | | | | | | | |
| [g/10 min] | | | | | | | | | |
| SD 0.01 | | | | | | | | | |
| Ultimate | 20.6 | 18.3 | 15.7 | 17.6 | 15.3 | 19.0 | 16.5 | 17.7 | 17.9 |
| Tensile | | | | | | | | | |
| Strength | | | | | | | | | |
| [MPa] | | | | | | | | | |
| SD 0.3 | | | | | | | | | |
| Elongation | 89 | 110 | 254 | 205 | 307 | 83 | 117 | 111 | 154 |
| at | | | | | | | | | |
| Break [%] | | | | | | | | | |
| SD 32 | | | | | | | | | |
| Tensile | 904 | 752 | 599 | 741 | 580 | 740 | 640 | 697 | 666 |
| Young's | | | | | | | | | |
| Modulus | | | | | | | | | |
| [MPa] | | | | | | | | | |
| SD 23 | | | | | | | | | |
| Flexural | 17.6 | 14.8 | 12.5 | 14.6 | 12.3 | 15.7 | 13.2 | 14.4 | 14.7 |
| Strength | | | | | | | | | |
| [MPa] | | | | | | | | | |
| SD 0.1 | | | | | | | | | |
| Flexural | 502 | 402 | 310 | 393 | 303 | 429 | 330 | 387 | 392 |
| Modulus | | | | | | | | | |
| [MPa] | | | | | | | | | |
| SD 6 | | | | | | | | | |
| Notched | 18H* | 30P* | 42P* | 21P* | 30P* | 23P* | 28P* | 20P* | 29P* |
| Izod | | | | | | | | | |
| impact | | | | | | | | | |
| strength | | | | | | | | | |
| [kJ/m²] | | | | | | | | | |
| SD 1 | | | | | | | | | |
| Notched | 4.1 | 4.6 | 4.1 | 4.2 | 4.7 | 4.4 | 3.6 | 3.9 | 5.3 |
| Izod | | | | | | | | | |
| impact | | | | | | | | | |
| strength | | | | | | | | | |
| at | | | | | | | | | |
| −20° C. | | | | | | | | | |
| [kJ/m²] | | | | | | | | | |
| SD 0.3 | | | | | | | | | |

*Failure mode is hinge (H) or partial break (P). Average Standard deviations for the measured modified samples are indicated by SD.

Table 30 shows that the inventive polyolefin compositions comprising both an ethylene-acrylate copolymer and a random alpha-olefinic copolymer (Inventive Examples 69-74) all have a simultaneous increase in MFR and in notched impact strength. Inventive Example 70 shows a 91% increase in MFR and a 128% increase in notched impact strength compared to the original unmodified r-HDPE (PCR PE1), Reference Example 68. Additionally, the inventive compositions also show an unexpected increase in the elongation at break of up to 246% in Inventive Example 72

The ethylene-acrylate copolymer used had surprisingly different effects on the balance of properties in the polyolefin composition depending on the specific ethylene-acrylate copolymer, the specific random alpha-olefinic copolymer, and the loading level of the additives. Inventive Examples 69-73 show equivalent or improved MFR, Notched Izod impact performance at room temperature and Notched Izod impact performance at −20° C. compared to the starting PCR PE1, with the percent improvement being as large as about 121% for MFR (example 72), about 128% for RT Notched Izod (Inventive Example 10) and about 13% for −20° C. notched Izod (Inventive Example 72). Inventive Examples 69-72 and 74 also show increased elongation at break compared to the starting PCR PE1 in Reference Example 68, as much as about 246% greater (example 72) than the starting PCR PE1.

Unexpectedly the inventors noted that changing the specific additive combination in the polyolefin composition, ethylene-acrylate copolymer/specific random alpha-olefinic copolymer, could increase the polyolefin composition elongation at break by about 100% (double) at the same total dosing level (Inventive Example 69 vs. Inventive Example 73) or by about 100-200% (Inventive Example 74 vs. Inventive Examples 70 and 72) when the ethylene-acrylate copolymer and random alpha-olefinic copolymer were advantageously paired.

Comparison of Comparative Example 75 to Inventive Example 71 surprisingly showed an 84% increase in elongation at break when EMAC 2205 was combined with Aerafin 180 and the total additive level in PCR was maintained at 10%. Additionally, the MFR and Notched Izod impact were improved over the unmodified PCR and a good balance of physical properties was obtained.

Previous Examples included examples of polyolefin compositions comprising recycled polyolefin, random alpha-olefinic copolymer and at least one additional polymer, with and without tackifier resin. Examination of the examples comprising recycled polyolefin, random alpha-olefinic copolymer and at least one additional polymer and without tackifier resin surprisingly showed improvements in MFR for PCR PE combined with an advantageous balance of properties where tensile modulus, yield strength, elongation at break and/or Notched Izod were acceptable and/or improved, and when the recycled polyolefin was PCR PP the polyolefin composition showed a surprising increase in elongation in break combined with an advantageous balance of properties and/or acceptable mechanical properties.

As previously defined, mechanical properties are “acceptable” if at least one mechanical property of the polyolefin composition or any article comprising the polyolefin composition is from about 66% to about 600% or from about 80% to about 600% of the same mechanical property of the same polyolefin composition without the random alpha-olefinic copolymer and additional polymer. Various end-use applications for the polyolefin compositions can require a different balance of mechanical properties where values for some properties can be outside of this “acceptable” range and the composition is fit-for-use in the application.

Examples 1-3 illustrate that the addition of 2 to 5 wt % each random alpha-olefinic copolymer and at least one additional polymer (1:1 ratio) (total addition level of 4 wt % to 10 wt %) in PCR PE can increase MFR (g/10 min, 190° C., 21.6 kg) by about 3.5% to about 45.5% compared to the unmodified PCR PE in Reference Example 1. The additional polymer was LDPE Carrier 1 (MFR 22). The wt % is based on the total polyolefin composition.

Additional materials used in the following Examples are as listed in Table 31 below. Test methods used are found in Table 10.

TABLE 31

| Material | Description |
|---|---|
| Engage ™ 8107 | Ethylene octene copolymer, MFR 0.8 g/10 min, |
| | 2.16 kg at 190° C., Dow |

### Examples 77-85—Modification of PCR PE with Random Alpha-Olefinic Copolymer and Additional Polymer

The samples were fully compounded on a Leistritz twin screw extruder with 18 mm diameter, 40/1 L/D at screw speed of 300 rpm and the screw temperature profile listed in Table 32. Test specimens were prepared by injection molding on a 90-ton Toyo Injection Molding machine at a 170-195° C. barrel temperature profile, 32 mm screw diameter, and a mold cavity temperature of 20° C.

TABLE 32
Compositions of Examples 77-85

| | Ref. | Comp. | Comp. | Inv. | Inv. | Inv. | Inv. | Inv. | Inv. | Inv. |
|---|---|---|---|---|---|---|---|---|---|---|
| | Ex. 68 | Ex. 77 | Ex. 78 | Ex. 79 | Ex. 80 | Ex. 81 | Ex. 82 | Ex. 83 | Ex. 84 | Ex. 85 |
| r-HDPE | 100 wt % | 90 wt % | 90 wt % | 90 wt % | 80 wt % | 80 wt % | 80 wt % | 90 wt % | 85 wt % | 85 wt % |
| (as is) | | | | | | | | | | |
| PCR | | | | | | | | | | |
| PE4 0.3 | | | | | | | | | | |
| MFR | | | | | | | | | | |
| Eastoflex ™ | — | 10 wt % | — | 5 wt % | 10 wt % | 7 wt % | 13 wt % | 5 wt % | 5 wt % | 5 wt % |
| 1060PL | | | | | | | | | | |
| Engage ™ | — | — | 10 wt % | 5 wt % | 10 wt % | 13 wt % | 7 wt % | — | 5 wt % | — |
| 8107 | | | | | | | | | | |
| EMAC ™ | — | — | — | — | — | — | — | 5 wt % | — | 5 wt % |
| SP2202 | | | | | | | | | | |
| Eastotac ™ H- | — | — | — | — | — | — | — | — | 5 wt % | 5 wt % |
| 142W | | | | | | | | | | |
| Screw | | 170- | 170- | 170- | 170- | 170- | 170- | 170- | 170- | 170- |
| temperature | | 210° C. | 210° C. | 210° C. | 210° C. | 210° C. | 200° C. | 200° C. | 200° C. | 200° C. |
| profile | | | | | | | | | | |
| (° C.) | | | | | | | | | | |

TABLE 33
Properties of Examples 77-85

| | Ref. | Comp. | Comp. | Inv. | Inv. | Inv. | Inv. | Inv. | Inv. | Inv. |
|---|---|---|---|---|---|---|---|---|---|---|
| | Ex. 68 | Ex. 77 | Ex. 78 | Ex. 79 | Ex. 80 | Ex. 81 | Ex. 82 | Ex. 83 | Ex. 84 | Ex. 85 |
| MFR at | 0.35 | 0.62 | 0.48 | 0.53 | 0.74 | 0.68 | 0.75 | 0.51 | 0.70 | 0.65 |
| 190° C. | | | | | | | | | | |
| (g/10 min) | | | | | | | | | | |
| Ultimate | 20.6 | 17.5 | 17.3 | 17.4 | 14.0 | 13.8 | 14.6 | 17.2 | 15.4 | 15.9 |
| Tensile | | | | | | | | | | |
| Strength, | | | | | | | | | | |
| MPa | | | | | | | | | | |
| Elongation | 89 | 184 | 209 | 164 | 394 | >400** | 326 | 157 | 307 | 229 |
| at | | | | | | | | | | |
| Break, % | | | | | | | | | | |
| Tensile | 904 | 691 | 672 | 689 | 548 | 524 | 568 | 701 | 610 | 636 |
| Young's | | | | | | | | | | |
| Modulus, | | | | | | | | | | |
| MPa | | | | | | | | | | |
| Flexural | 17.6 | 14.0 | 14.1 | 13.8 | 11.0 | 10.7 | 11.3 | 14.3 | 11.8 | 12.2 |
| Strength, | | | | | | | | | | |
| MPa | | | | | | | | | | |
| Flexural | 502 | 349 | 360 | 360 | 276 | 275 | 289 | 370 | 308 | 304 |
| Modulus, | | | | | | | | | | |
| MPa | | | | | | | | | | |
| Notched | 19P* | 19P* | 37N* | 27P* | 43N* | 46N* | 37N* | 23P* | 30P* | 22P* |
| Izod, | | | | | | | | | | |
| KJ/m2 | | | | | | | | | | |
| Notched | 4.1 | 3.7 | 6.3 | 5.2 | 6.1 | 8.3 | 4.9 | 3.9 | 2.8 | 2.1 |
| Izod, | | | | | | | | | | |
| −20° C., | | | | | | | | | | |
| KJ/m2 | | | | | | | | | | |

*Notched Izod impact failure mode partial break (P) or non-breaking (N).
**instrument maximum is 400%

Table 33 shows that the inventive compositions increase the MFR of the polyolefin composition by as much as 113% compared to the original unmodified r-HDPE PCR (Reference Example 68). Inventive Examples 80, 81 and 82 simultaneously exhibit increased elongation at break of a surprising 343%, 350% and 267%, respectively. These increases are greater than expected based on the improved elongation at break shown by 10% addition of only the alpha olefin copolymer or only the additional polymer in Comparative Examples 77 and 78 It should be noted that the 350% increase compared to Reference Example 68 for Inventive Example 81 is a minimum percent increase since the % elongation exceeded the ability of the equipment to measure. These inventive compositions also unexpectedly had greatly improved impact resistance; the Notched Izod impact hammer rebounded from the test samples without breaking them.

Examination of the series Reference Example 68, Inventive Example 79, Inventive Example 84 and the series Example 68, Inventive Example 83, Inventive Example 85 shows that the increase in MFR and elongation at break can be affected by the addition of optional tackifier. The increase in % elongation at break was surprisingly affected by the selection of the additional polymer, with Inventive Example 84 having an unexpectedly greater increase in % elongation at break compared to Inventive Example 79 than was observed for Inventive Example 85 compared to Inventive Example 83 without the optional tackifier.

The invention is intended to not only cover individual embodiments but also combinations of the embodiments discussed herein.

That which is claimed is:

1. A polyolefin composition comprising:
(A) about 60 to about 96 weight % of at least one recycled polyolefin;
(B) about 2 to about 20 weight % of at least one random alpha-olefinic copolymer;
(C) optionally, at least one tackifier; and
(D) about 1 to about 60 weight % of at least one additional polymer; and wherein said polyolefin composition has a melt flow rate increase of about 3 to about 400% compared to a same polyolefin composition without said random alpha-olefinic copolymer, said tackifier, and said additional polymer.

2. The polyolefin composition according to claim 1 wherein said polyolefin composition has a weight ratio of said random alpha-olefinic copolymer and said tackifier to said additional polymer of between about 0.2 and about 20.0 or about 0.2 to about 5.0.

3. The polyolefin composition according to claim 1 wherein said additional polymer is at least one selected from the group consisting of an ethylene-hexene copolymer, ethylene-octene copolymer, ethylene-butene copolymer, ethylene-acrylate copolymer, ethylene ethyl acrylate copolymer, ethylene methyl acrylate copolymer, ethylene butyl acrylate copolymer, terpolymers of ethylene, ethyl acrylate and maleic anhydride, MDPE, HDPE, LLDPE, LDPE, virgin PP homopolymer, and PP copolymer.

4. The polyolefin composition according to claim 1 wherein said random alpha-olefinic copolymer and said additional polymer are present in said polyolefin composition in an amount ranging from about 3 weight % to about 80 weight % based on the weight of said polyolefin composition.

5. The polyolefin composition according to claim 1 wherein said polyolefin composition has a weight ratio of said random alpha-olefinic copolymer to said additional polymer of between about 0.2 to about 20.0 or about 0.2 to about 5.0.

6. The polyolefin composition according to claim 1 wherein said recycled polyolefin comprises at least one ethylene polymer or propylene polymer, wherein said ethylene polymer is at least one selected from the group consisting of polyethylene homopolymers and ethylene-alpha-olefin copolymers comprising at least 50 mol % ethylene derived units.

7. The polyolefin composition according to claim 6 wherein said ethylene-alpha-olefin copolymers comprise comonomers comprising one or more C₃ to C₄₀ olefin derived units,
wherein said propylene polymer is at least one selected from the group consisting of propylene homopolymers and propylene copolymers comprising at least 50 mol % propylene derived units, and/or
wherein said propylene copolymers are polymers where the propylene is copolymerized with ethylene or one C₄-C₂₀ alpha-olefin.

8. The polyolefin composition according to claim 1 wherein said polyolefin composition has a notched impact strength increase of about 2 to about 150% compared to said same polyolefin composition without said random alpha-olefinic copolymer, said tackifier, and said additional polymer.

9. The polyolefin composition according to claim 8 wherein said polyolefin composition shows an elongation at break increase of up to 400% compared to said same polyolefin composition without said random alpha-olefinic copolymer, said tackifier, and said additional polymer, and wherein said polyolefin composition retains acceptable mechanical properties.

10. The polyolefin composition according to claim 1 wherein said recycled polyolefin is at least one polyolefin selected from the group consisting of a polyethylene-rich polyolefin recovered from post-consumer waste, polyethylene-rich polyolefin recovered from a post-industrial waste, a polypropylene-rich polyolefin recovered from post-consumer waste, and a polypropylene-rich polyolefin recovered a post-industrial waste.

11. The polyolefin composition according to claim 1 wherein said random alpha-olefinic copolymer, said tackifier, and said additional polymer are present in said polyolefin composition in an amount ranging from about 5% to about 70 weight % based on the weight of said polyolefin composition.

12. The polyolefin composition according to claim 1 wherein said polyolefin composition has a weight ratio of said random alpha-olefinic copolymer to said tackifier of between about 0.2 to about 5.0 and wherein said polyolefin composition has a weight ratio of said random alpha-olefinic copolymer and said tackifier to said additional polymer of between about 0.2 to about 20.0.

13. The polyolefin composition according to claim 1 wherein said recycled polyolefin has a melt flow rate from about 0.1 to 10 g/10 min.

14. The polyolefin composition according to claim 1 wherein said random alpha-olefinic copolymer comprises amorphous polypropylene-ethylene copolymers or amorphous polypropylene-ethylene copolymers containing derived units of one or more C4-C10 alpha olefins or combinations thereof, and
wherein said random alpha-olefinic copolymer has a number average molecular weight equal to or below 25,000 g/mol and/or a glass transition equal to or below −10° C.

15. The polyolefin composition according to claim 1 wherein said random alpha-olefinic copolymer, said tackifier, and said additional polymer are present in said polyolefin composition in an amount ranging from about 5% to about 70 weight % based on the weight of said polyolefin composition,
wherein the weight ratio of said random alpha-olefinic copolymer to said tackifier is between 0.2 and 5.0,
wherein the weight ratio of said random alpha-olefinic copolymer to said additional polymer is between 0.2 and 20, and
wherein said polyolefin composition optionally retains acceptable mechanical properties.

16. The polyolefin composition according to claim 1 wherein said tackifier is selected from cycloaliphatic hydrocarbon resins, C5 hydrocarbon resins, C5/C9 hydrocarbon resins, aromatically modified C5 resins, C9 hydrocarbon resins, pure monomer resins, C5 resins, C9 resins, terpene resins, terpene phenolic resins, terpene styrene resins, rosin esters, modified rosin esters, liquid resins of fully or partially hydrogenated rosins, fully or partially hydrogenated rosin esters, fully or partially hydrogenated modified rosin resins, fully or partially hydrogenated rosin alcohols, fully or partially hydrogenated C5 resins, fully or partially hydrogenated C5/C9 resins, fully or partially hydrogenated aromatically-modified C5 resins, fully or partially hydrogenated C9 resins, fully or partially hydrogenated pure monomer resins, fully or partially hydrogenated C5/cycloaliphatic resins, fully or partially hydrogenated C5/cycloaliphatic/styrene/C9 resins, fully or partially hydrogenated cycloaliphatic resins; and combinations therefor combinations thereof,
wherein said tackifier has a ring and ball softening point equal or above 70° C. and/or said tackifier has a glass transition temperature equal or above 25° C.

17. An article comprising at least one component formed from said polyolefin composition of claim 1, wherein said article is selected from the group consisting of films, sheets, extruded parts, injection molded parts, blow molded parts, thermoformed articles, rotomolded articles, woven textiles, non-woven textiles, foamed articles, carpets, flooring materials, roofing materials, composites, synthetic paper, artificial turf, fibers, thermoplastic elastomers, automotive parts, computer parts, healthcare parts, building materials, household appliances, electronic parts, electric parts, toys, and footwear components.

18. A process for producing a polyolefin composition comprising melt blending:
(A) about 60 to about 96 weight % of at least one recycled polyolefin;
(B) about 2 to about 20 weight % of at least one random alpha-olefinic copolymer;
(C) optionally, at least one tackifier; and
(D) about 1 to about 60 weight % of at least one additional polymer, and wherein the polyolefin composition has a melt flow rate increase of about 5 to about 400% compared to a same polyolefin composition without said random alpha-olefinic copolymer, said tackifier, and said additional polymer.

19. The process according to claim 18, wherein during said melt blending the process imparts a specific energy of about 0.01 to about 10 kWh/kg to said polyolefin composition.

20. The process according to claim 18, wherein said melt blending is done using a single screw extruder, a corotating twin screw extruder, a counter rotating twin screw extruder, or combinations thereof.

21. The process according to claim 18, wherein said melt blending is done using a co-rotating twin screw extruder with a screw temperature profile from about 110 to about 200° C. for a polyethylene-rich recycled polyolefin and from about 140° C. to about 220° C. for a polypropylene-rich recycled polyolefin.

22. The process according to claim 18, wherein said random alpha olefinic copolymer, said tackifier, said additional polymer, or a combination thereof are added in one or more masterbatches, wherein a concentration of said random alpha-olefinic copolymer, said tackifier, and/or said additional polymer is achieved by combining said recycled polyolefin with said masterbatches.

23. The process according to claim 22, wherein said masterbatches are made using a carrier polymer which can be identical or different from said recycled polyolefin, and which can be identical or different from said additional polymer, and wherein said carrier polymer has an MFR from about 0.5 to about 25 g/10 min.

24. The process according to claim 22, wherein said melt blending of said masterbatches is done using a corotating twin screw extruder with a screw temperature profile from about 85 to about 160° C. for a polyethylene carrier polymer and from about 120° C. to about 185° C. for a polypropylene carrier polymer.
